(19) United States
(12) Patent Application Publication
(10) Pub. No.: US 2018/0046931 A1
(43) Pub. Date: Feb. 15, 2018

(54) Method and Apparatus for Quantitatively Ranking Possible Outcome Scenarios for Issues Involving Multiple Stakeholders

(71) Applicant: Global Impact Strategies, Washington, DC (US)

(72) Inventor: Amir Bagherpour, Laguna Niguel, CA (US)

(73) Assignee: Global Impact Strategies, Washington, DC (US)

(21) Appl. No.: 15/451,141

(22) Filed: Mar. 6, 2017

Related U.S. Application Data
(60) Provisional application No. 62/372,750, filed on Aug. 9, 2016.

(51) Int. Cl. G06N 7/00; G06Q 30/04

(52) U.S. Cl. CPC G06N 7/005; G06Q 30/04

(57) ABSTRACT

System and method for scoring and ranking possible outcome scenarios within a range of possible outcome scenarios for a defined issue. The system and the method may practiced manually or on a computer system by defining a range of possible outcome scenarios for the defined issue, including a status quo outcome scenario, defining and ranking the factors and options associated with the defined issue, establishing pathways linking the options to the possible outcome scenarios, using reverse induction to generate a utility payoff schedule for the range of possible outcome scenarios, calculating an average influence-weighted utility payoff score for each possible outcome scenario, and ranking the possible outcome scenarios from most likely to least likely to occur based on the average influence-weighted utility payoff scores. Embodiments of the invention may also be used to determine the most likely egalitarian outcome scenario and the amount of friction for the defined issue.

### FIELD OF ART

The present invention relates generally to systems and methods for predicting the most likely outcome scenario for a given issue. More particularly, embodiments of the present invention provide a method and an apparatus for scoring and ranking each possible outcome scenario in a range of possible outcome scenarios for a defined issue, when the defined issue involves multiple agents and/or multiple stakeholders who may have different positions on the issue, as well as different levels of influence and concern about the issue.

### BACKGROUND

In our increasingly complex world, leaders and decision-makers for all types of governments, corporations, political parties, law firms, educational institutions, news and health organizations often turn to decision analytics for help in trying to solve some of the world's most important challenges and predict the most likely outcome scenarios for a range of decisions, situations and conflicts. Often the range of possible outcome scenarios for a complex issue or conflict is driven primarily by a variety of human factors arising during complicated negotiations between multiple agents and stakeholders. These human factors may include varying priorities, varying levels of influence and varying levels of concern among the stakeholders in respect to the issue. The level of concern is sometimes referred to in the industry as “salience.”

When there are multiple agents and stakeholders for an issue, one of the conventional techniques for trying to rank the possible outcome scenarios is to use expected utility value agent-based modeling. This technique attempts to rank outcome scenarios for a complex issue based solely on qualitative judgements, such as the expected behaviors of the agents during hypothetical negotiations with each other. Another approach is to use decision-tree modeling, whereby the perceived relative gains of the stakeholders and the probabilities of potential outcomes occurring are explicitly entered into the model, and the model generates a decision tree that is supposed to visually represent the decision-making process, and thereby show the most likely outcomes.

But there are significant disadvantages associated with using expected utility value agent-based modeling, decision trees or other conventional techniques to predict outcomes. For one thing, there are always a variety of decision factors and factor options associated with the range of possible outcome scenarios for a complex issue. Yet, the conventional approaches make no real attempt to identify and break down these factors and options, and therefore fail to account for the stakeholders' priorities in respect to these factors and options. Because the factors, options and priorities are largely ignored by the conventional methods, the expected and maximum utility calculations (i.e., the net payoffs) for the multiple stakeholders is essentially abstract, which makes the predictions and/or rankings of the possible outcome scenarios in accurate and unreliable. These disadvantages severely limit the type and number of situations in which the conventional techniques may be used to accurately rank the possible outcome scenarios for issues involving multiple stakeholders.

Accordingly, there is considerable need for accurate and reliable systems and methods for scoring and ranking potential outcome scenarios for complex issues and negotiations involving multiple agents and stakeholders. There is also considerable need for systems and methods that account for the factors and options associated with each possible outcome scenario in the range of possible outcome scenarios, as well as the priorities of the agents and stakeholders in respect to those factors and options.

### BRIEF SUMMARY OF EXEMPLARY EMBODIMENTS OF THE INVENTION

In general, embodiments of the present invention address the aforementioned needs by providing a system and method for scoring and ranking possible outcome scenarios within a range of possible outcome scenarios for a defined issue, decision, conflict or dispute. By identifying, isolating and rank ordering the factors and options associated with the range of possible outcome scenarios for the defined issue, embodiments of the invention provide more accurate expected utility values for each one of the possible outcome scenarios for each one of the agents and/or stakeholders. In addition to isolating and ranking the factors and options associated with the range of possible outcome scenarios, embodiments of the present invention also identify a status quo outcome scenario and take into account the utility payoffs for each stakeholder relative to the status quo outcome scenario. Furthermore, some embodiments of the present invention also receive and factor in the relative influences and levels of concern about the issue for all of the stakeholders in order to calculate average-influence-weighted payoffs for each outcome scenario in the range of possible outcome scenarios. The average influence-weighted payoffs are then used to generate more trustworthy scores and rankings for the possible outcome scenarios for any defined issue. Embodiments of the present invention also generate landscape visualizations for the issue, which improves users' ability to recognize and comprehend the differences between the stated positions of the stakeholders and the true positions of the stakeholders across the defined issue spectrum, and thereby make more reliable predictions about outcomes.

The defined issue may be simple or complex, and may or may not be the subject of extended, delicate or contentious negotiations between multiple agents and/or stakeholders. The defined issue could arise, for example, from local, regional or international disputes, actual or potential armed conflicts, questions related to politics, economics, energy or finance, concerns about healthcare, law, business or technology, or any other events, disputes, questions or decisions in which there may be multiple agents (and/or stakeholders) with different, and sometimes conflicting, positions and expected payoffs.

Advantageously, embodiments of the present invention use qualitative data inputs to quantitatively calculate payoff scores that are more realistic, and therefore more reliable than the conventional methods. More specifically, embodiments of the present invention combine qualitative inputs, such as the opinions of subject matter experts and analysts about the relative influence and relative levels of concern held by each stakeholder for the issue, with quantitative and reproducible calculations on those data. The combination of qualitative inputs and quantitative calculations generate, for each stakeholder and each possible outcome scenario, reality-based influence driven positions for the defined issue. These reality-based influence driven positions do not always match the stakeholders' publicly-stated positions on the issue. The reality-based influence driven positions of the stakeholders are then averaged for each possible outcome scenario, and the averages are used to rank order the possible outcome scenarios from most likely to least likely to occur. The rank-ordered list of outcome scenarios is more accurate and more reliable than lists created by the conventional method because quantitative calculations relying on the priority rankings of factors and options for the defined issue are taken into account for the analysis.

Embodiments of the present invention may also be configured to automatically generate and display rich graphs and plots (“landscape visualizations”) that illustrate and compare the stated positions, the reality-based influence-driven positions and the utility payoffs for each stakeholder and each outcome scenario in the range of possible outcome scenarios. Ultimately, embodiments of the present invention enable analysts, practitioners and users to score and rank possible outcome scenarios with more precision and more accuracy than the conventional methods and systems because the present invention determines and incorporates the true priorities and the true positions of the multiple agents and stakeholders.

For purposes of this disclosure, unless otherwise stated, the terms “agent” and “stakeholder” are used interchangeably to mean any person, party, group or organization with a role, stake or interest in the negotiation, bargaining, handling, resolution or consequences of an issue. Unless otherwise stated, the terms “scenario,” “outcome” and “outcome scenario” are also used interchangeably to refer to an actual or potential result, conclusion, product or consequence of a negotiation, decision, dispute or conflict over an issue involving the multiple agents or stakeholders. As will become more apparent with the detailed description below, the term “factor” is used in this disclosure to refer to a component, driver or important consideration that is believed to affect (sometimes decisively) the nature or outcome of a defined issue. To give one illustrative example, if the issue is defined as “How to improve healthcare in America,” and one of the possible outcome scenarios in a range of possible outcome scenarios for this issue is “the Affordable Care Act is repealed and replaced,” then three of the “factors” on this issue are likely to be “Cost,” “Quality” and “Access” to healthcare because “Cost,” “Quality” and “Access” are components of healthcare that may be considered important enough to have a decisive impact on whether the Affordable Care Act is repealed and replaced. And finally, unless otherwise noted, the term “option” refers to a quality, attribute, choice, feature, property, precondition, prerequisite or trait of any one of the factors. For example, if one of the defined factors of an issue is “Cost,” then one possible defined option for the Cost factor is “very expensive,” and one possible defined range of options for the Cost factor might be “very expensive, moderately expensive, moderately inexpensive, very inexpensive, and free.”

In one implementation of the present invention, there is provided a method for determining the most likely outcome scenario for a defined issue involving two or more stakeholders, the method comprising the steps of:
1) defining a range of possible outcome scenarios for the defined issue, including a status quo outcome scenario;
2) defining a set of factors for the defined issue;
3) defining a range of options for each factor in the set of factors;
4) establishing a pathway to each one of the possible outcome scenarios in the range of possible outcome scenarios by linking one of the options for each factor in the set of factors to said each one of the possible outcome scenarios;
5) for each stakeholder, ranking the factors in the set of factors by order of importance to the stakeholder, thereby producing a set of factor rankings for said each stakeholder;
6) for each stakeholder and each factor, ranking the options in the range of options for said each factor by order of importance to the stakeholder, thereby producing a set of option rankings for each stakeholder;
7) using reverse induction to generate a utility payoff schedule for each stakeholder based on the factor rankings and the option rankings for said each stakeholder, the utility payoff schedule comprising a utility payoff score for said each stakeholder for each one of the possible outcome scenarios in the range of possible outcome scenarios;
8) calculating an average utility payoff score for each one of the possible outcome scenarios in the range of possible outcome scenarios by summing together the utility payoff scores for said each possible outcome scenario across all of said two or more stakeholders and dividing the sum by the number of stakeholders; and
9) determining the most likely outcome scenario in the range of possible outcome scenarios by comparing the average utility payoff scores for all of the possible outcome scenarios for all of the stakeholders and selecting the possible outcome scenario with the most positive average utility payoff score.

In some versions of this implementation, the method may optionally include the additional steps of:
10) generating a rank-ordered list comprising all of the possible outcome scenarios in the range of possible outcome scenarios, wherein the possible outcome scenarios in the rank-ordered list are sequenced according to the relative values calculated for the average utility payoff scores for each one of said possible outcome scenarios; and
11) transmitting the rank-order list to a display device.

Preferably, but not necessarily, influence ratings are also factored into the calculations. Accordingly, the method may also comprise the steps of:
12) receiving an influence rating for each stakeholder;
13) calculating an influence-weighted utility payoff score for each stakeholder for each possible outcome scenario by multiplying the utility payoff score for said each possible outcome scenario for said each stakeholder by the influence rating for said each stakeholder;
14) calculating an average influence-weighted utility payoff score for each one of the possible outcome scenarios in the range of possible outcome scenarios by summing together the influence-weighted utility payoff scores for said each possible outcome scenario across all of said two or more stakeholders, and dividing the sum by the number of stakeholders; and
15) determining the most likely outcome scenario in the range of possible outcome scenarios by comparing the average influence-weighted utility payoff scores for all of the possible outcome scenarios for all of the stakeholders and selecting the possible outcome scenario with the most positive average influence-weighted utility payoff score.

In some embodiments, the method further includes receiving, for each stakeholder, the level of concern the stakeholder has for the defined issue, and weighting the average influence-weighted payoff scores by the levels of concern for said each stakeholder before determining the most likely outcome scenario. In still other embodiments, the method further includes the step of calculating the variance in the influence-weighted utility payoff scores across all of the stakeholders in order to predict the amount of friction associated with realizing each one of the possible outcome scenarios.

In another implementation of the present invention, there is provided a computer system for ranking outcome scenarios for a defined issue involving two or more stakeholders, the computer system comprising:
1) a user interface configured to assist a user in defining (a) a range of possible outcome scenarios for the defined issue, including a status quo outcome scenario, (b) a set of factors for the defined issue, and (c) a range of options for each factor in the set of factors;
2) an option-scenario linker for establishing a pathway to each one of the possible outcome scenarios in the range of possible outcome scenarios by linking one of the options for each factor in the set of factors to one of the possible outcome scenarios;
3) a factor ranker that produces a set of factor rankings for each stakeholder by ranking the factors in the set of factors in order of importance to the stakeholder;
4) an option ranker that produces a set of option rankings for each stakeholder and each factor by ranking the options in the range of options for said each factor in order of importance to the stakeholder;
5) a reverse induction engine that generates a utility payoff schedule for each stakeholder based on the factor rankings and the option rankings for said each stakeholder, the utility payoff schedule comprising a utility payoff score for said each stakeholder for each one of the possible outcome scenarios in the range of possible outcome scenarios;
6) a utility payoff scorer that calculates an average utility payoff score for each one of the possible outcome scenarios in the range of possible outcome scenarios by summing together the utility payoff scores for said each possible outcome scenario across all of the stakeholders and dividing the sum by the number of stakeholders; and
7) an outcome scenario ranker that determines the most likely outcome scenario in the range of possible outcome scenarios by comparing the average utility payoff scores for all of the possible outcome scenarios for all of the stakeholders and selecting the possible outcome scenario with the most positive average utility payoff score.

In preferred embodiments of the computer-implemented version of the present invention, the user interface is further configured to receive, for each stakeholder, an influence rating and a level of concern for the defined issue, and the utility payoff scorer is further configured to calculate the average influence-weighted payoff scores based on the influence ratings and the concern levels before determining the most likely outcome scenario. The computer system may further include a friction engine for calculating the variance in the influence-weighted utility payoff scores across all of the stakeholders in order to predict the amount of friction associated with realizing each one of the possible outcome scenarios.

Additional embodiments, features and benefits of the invention will become apparent upon reading the detailed disclosure below. The invention may be embodied in the forms illustrated in the accompanying drawings, attention being called to the fact, however, that the drawings are illustrative only, and that changes may be made in the specific construction of the embodiments illustrated and described within the scope of the appended claims, without departing from the inventive aspects and scope of the invention.

### BRIEF DESCRIPTION OF THE FIGURES

The present invention and various aspects, features and advantages thereof are explained in detail below with reference to exemplary and therefore non-limiting embodiments shown in the drawings, which constitute a part of this specification and include depictions of the exemplary embodiments. In these drawings:

FIG. 1 shows a high-level flow diagram illustrating five different stages of operation for the claimed system and method according to certain embodiments of the present invention.

FIG. 2 shows a high-level flow diagram illustrating by way of example the steps performed in the first stage of operation according to one embodiment of the invention.

FIG. 3 shows a flow diagram illustrating by way of example the steps performed in the second stage of operation according to one embodiment of the invention.

FIG. 4 shows a flow diagram illustrating by way of example the steps performed in the third stage of operation according to one embodiment of the invention.

FIG. 5 shows a flow diagram illustrating by way of example the steps performed in the fourth stage of operation according to one embodiment of the invention.

FIGS. 6A-6D show exemplary data that might be defined, received and/or recorded as a result of carrying out some of the steps of FIG. 2 for the defined issue of “What will be the likely impact of a counter-ISIS campaign?”

FIG. 7 shows an exemplary scenario pathway table for the defined issue of “What will be the likely impact of a counter-ISIS campaign?”

FIG. 8A shows that an exemplary set of stakeholders and FIG. 8B illustrates a potential set of rankings of the factors and options for a stakeholder for the defined issue of “What will be the likely impact of a counter-ISIS campaign?”

FIG. 9 shows an example of a portion of a utility payoff schedule for one of the stakeholders for the defined issue of “What will be the likely impact of a counter-ISIS campaign?”

FIGS. 10A and 10B show, respectively, examples of influence-weighted payoff scores and rankings for the range of possible outcome scenarios for the defined issue of “What will be the likely impact of a counter-ISIS campaign?”

FIG. 11 shows a high-level block diagram illustrating the issue and stakeholder input parameters for an outcome scenario ranking system configured to operate according to one embodiment of the present invention.

FIG. 12 shows a high-level block diagram illustrating the outputs for an outcome scenario ranking system configured to operate according to one embodiment of the invention.

FIG. 13 shows a high-level block diagram of an outcome scenario ranking system arranged and configured to operate according to one embodiment of the invention.

### DETAILED DESCRIPTION OF THE EXEMPLARY EMBODIMENTS SHOWN IN THE FIGURES

With reference now to the drawings, a more detailed discussion of exemplary embodiments of the invention will now be presented. Notably, the invention may be implemented using software, hardware, firmware, or any combination thereof, as would be apparent to those of skill in the art upon reading this disclosure. It is also noted, however, that certain embodiments of the present invention may be beneficially practiced by carrying out the steps of the recited and described steps manually, without relying on computer software, hardware or firmware components, as will be more fully described below.

Embodiments of the present invention provide both a method and an apparatus for ranking a given range of possible outcome scenarios for a defined issue, wherein the defined issue concerns a plurality of different agents having different positions and different levels of concern about the issue. Typically, embodiments of the present invention will produce a rank-ordered list of possible outcome scenarios for the defined issue, wherein the possible outcome scenarios are presented in a sequence that goes from most likely occur to the least likely to occur. It is understood, however, that the range may be displayed in the opposite order, i.e., from least likely to most likely to occur. And in some embodiments, the output may comprise only the most likely outcome scenario instead of a ranked list of possible outcome scenarios. The agents, who may or may not be stakeholders, may be determined to have different utility payoffs for each possible outcome scenario in the defined range of possible outcome scenarios.

In general, practicing an embodiment of the invention comprises performing the steps of (1) defining an issue involving multiple stakeholders, (2) defining a range of possible outcome scenarios for the defined issue, including a status quo outcome scenario, (3) defining a set of factors relevant to all of the possible outcome scenarios, (4) defining a range of options for each one of the factors in the defined set of factors, (5) identifying a set of stakeholders for the defined issue, (6) defining the stakeholders' relative influence ratings and relative levels of concern for the defined issue, (7) for each stakeholder and each factor, ranking the factors and the options in order of importance to that stakeholder, and (8) generating by reverse induction a utility payoff schedule for each stakeholder based on the stakeholder's rankings of the factors, the stakeholder's rankings of options and the defined status quo outcome scenario. The utility payoff schedule identifies the stakeholder's reality-based utility payoff score for each one of the possible outcome scenarios in the range of possible outcome scenarios.

As will be described in more detail below, practicing an embodiment of the present invention may further include the steps of: (9) calculating an average influence weighted payoff score for each one of the possible outcome scenarios based on the influence ratings and the levels of concern for each stakeholder, and (10) ranking the possible outcome scenarios in accordance with the average influence-weighted utility payoff scores for each possible outcome scenario. In certain embodiments, optional additional steps may include: (11) ranking the possible outcome scenarios without considering influence ratings in order to determine the most likely egalitarian outcome scenario, and/or (12) calculating the variance in the reality-based utility payoff scores across all of the stakeholders in order to predict or determine the amount of friction associated with realizing each one of the possible outcome scenarios.

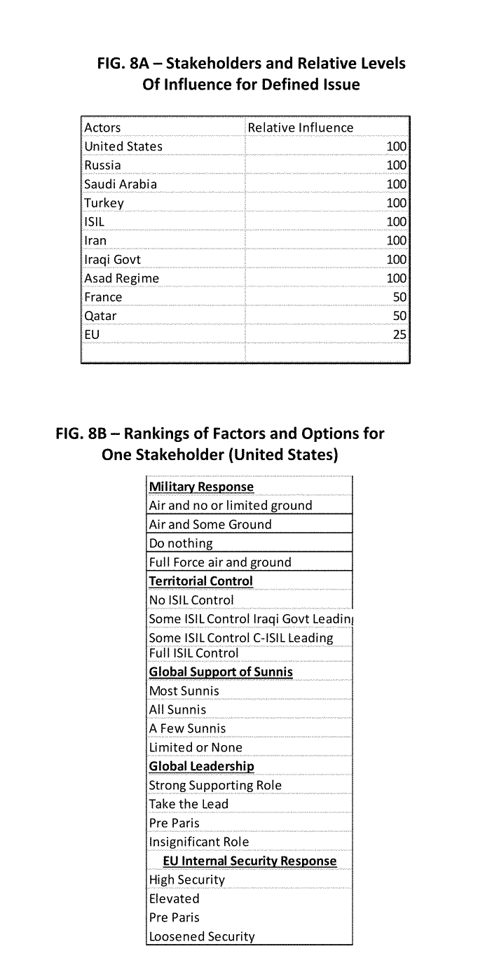

In some embodiments, all of the above-described steps may be carried out on a computer system or computer network, as will be described in more detail below. In other embodiments, only a portion of the above-listed steps will be performed using a computer system or computer network, while the remaining steps are carried out manually. In still other embodiments, all of the above-listed steps may be carried out manually, without using a computer program, computer system or computer network. In a computer-implemented embodiment, an online server, comprising a network interface, a microprocessor and one or more computer software programs with programming instructions configured to cause the microprocessor to perform the steps listed above, may be communicatively connected directly to a personal computer (PC) of a user, the PC of a subject matter expert, the PC of a system operator, or the PCs of all three of them. While carrying out these functions with the microprocessor against data stored in data structures located in the computer's primary or secondary data storage areas, computer-implemented embodiments of the present invention may also be configured to generate and present visualizations (i.e., graphs and plots) illustrating, for each step in the process, certain intermediate data values, such as reality-based utility payoff scores, which helps analysts, users, subject matter experts and/or operators alike better visualize and comprehend the negotiation landscapes associated with the issues and the disputes to be negotiated. These visualizations may be transmitted to the analysts, users and/or subject matter experts via the data communications channels concomitant to a local area network, such as a corporate intranet, a private wide area network, or a public wide area network (WAN), such as the Internet and the World Wide Web. The computer programs and functional components of the online server will be further described in greater detail below in connection with the detailed description of FIG. 8.

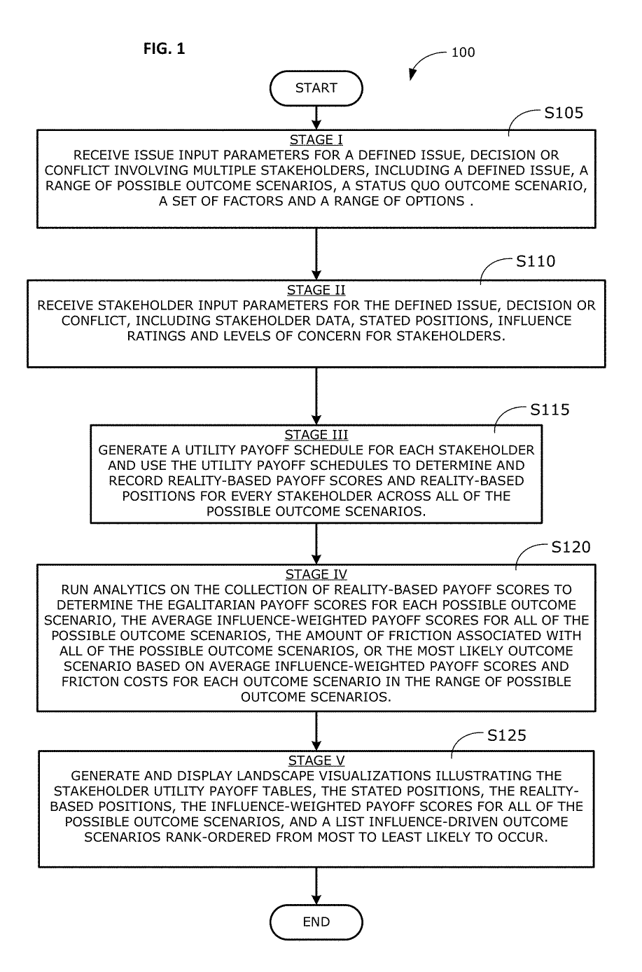

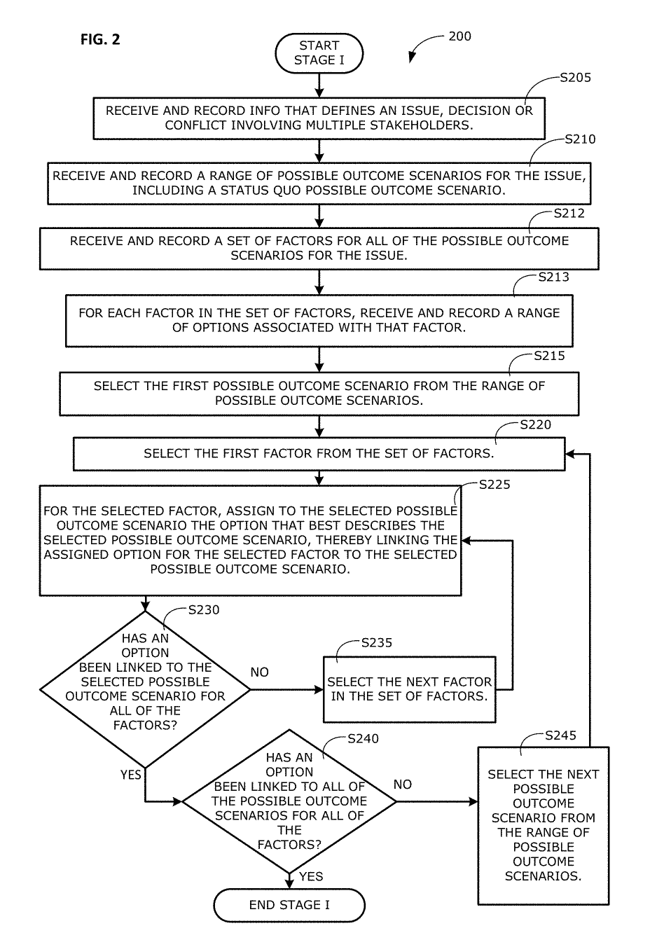

Turning now to the detailed description of the individual figures, FIG. 1 shows a flow diagram 100 illustrating, at a high-level, the five stages of operation for one exemplary embodiment of the present invention. As shown at step S105 in FIG. 1, Stage I comprises receiving issue input parameters for a defined issue, decision or conflict involving multiple stakeholders. The issue input parameters may include a defined issue, a range of possible outcome scenarios for the defined issue, a set of factors that are relevant to all of the possible outcome scenarios in the range of possible outcome scenarios, and for each factor, a range of options. Examples of defined issues that might be received and recorded at this point in the practice of the present invention might include defining and/or receiving an issue of national or international importance, such as “What the United States should do to address illegal immigration?” or “How many times will the Federal Reserve raise interest rates next year?” or “How will the refugee crises in Europe and Middle East progress?” If the embodiment is computer-implemented, then the issue input parameters are typically recorded to a primary or secondary memory area on a computer system. FIG. 2, which will be discussed below, contains a flow diagram illustrating with more specificity some of the details of the step S105 carried out in the first stage of operation for the system.

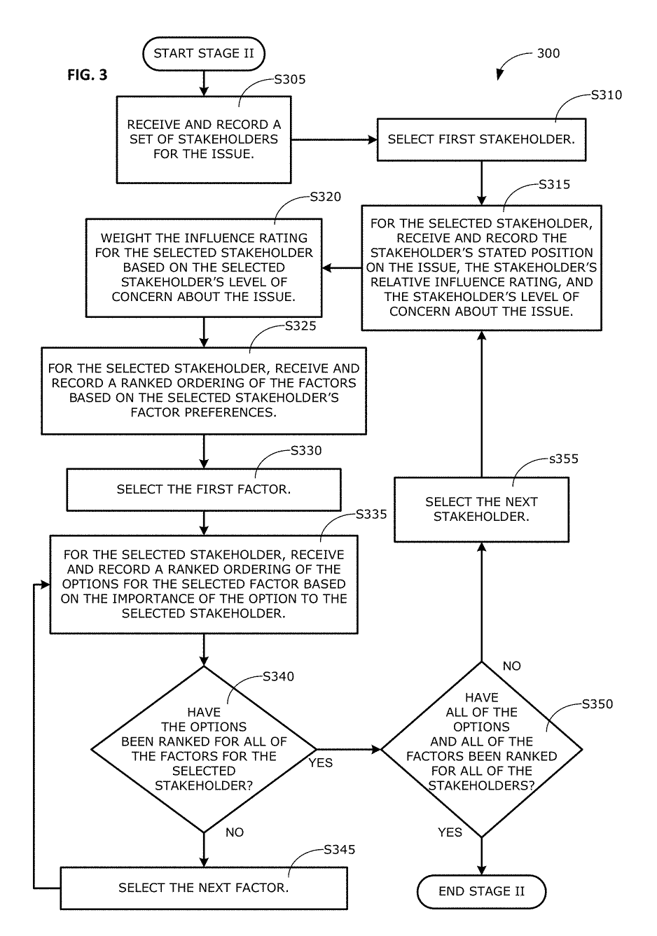

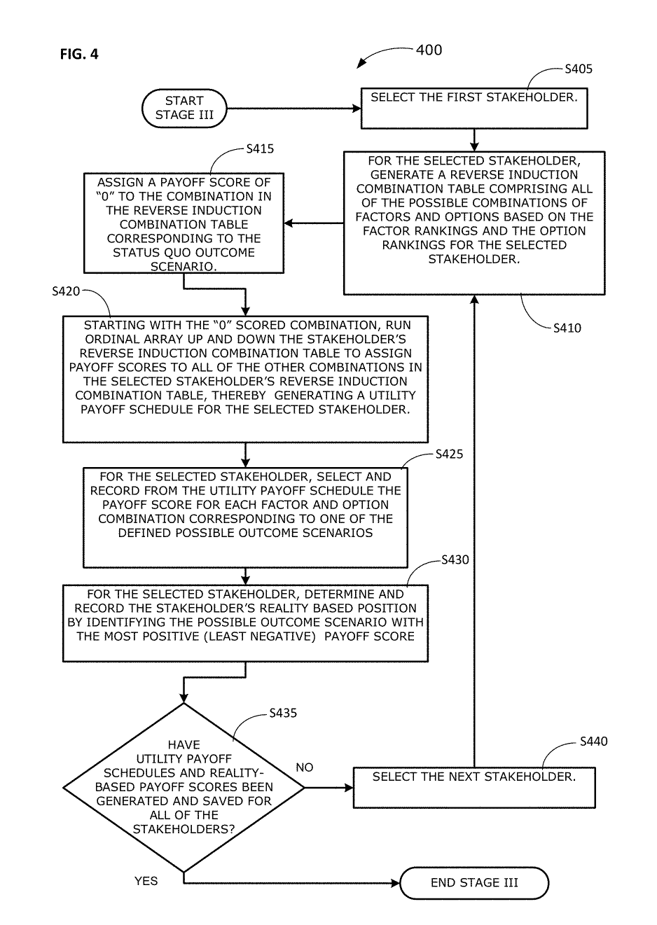

In the second stage of operation (represented by step S110 of FIG. 1), stakeholder input parameters for the defined issue, including stakeholder data, are received and recorded. As will be discussed below in connection with FIG. 3, the stakeholder data may include, for example, the identities of the stakeholders, their stated positions, influence ratings and levels of concern about the issue. The third stage (step S115 in FIG. 1) comprises generating a utility payoff schedule for each stakeholder and using the utility payoff schedules to determine and record, for each stakeholder, the stakeholder's reality-based payoff scores and reality-based positions across all of the possible outcome scenarios defined in Stage I (step S105). Stage III will be described in more detail below in connection with the discussion of FIG. 4.

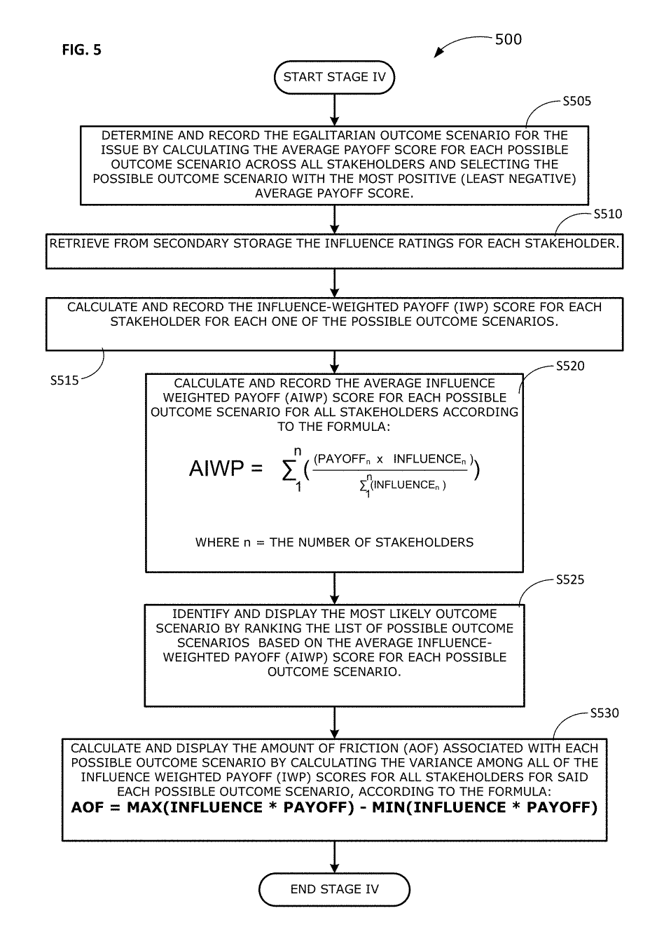

Stage IV (illustrated as step S120 in FIG. 1), comprises running analytics against the collection of reality-based payoff scores generated in Stage III to determine (a) the egalitarian payoff scores for each outcome scenario in the range of possible outcome scenarios, (b) the average influence-weighted payoff scores for each outcome scenario, (c) the amount of friction associated with all of the possible outcome scenarios, and (d) the most likely outcome scenario based on the average influence-weighted payoff scores and friction costs. The egalitarian payoff score for a possible outcome scenario is the average payoff score for a possible outcome scenario when all of the stakeholders are assumed to hold the same level of influence on the defined issue. In other words, the stakeholders' relative influence and levels of concern are disregarded for purposes of calculating the egalitarian payoff score for a possible outcome scenario. The egalitarian payoff scores for each possible outcome scenario are then compared against each other to determine which outcome scenarios or more or less likely when influence and levels of concern are not considered. Stage IV is described in more detail below in connection with the detailed discussion of FIG. 5.

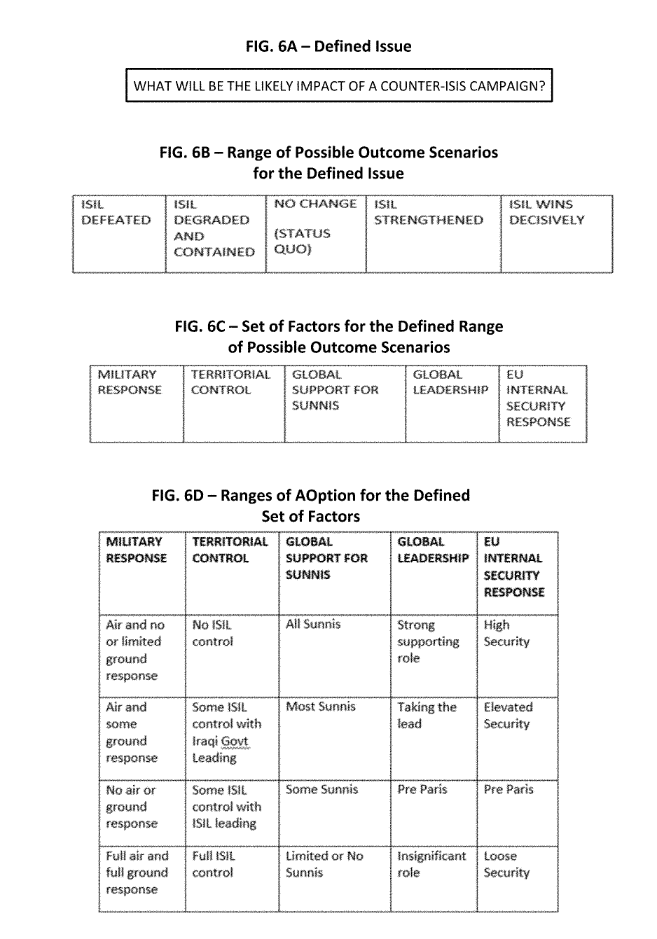

The fifth stage (Stage V) of operation (represented at step S125 of FIG. 1) comprises generating and displaying landscape visualizations illustrating, for example, the utility payoff schedules for each stakeholder, the stated positions for the stakeholders, the reality-based positions for the stakeholders, the influence-weighted payoff scores for all of the possible outcome scenarios, and a rank-ordered list of influence-driven outcome scenarios for the defined issue. Stage V is discussed in more detail below in connection with the detailed discussion of FIG. 6.

As previously noted, the defined issue can be simple or complex, and might (or might not) be the subject of protracted or contentious negotiations between a number of stakeholders with different positions and different levels of influence and concern in respect to the defined issue. Embodiments of the present invention are ideal for scoring and ranking possible outcome scenarios for enormously important issues around the world with far-reaching implications and consequences because many of the world's most important challenges involve multiple stakeholders with vastly different positions and vastly different levels of influence and concern about the issue. Embodiments of the invention may be used, for instance, to score and rank ranges of possible outcome scenarios for a host of important political issues, such as national security, climate control, inequality, energy consumption, gun control legislation, space exploration, human rights, nuclear proliferation, or global warming, to name but a few examples. It is also anticipated and expected that embodiments of the present invention will frequently be used to score, rank and predict the most likely outcome scenarios for legal disputes between multiple parties, as well as anticipated or proposed mergers and acquisitions by national and international corporations and organizations.

Before discussing an example illustrating how embodiments of the present invention may be beneficially applied to rank outcome scenarios for one or more of these extremely important and relatively complicated national and international issues, however, it is constructive and illuminating to first present and describe how an embodiment of the present invention might be utilized to score and rank a range of possible outcome scenarios associated with a relatively simple, uncomplicated issue involving a small number of stakeholders. In this way, the dimensions and complexity of the defined issue itself will not complicate the description and comprehension of the invention, or unnecessarily obscure its individual features and steps.

Accordingly, for purposes of providing an easy to comprehend illustration of how to practice the claimed invention, FIGS. 2 through 8 will be discussed in the context of a relatively simple defined issue. In this case, the defined issue is “What to do for lunch today,” and there are only two stakeholders, namely, Jane and Carl. Thus, the following discussion of FIGS. 2 through 8 will show how certain embodiments of the present invention might be used and/or practiced for the purpose of ranking from most likely to least likely a range of possible outcome scenarios associated with a decision or negotiation between Jane and Carl about whether to go out for lunch, and if so, which one of few possible choices of restaurants they should go to. Although the defined issue in this example is not an issue of far-reaching significance, it should be understood that when the same steps discussed herein are applied to more “weighty” issues, such as illegal immigration, climate change or health care, the present invention will typically achieve results that are far superior to the results achieved using conventional techniques and methodologies, such as expected value agent-based modeling and decision trees. Notably, FIGS. 2 through 8 demonstrate how the invention may be used and practiced using the components of a computer network. It is understood that alternative embodiments of the invention may be performed manually, and therefore, do not necessarily require computer components in order to be considered as falling within the scope of the claims appended hereto.

Returning now to the figures, FIG. 2 shows a flow diagram 200 illustrating the steps performed in the first stage of operation according to one embodiment of the present invention. As shown in FIG. 2, the first step of Stage I (step S205) is to receive and record information that defines an issue involving multiple stakeholders. For purposes of illustrating the features of the present invention the defined issue is “What to do for lunch,” as shown in Table 1 below. Therefore, sufficient information defining and representing the issue of “What to do for lunch” may be collected and/or recorded. If the embodiment is automated, then the information may be received on a computer system or computer network and stored in a data structure, such as a database, which resides in a primary or secondary memory storage area associated with the computer system or computer network. If, on the other hand, the embodiment is not automated, or only semi-automated, then the information defining the issue may be collected and recorded using any conventional manual or semi-automated tools to techniques, including without limitation, pencil and paper, word-processors or spreadsheets.

TABLE 1
DEFINED ISSUE

WHAT TO DO FOR LUNCH?

Next, at step S210, a range of possible outcome scenarios for the defined issue are received and/or recorded. For example, if the defined issue is “For our example, the range of possible outcome scenarios for the defined issue of “What to do for lunch today,” comprises four different possible outcome scenarios. As shown in Table 2 below, these four possible outcome scenarios include going to a Subway restaurant, going to a McDonalds restaurant, going to a Chipotle restaurant, or doing nothing and skipping lunch altogether. Although only four possible outcome scenarios are defined in our lunch example, it will be recognized and appreciated by those skilled in the art that any number of possible outcome scenarios may be included in the range of possible outcome scenarios without departing from the scope of the claimed invention. For purposes of this disclosure, it should be understood that, for the sake of brevity in the tables, the restaurant names are used as shorthand references to the stated outcome scenarios. For example, whenever the words “Subway” or “McDonalds” are shown in any of the following tables, those words actually refer to the outcome scenarios of “going to Subway for lunch,” and “going to McDonalds for lunch,” respectively.

TABLE 2
RANGE OF POSSIBLE OUTCOME SCENARIOS
FOR THE DEFINED ISSUE

| | | | |
|---|---|---|---|
| SUBWAY | MCDONALDS | CHIPOTLE | NOTHING |
| | | | (STATUS QUO) |

Notably, step S210 also includes a sub-step of identifying (or designating) one of the possible outcome scenarios in the range of possible outcome scenarios as “the status quo outcome scenario” for the defined issue. The status quo outcome scenario is the outcome scenario that most closely corresponds to the present set of circumstances surrounding the defined issue. Continuing with our lunch example, assuming that it is not yet time for lunch and that Jane and Carl are not already at lunch or on their way to a restaurant, then the status quo outcome scenario is doing nothing for lunch (i.e., skipping lunch) because skipping lunch is probably the outcome scenario that most closely corresponds to maintaining the present set of circumstances on the issue of “What to do for lunch today.”

If, on the other hand, the defined issue was a more complex issue, such as, “How will the Federal Reserve interest rate change in the next 12 months,” then the range of possible outcome scenarios might be defined as “the Federal Reserve will hike interest rates significantly,” “the Federal Reserve will lower interest rates,” and “There will be no change in the Federal Reserve interest rate;” and the possible outcome scenario of “There will be no change in the Federal Reserve interest rate” would likely be designated as the status quo outcome scenario.

After receiving and recording the range of possible outcome scenarios for the defined issue, the next step (represented by step S212 in FIG. 2) is to receive and record a set of factors for all of the possible outcome scenarios for the define issue. A factor is a factor or component of the defined issue that decisively drives or affects the actual outcome scenario that will develop for the defined issue. In other words, the factors are factors or components that are so important, and so relevant to the defined issue, that they tend to determine which one of the possible outcome scenarios in the range of possible outcome scenarios will be collectively selected by the as-yet unidentified stakeholders. Continuing with our lunch example, there are four factors for the range of possible outcome scenarios. These four factors include the health impact of the food provided by the four possible outcome scenarios, the taste of the food provided by the four possible outcome scenarios, the cost of the food provided by the four possible outcome scenarios, and the distance to the restaurants in the four possible outcome scenarios. These four factors for the defined range of possible outcome scenarios are listed in Table 3 below.

TABLE 3
SET OF FACTORS FOR THE DEFINED RANGE
OF POSSIBLE OUTCOME SCENARIOS

| | | | |
|---|---|---|---|
| HEALTH | TASTE | COST | DISTANCE |

The next step in the process, shown as step S213 in FIG. 2, is to receive and record a range of options associated with each one of the factors in the defined set of factors. An option for a factor is a trait, characteristic, description, value or feature that comprises one of the options (or choices) for that factor. For our lunch example, for instance, one possible description, trait or characteristic (among several possible descriptions, traits or characteristics) for the Taste factor (i.e., how the food tastes) is “DELICIOUS.” Therefore, “DELICIOUS” is recorded as one of the several options for the Taste factor. Similarly, one possible description, trait or characteristic (among several possible descriptions, traits or characteristics) for the Cost factor (i.e., how much the food costs) is “FREE.” Therefore, “FREE” is recorded as one of the several options for the Cost factor. In a computer-implemented embodiment, the “DELICIOUS” taste option and the “FREE” cost option might be recorded in a suitable data structure, such as a linked list or an array, which is located in a primary or secondary memory storage area on a computer system or computer network. For a semi-automated implementation, these options might be recorded in a spreadsheet or word processing program. For a manual implementation, the option values could simply be recorded on paper.

Table 4 below shows the ranges of options for each one of the four factors in the set of defined factors for our lunch example. As shown in Table 4, the range of options for the Health factor runs from “VERY HEALTHY” at one end of the range to “VERY UNHEALTHY” at the opposite end of the range, with three intermediate options of “MODERATELY HEALTHY,” “NEUTRAL” and “MODERATELY UNHEALTHY” lying between the two extremes. For the Taste factor, the range of options runs from “SUCCULENT” to “ACCEPTABLE;” with three intermediate options of “DELICIOUS,” “SAVORY” and “GOOD-TASTING” lying between the two extremes. For the Cost factor, the range of options runs from “FREE” to “VERY EXPENSIVE,” with three intermediate values of “VERY INEXPENSIVE,” “MODERATELY INEXPENSIVE” and “MODERATELY EXPENSIVE” lying between the two extremes. And finally, for the Distance factor, the range of options runs from “NONE” to “VERY FAR,” with three intermediate options of “VERY CLOSE,” “MODERATELY CLOSE” and “MODERATELY FAR” lying between the two extremes.

TABLE 4
RANGES OF OPTIONS FOR THE DEFINED FACTORS

| HEALTH | TASTE | COST | DISTANCE |
|---|---|---|---|
| VERY | SUCCULENT | FREE | NONE |
| HEALTHY | | | |
| MODERATELY | DELICIOUS | VERY | VERY CLOSE |
| HEALTHY | | INEXPENSIVE | |
| NEUTRAL | SAVORY | MODERATELY | MODERATELY |
| | | INEXPENSIVE | CLOSE |
| MODERATELY | GOOD- | MODERATELY | MODERATELY |
| UNHEALTHY | TASTING | EXPENSIVE | FAR |
| VERY | ACCEPT- | VERY | VERY FAR |
| UNHEALTHY | ABLE | EXPENSIVE | |

Although this example uses exactly four different factors, with each factor having exactly five options, it will be recognized and appreciated by those skilled in the art that any number of factors and any number of options may be defined for the defined range of possible outcome scenarios without departing from the scope of the claimed invention. For extremely complex issues, it might be necessary or desirable to define dozens, or even hundreds, of different factors and options for the range of possible outcome scenarios.

After defining the range of options for each one of the factors in the defined set of factors, embodiments of the present invention next establish a link (or pathway) between one of the options for each one of the factors and each one of the possible outcome scenarios in the defined range of possible outcome scenarios. Establishing this link, which creates a pathway from the option to the outcome scenario, comprises the steps of selecting a possible outcome scenario from the range of possible outcome scenarios (step S215), selecting one of the factors in the set of factors (step S220), and for the selected factor and selected possible outcome scenario, assigning to the selected possible outcome scenario the option which best describes (or will most likely lead to) the occurrence or development of that particular possible outcome scenario (see step S225). These three steps are then repeated for the next factor and the next possible outcome scenario until an option has been linked to all of the possible outcome scenarios for all of the factors. The combination of steps S215, S220, S225, S230, S235, S240 and S245 of FIG. 2 illustrates a repeating programmatic loop that, when executed, links an option for every factor to one of the possible outcome scenarios.

Returning to our lunch example, and as shown in Table 5 below, the options of “MODERATELY HEALTHY” (for the Health factor), “GOOD-TASTING” (for the Taste factor), “MODERATELY INEXPENSIVE” (for the Cost factor) and “VERY FAR” (for the Distance factor) are all assigned (i.e., linked) to the defined possible outcome scenario of “SUBWAY” because the food at Subway has been determined by the user (or, alternatively, by the system operator or by one or more subject matter experts) to be moderately healthy, good-tasting and moderately expensive; and the location of the Subway restaurant has been determined by the user (or, alternatively, by the system operator or by one or more subject matter experts) to be very far away. However, the defined possible outcome scenario of “MCDONALDS” is linked to a different set of options, thereby creating a different pathway for the “MCDONALDS” outcome scenario. Specifically, the options of “VERY UNHEALTHY” (for the Health factor), “SAVORY” (for the Taste factor), “VERY INEXPENSIVE” (for the Cost factor) and “MODERATELY CLOSE” (for the Distance factor) have been linked to the MCDONALDS outcome scenario through the Health, Taste, Cost and Distance factors because it has been determined that the options of unhealthy, yummy, very inexpensive and moderately close best describe the characteristics of the possible outcome scenario of going to the McDonalds restaurant for lunch. The appropriate choices are made and appropriate links are also established to provide pathways from the options to the Chipotle and Nothing outcome scenarios.

TABLE 5
SCENARIO PATHWAY TABLE (LINKING OPTIONS
TO POSSIBLE OUTCOME SCENARIOS)

| | HEALTH | TASTE | COST | DISTANCE |
|---|---|---|---|---|
| SUBWAY | MODERATELY | GOOD- | MODERATELY | VERY FAR |
| | HEALTHY | TASTING | INEXPENSIVE | |
| MCDONALDS | VERY | SAVORY | VERY | MODERATELY |
| | UNHEALTHY | | INEXPENSIVE | CLOSE |
| CHIPOTLE | MODERATELY | DELICIOUS | MODERATELY | MODERATELY |
| | UNHEALTHY | | EXPENSIVE | FAR |
| NOTHING | MODERATELY | ACCEPTABLE | FREE | NONE |
| (STATUS QUO) | UNHEALTHY | | | |

Although not represented in the example represented by Table 5, it is noteworthy that some options for some of the factors may be linked to multiple possible outcome scenarios. For instance, the “DELICIOUS” option for the Taste factor could have been linked to two or more of the restaurant outcome scenarios, and the “VERY FAR” option for the Distance factor could have been linked to two or more of the restaurant outcome scenarios, depending on the tastes and distances that the user, system operator and/or subject matter experts associate with each one of the restaurants. Conversely, some of the options in the defined ranges of options may not be linked to any of the possible outcome scenarios in the defined range of possible outcome scenarios. In our lunch example, for instance, the “SUCCULENT” option for the Taste factor is not linked to any of the restaurant outcome scenarios because it has not been determined by the user, system operator or subject matter expert that the term “SUCCULENT” is the best description of the food provided by any of the restaurant outcome scenarios. In other words, there is no requirement in the present invention that every one of the options in the range of options for each factor be linked to one of the possible outcome scenarios in the range of possible outcome scenarios.

By this time in the process, we have covered step S105 in FIG. 1, as well as all of the steps in flow diagram S200 of FIG. 2. Up to this point in our lunch issue example, all of the input parameters that have been received and recorded so far, and all of the inputs listed in Tables 1 through 5 above, comprise issue input parameters. Therefore, the Stage I of operation is now complete. FIG. 3 shows a flow diagram 300 illustrating the steps performed in the second stage (Stage II) of operation, according to an embodiment of the present invention, wherein a collection of stakeholder input parameters is received and recorded.

In general, the flow diagram 300 of FIG. 3 shows a series of steps to be carried out to receive, process and record, for each stakeholder, a set of stakeholder input parameters about the stakeholder, including the stakeholder's stated position on the issue, the stakeholder's relative influence on the issue, the stakeholder's level of concern about the issue, the stakeholder's ranked ordering of the defined set of factors, and the stakeholder's ranked ordering of options for the defined set of components. These steps could be carried out manually using pencil and paper, semi-automatically using, for example, a computer-based word processor or spreadsheet program, or automatically using a microprocessor located on the system or server, the microprocessor executing these steps under the control of programming instructions arranged to cause the microprocessor to receive and record stakeholder input parameters provided by a user or another processor. For the computerized implementation, it is understood that the computer system may receive the stakeholder input parameters via a variety of conventional methods, including without limitation, capturing input in real time as the input is supplied by a human operator via a user interface, or otherwise retrieving and scanning an electronic file containing the stakeholder input parameters.

As shown in step S305 of FIG. 3, the first step in Stage II is to receive and record a set of stakeholders for the defined issue. The stakeholders may be identified by a system user, a system operator, one or more subject matter experts for the defined issue, or any combination thereof. Depending on the defined issue, identifying the stakeholders could comprise a relatively easy and straightforward task, or one that requires considerable experience, skill and/or research to complete. In our lunch example, for instance, identifying the stakeholders could just be a matter of determining who is available to go to lunch. Thus, for this example, the set of stakeholders comprises only two individuals, Jane and Carl, as listed in Table 6 below. For more complex defined issues, such as the issues of illegal immigration, health care or gun control legislation, identifying the stakeholders for the defined issue could require extensive research and analysis, and/or the qualitative judgements and opinions of one or more subject matter experts having deep and broad experience, education and/or training in respect to the defined issue. The stakeholder identification step could also be carried out by sending out surveys and collecting responses from potential stakeholders and thought-leaders in the field and then averaging or “normalizing” those responses in order to produce reasonably-reliable answers to the survey questions based on a consensus of the most common answers (i.e., “crowdsourcing” the input data).

TABLE 6
IDENTIFIED STAKEHOLDERS

| | |
|---|---|
| JANE | CARL |

Next, at steps S310 and S315 of FIG. 3, the system selects one of the stakeholders and receives and records additional stakeholder information about that stakeholder, including the stakeholder's stated position on the defined issue, the stakeholder's relative influence rating on the defined issue, and the stakeholder's level of concern for the defined issue. The stakeholder's stated position may be obtained directly from each stakeholder, or otherwise could be obtained in other ways, such as by collecting and considering each stakeholder's past actions and recent conduct regarding the defined issue or by surveying subject matter experts to learn what those experts subjectively believe the stakeholders' stated positions are or probably would be based on a variety of other factors, such as each stakeholder's current financial condition, current relationships with other stakeholders, etc. Thus, the stated position may be derived by a variety of different methods using any number of different data sources, and does not necessarily require that each stakeholder actually state or “declare” a position. In our lunch example, and as shown in Table 7 below, it can be seen that Jane's stated position on the issue of “What to do for lunch,” is to go to Chipotle, while Carl's stated position on the issue is to go to Subway.

Step S315 of FIG. 3 also includes receiving and recording the selected stakeholder's relative influence rating on the defined issue. The selected stakeholder's relative influence rating indicates how much influence, or “sway,” the selected stakeholder has over the defined issue relative to the influence and sway of all of the other stakeholders. Typically, although not necessarily, the relative influence rating of any particular stakeholder will be provided to the system by the user, the system operator, one or more subject matter experts, or a combination of two or more of them, based on their subjective judgements about the relative power of each stakeholder in the context of the defined issue. These ratings will obviously depend, in large part, on the perceived power of each stakeholder in respect to the defined issue. For instance, if the defined issue is “What will Saudi Arabia and the Organization of Petroleum Exporting Countries (OPEC) do next year in light of falling oil prices,” then it would be logical and appropriate to give certain stakeholders, such as Saudi Arabia, Iraq, Kuwait and Iran, relatively higher influence ratings (as compared to other stakeholders, like the United States and Russia) because Saudi Arabia, Iraq, Kuwait and Iran produce and export much more oil than any of the other stakeholders, and therefore exercise more sway over the worldwide oil market.

Importantly, a stakeholder's relative power on a particular issue is not always equal to, or commensurate with, that stakeholder's relative level of concern about the issue. In many cases, a particularly powerful stakeholder may not care as much about the issue as a stakeholder who exercises considerably less power in respect to the same issue. For this reason, along with factoring in the influence ratings for each stakeholder, it can be just as important, or sometimes more important, to factor in each stakeholder's level of concern about the issue. Consequently, step S315 of FIG. 3 also includes receiving and storing the selected stakeholder's level of concern about the defined issue. Therefore, in addition to listing the stated positions of each stakeholder, Table 7 also includes columns indicating each stakeholder's relative influence rating and level of concern on the defined issue of “What to do for lunch.”

TABLE 7
RELATIVE INFLUENCE RATINGS AND LEVELS
OF CONCERN FOR STAKEHOLDERS

| | STATED | INFLUENCE | LEVEL |
|---|---|---|---|
| STAKEHOLDER | POSITION | RATING | OF CONCERN |
| JANE | CHIPOTLE | 100 | 40 |
| CARL | SUBWAY | 90 | 60 |

Based on the entries in the third and fourth columns of Table 7 above, it can be seen that the two stakeholders, Jane and Carl, have different levels of influence on the defined issue of “What to do for Lunch,” as well as different levels of concern about the issue. In particular, Jane's relative influence rating (100) on the issue is higher than Carl's relative influence rating (90) on the same issue because Jane has been determined by the user, the system operator, a subject matter expert, or some combination of two or more of them, to have more power than Carl on this issue. On the other hand, Carl may have shown by his past history, his recent statements or by some other indicator, to care about the lunch issue considerably more than Jane cares about this issue. This information results in Carl's relative level of concern being rated at 60, while Jane's relative level of concern is rated at only 40.

In step S320 of FIG. 3, each stakeholder's influence rating is weighted based on the stakeholder's level of concern about the issue. There are a variety of different ways to weight the stakeholders' relative influence rating based on their relative levels of concern. One way to accomplish the weighting, for example, is to multiply the stakeholder's relative influence rating by the stakeholder's relative level of concern to produce a concern-weighted relative influence rating for each stakeholder. In our lunch example, carrying out this multiplication produces a concern-weighted relative influence rating of 4,000 for Jane, and a concern-weighted relative influence rating of 5,400 for Carl. Therefore, Carl's concern-weighted relative influence rating is actually higher than Jane's concern-weighted relative influence rating, despite the fact that Jane's unweighted relative influence rating is higher than Carl's unweighted relative influence rating.

In some embodiments of the present invention, the relative influence ratings are weighted by the levels of concern immediately so that the concern-weighted relative influence ratings can be stored on the system for later use in calculating influence- and concern-weighted utility payoffs for each possible outcome scenario in the range of possible outcome scenarios. In alternative embodiments, the relative influence ratings for each stakeholder may be stored separately from the levels of concern for each stakeholder (without first performing the weighting calculation) so that the relative influence ratings and the relative levels of concern can be retrieved separately at a later point in time and then used at that later point in time to calculate both egalitarian utility payoffs for each possible outcome scenario and influence- and concern-weighted utility payoffs for each possible outcome scenario. In still other embodiments, the entire process of receiving and recording relative influence ratings and relative levels of concern may be deferred until they are needed for the calculations that are performed in Stage IV of operation, which will be discussed in more detail below with reference to FIG. 5. In still further embodiments, the stakeholders' levels of concern for the issue are optional considerations, and thus may not be factored into the calculations for ranking the outcome scenarios and determining the most likely outcome scenario in the range of possible outcome scenarios.

Next, as shown in step S325 of FIG. 3, the system receives and records, for the selected stakeholder, a rank ordering of the factors in the defined set of factors based on the selected stakeholder's subjective opinions about the relative importance of each factor to the range of possible outcome scenarios. Typically, in order to receive this input, the selected stakeholder provides a ranking of the factors in the defined set of factors in accordance with the selected stakeholder's priorities. However, it will be appreciated that this input may also be acquired from the user, the system operator, a subject matter expert, or a combination of two or more thereof, based on available information and/or research about the stakeholder, rather than information that comes directly from the selected stakeholder.

Regardless of how the information for the factor rankings is acquired, factor rankings essentially show the stakeholder's actual or perceived opinions about the importance of each factor relative to all of the other factors in the defined set of factors. Tables 8 and 9 below show the two stakeholders' rank-ordering of the factors in the defined set of factors for the lunch example. In these two tables, lower numbers in the rank column means the corresponding factor is considered relatively more important, while higher numbers in the rank column means the corresponding factor is considered to be of relatively lesser importance. Because there are four factors in our example, the factor considered by the stakeholder to be the most important factor will be assigned a rank of “1” and the factor that is considered by the stakeholder to be the least important will be assigned a rank of “4.”

Based on the rankings provided by (or on behalf of) stakeholder Jane in Table 8, we see that, as between the four defined factors of Health, Taste, Cost and Distance, Jane's position is that the most important factor is the health impact of the food, followed next by the cost of the food, then the taste of the food, and finally the distance to the restaurant. However, stakeholder Carl's rankings for the same factors are not the same as Jane's rankings for those factors. Based on the rankings provided by (or on behalf of) stakeholder Carl in Table 9, we can see that, as between the four defined factors of Health, Taste, Cost and Distance, Carl's position is that the most important factor is the taste of the food, followed next by the distance to the restaurant, then the health impact of the food, and finally the cost of the food.

TABLE 8
JANE'S FACTOR RANKINGS

| FACTOR | RANK |
|---|---|
| HEALTH | 1 |
| COST | 2 |
| TASTE | 3 |
| DISTANCE | 4 |

TABLE 9
CARL'S FACTOR RANKINGS

| FACTOR | RANK |
|---|---|
| TASTE | 1 |
| DISTANCE | 2 |
| HEALTH | 3 |
| COST | 4 |

As shown in steps S330 and S335 of FIG. 3, embodiments of the present invention also select a factor and then receive and record, for the selected stakeholder and the selected factor, a rank ordering of the options in the defined range of options for the selected factor based on the selected stakeholder's subjective opinions about the importance of each option in the range of options relative to the importance of all of the other options in the range of options for that factor. Like the factor rankings described above, the option rankings for each stakeholder may also be acquired directly from the stakeholders, or alternatively, acquired from the user, the system operator, a subject matter expert, or a combination of two or more thereof, based on available information and/or research about the stakeholder, rather than information that comes directly from the stakeholder. Tables 10 and 11 below show, respectively, the rank-ordered lists of options for each one of the factors in the defined set of factors for the lunch example. In both of these two tables, lower numbers in the rank column means the corresponding option is considered to be relatively more important, while higher numbers in the rank column means the corresponding factor is considered to be of relatively less importance. Accordingly, the option with the rank number of “1” is considered to be more important (or a higher priority) than the options having ranks of 2, 3 and 4.

TABLE 10
JANE'S OPTION RANKINGS

| | RANK |
|---|---|
| HEALTH OPTIONS | |
| MODERATELY HEALTHY | 1 |
| VERY HEALTHY | 2 |
| MODERATELY UNHEALTHY | 3 |
| NEUTRAL | 4 |
| VERY UNHEALTHY | 5 |
| COST OPTIONS | |
| VERY INEXPENSIVE | 1 |
| FREE | 2 |
| MODERATELY INEXPENSIVE | 3 |
| MODERATELY EXPENSIVE | 4 |
| VERY EXPENSIVE | 5 |
| TASTE OPTIONS | |
| SUCCULENT | 1 |
| DELICIOUS | 2 |
| SAVORY | 3 |
| GOOD-TASTING | 4 |
| ACCEPTABLE | 5 |
| DISTANCE OPTIONS | |
| MODERATELY CLOSE | 1 |
| VERY CLOSE | 2 |
| MODERATELY FAR | 3 |
| VERY FAR | 4 |
| NONE | 5 |

Based on Jane's rank-ordering of all of the options for all of the factors in Table 10 above, it can be seen that Jane's first preferences for each of the four factors is that lunch be moderately healthy, very inexpensive, scrumptious and moderately close. Because Jane previously ranked the factors in order of importance and/or preference to her, and gave the Health factor a higher rank than the Cost factor (see Table 8), it should also be evident that, given a choice between moderately healthy food and very inexpensive food, it is more important to Jane that the food be moderately healthy than it is for the food to be very inexpensive. In other words, to Jane, the Health factor matters more than the Cost factor, the Cost factor matters more than the Taste factor, and the Taste factor matters more than the Distance factor.

TABLE 11
CARL'S OPTION RANKINGS

| | RANK |
|---|---|
| TASTE OPTIONS | |
| SAVORY | 1 |
| GOOD-TASTING | 2 |
| DELICIOUS | 3 |
| ACCEPTABLE | 4 |
| SUCCULENT | 5 |
| DISTANCE OPTIONS | |
| MODERATELY FAR | 1 |
| VERY FAR | 2 |
| MODERATELY CLOSE | 3 |
| VERY CLOSE | 4 |
| NONE | 5 |
| HEALTH OPTIONS | |
| NEUTRAL | 1 |
| MODERATELY HEALTHY | 2 |
| VERY HEALTHY | 3 |
| MODERATELY UNHEALTHY | 4 |
| VERY UNHEALTHY | 5 |
| COST OPTIONS | |
| MODERATELY EXPENSIVE | 1 |
| VERY EXPENSIVE | 2 |
| MODERATELY INEXPENSIVE | 3 |
| VERY EXPENSIVE | 4 |
| FREE | 5 |

Based on Carl's rankings of all of the options for all of the factors in Table 11 above, it is apparent that Carl's first preference for each one of the four factors is that lunch be yummy, moderately far away, relatively neutral as far as health impact, and moderately expensive. Because Carl previously ranked the factors in order of importance and/or preference to him, and gave the Taste factor a higher rank than the Distance, Health and Cost factors (see Table 9), it should also be apparent that, given a choice between going to restaurant with yummy food and going to a restaurant that is moderately far away, Carl prefers to go to a restaurant where the food is considered yummy. In other words, to Carl, the Taste factor matters more than the Distance factor, the Distance factor matters more than the Health factor, and the Health factor matters more than the Cost factor.

As illustrated by steps S330 and S335, embodiments of the present invention are configured to select a first factor in the defined set of factors and then receive and record a rank-ordered list of options for all of the options associated with the selected factor. When all of the options for the selected factor have been ranked, the system selects the next factor, and then ranks all of the options for that next selected factor, until all of the options for all of the factors have been ranked for the selected stakeholder. See the loop defined by steps S335, S340 and S345 in FIG. 3. Then the system selects the next stakeholder and repeats the entire process of receiving and recording ranked orderings of factors and ranked orderings of options until all of the options and all of the factors for all of the stakeholders have been ranked. See the programmatic loop defined by steps S315, S320, S325, S330, S335, S340, S345, S350 and S355 in FIG. 3. At this point, Stages I and II of operation, which include receiving and recording all of the issue input parameters and all of the stakeholder input parameters, respectively, have been completed. Therefore, the third stage (Stage III) of operation is now set to begin.

In general, Stage III begins by selecting one of the stakeholders, and then producing for the selected stakeholder a reverse induction combination table of possible outcome scenarios. The reverse induction combination table, which could also be referred to as a “fractional factorial” table, comprises a table that arranges all of the possible combinations of factors and options based on the selected stakeholder's previously recorded factor and option rankings. The reverse induction combination table is then converted into a utility payoff schedule for the selected stakeholder by assigning utility payoff scores to every possible combination in the reverse induction combination table, starting with the assignment of a utility payoff score of “0” to the combination of options in the reverse induction combination table corresponding to the previously defined status quo outcome scenario for the defined issue. Then the combinations of options in the utility payoff schedule are compared against the combinations of options in the previously recorded scenario pathway table in order to find and record, for the selected stakeholder, the reality-based utility payoff scores for each one of the possible outcome scenarios in the range of possible outcome scenarios. Next, the reality-based utility payoff scores for each one of the possible outcome scenarios for the selected stakeholder are compared against each other to determine and record a reality-based position for the selected stakeholder. The reality-based position for the selected stakeholder is the possible outcome scenario that has the most positive (or least negative) utility payoff score for the selected stakeholder. Notably, the reality-based payoff position for a selected stakeholder may be different from the previously recorded stated position for that stakeholder. The present invention's ability to reveal the reality-based position of each stakeholder is one of the benefits the invention has over conventional techniques for predicting the most likely outcome scenarios for defined issues involving multiple stakeholders. Finally, all of the steps described in this paragraph are repeated for the rest of the stakeholders so that, by the conclusion of Stage III, a reality-based position for every stakeholder, as well as a reality-based utility payoff score for every stakeholder and every possible outcome scenario, will have been determined and recorded.

The specific procedures used by embodiments of the present invention to create, manipulate and analyze the data in the scenario pathway table, the reverse induction combination tables and the utility payoff schedules for each stakeholder will now be described in more detail below with reference to FIG. 4. It is understood that some or all of these steps may be carried out automatically by a microprocessor operating under the control of one or more software- or firmware-based computer programs, the computer programs comprising programming instructions suitably arranged and configured to cause the microprocessor to automatically acquire the issue and stakeholder input parameters from a user and/or memory storage area, and then use those input parameters to automatically create, track and manipulate data structures in the memory storage area, the data structures holding the data (described below) that goes into the reverse induction combination tables and utility payoff schedules for the stakeholders. It is also understood, however, that these steps also may be carried out using manual, non-automated methods (i.e., without the aid of a computer microprocessor). It is further understood that these steps may be carried out using a combination of manual and semi-automated methods, as would be the case, for example, when a human operator types or copies the issue and stakeholder input parameters into the fields of an electronic spreadsheet or text document displayed on the display screen of a personal computer, and then uses keyboard and/or mouse controls, in combination with conventional computer spreadsheet and word processing functions, to manipulate and process the data in the spreadsheet or document for the purpose of creating and analyzing the reverse induction combination tables and utility payoff schedules as descried herein. All such manual, automated and semi-automated techniques for carrying out the steps described herein for State III are considered to fall within the scope of the claimed systems and methods. For clarity and ease of comprehension, however, the following discussion will describe how the steps of Stage III may be carried out in the manual and/or semi-automated embodiments of the present invention.

FIG. 4 contains a high-level flow diagram 400 illustrating at a more detailed level some of the steps performed during Stage III of operation to create and organize the reverse induction combination tables and utility payoff schedules for each stakeholder, and to determine the reality-based utility payoff scores and the reality-based positions for all of the stakeholders according to one embodiment of the present invention. As shown at steps S405 and S410 of FIG. 4, the first step is the select one of the stakeholders and generate a reverse induction combination table for that selected stakeholder. One way of creating the reverse induction combination table is to create (or draw) a two dimensional table of factor and option combinations based on the factor rankings and the option rankings previously provided for the selected stakeholder. The two-dimensional table is built by first selecting the selected stakeholder's lowest ranked (i.e., least important) factor and creating a column of cells containing all of the options for that lowest ranked factor, the options being listed in order from the most important option to the least important option, in accordance with the selected stakeholder's option rankings for the lowest ranked factor. Then a second column of cells is created next to the first column of cells, the second column of cells containing all of the options for the second lowest ranked factor. Starting with the stakeholder's highest ranked option for the second lowest ranked factor, the values for the options in the second column are arranged so that the highest ranked option for the second lowest ranked factor is combined at least once with every option for the lowest ranked factor in the first column, and the second highest ranked option for the second lowest ranked factor is at least once combined with every option for the lowest ranked factor in the first column, and so on. Arranging the second column in this fashion creates a two-dimensional table with a sufficient number of rows to represent every possible combination of options for the lowest ranked and second lowest ranked factors.

Next, a third column is created next to the second column of cells, the third column of cells containing all of the options for the third lowest ranked factor. Starting with the highest ranked option for the third lowest ranked factor, the values for the options in the third column are arranged so that every option for the third lowest ranked factor is at least once combined with every option for the second lowest ranked factor in the second column and at least once combined with every option for the lowest ranked factor in the first column, thereby extending the two-dimensional table to contain a separate row for every possible combination of options for the lowest ranked, second lowest ranked and third lowest ranked factors. This process is repeated until there exists a column of ranked options in the two-dimensional table for every one of the factors ranked by the selected stakeholder, as well as a row in the two-dimensional table that represents every possible combination of options and factors. The resulting two-dimensional table is referred to herein as the reverse induction combination table for the selected stakeholder.

To illustrate the process of building the reverse induction combination table in our lunch example, assume that the first selected stakeholder is Jane. As shown in Table 10 above, Jane ranked “Distance” as the least important factor and he ranked “Moderately Close” as the most important option for the “Distance” factor. Therefore, the first column of cells created for Jane's reverse induction combination table would be organized as shown immediately below.

TABLE 12
REVERSE INDUCTION COMBINATION TABLE (PARTIAL)

Distance
Moderately Close
Very Close
Moderately Far
Very Far
None

As also shown in Table 10 above, Jane ranked “Taste” as the second least important factor and “Succulent” as the most important option for the Taste factor. Therefore, a second column is created for Jane on the immediate left side of the Distance column, the second column containing in every cell Jane's highest ranked option (Succulent) for Jane's second least important factor (Taste), which results in a two-dimensional table that looks like this:

TABLE 13
REVERSE INDUCTION COMBINATION TABLE (PARTIAL)

| Taste | Distance |
|---|---|
| Succulent | Moderately Close |
| Succulent | Very Close |
| Succulent | Moderately Far |
| Succulent | Very Far |
| Succulent | None |

Next, a sufficient number of rows is added to the two-dimensional table above so that the table will contain a separate row for every possible combination of Distance and Taste options. Put another way, all of the remaining options (“Delicious,” “Savory,” “Good-Tasting” and “Acceptable”) for the second least important factor (Taste) are added to the second column of cells, and the sequence of options in the first column of cells for the least important factor (“Distance”) is repeated until there exists a row in the two-dimensional table for every possible combination of options for the Taste and Distance factors. The Distance and Taste options are sequenced in the table to match the rankings Jane gave to these options as shown in Table 10 above. Thus, the two-dimensional table above is extended downward to create a table that appears as follows:

TABLE 14
REVERSE INDUCTION COMBINATION TABLE (PARTIAL)

| Taste | Distance |
|---|---|
| Succulent | Moderately Close |
| Succulent | Very Close |
| Succulent | Moderately Far |
| Succulent | Very Far |
| Succulent | None |
| Delicious | Moderately Close |
| Delicious | Very Close |
| Delicious | Moderately Far |
| Delicious | Very Far |
| Delicious | None |
| Savory | Moderately Close |
| Savory | Very Close |
| Savory | Moderately Far |
| Savory | Very Far |
| Savory | None |
| Good-Tasting | Moderately Close |
| Good-Tasting | Very Close |
| Good-Tasting | Moderately Far |
| Good-Tasting | Very Far |
| Good-Tasting | None |
| Acceptable | Moderately Close |
| Acceptable | Very Close |
| Acceptable | Moderately Far |
| Acceptable | Very Far |
| Acceptable | None |

This process is repeated for all of the other factors until the reverse induction combination table for Jane contains a column of options for every one of the factors in the set of factors, as well as a row of options for every possible combination of factor options. Since there are four factors in our lunch example, and five possible options for each factor, Jane's reverse induction combination table will contain a total of 5⁴ (or 625) different combinations of options (represented in a table containing 4 columns and 625 different rows) by the end of performing step S410 in FIG. 4. Thus, the top portion of Jane's reverse induction combination table would look as shown in Table 15 below at the end of step S410 (for the sake of brevity, only the top eleven rows of Jane's reverse induction combination table are shown in Table 15):

TABLE 15
REVERSE INDUCTION COMBINATION TABLE (PARTIAL)

| Health | Cost | Taste | Distance |
|---|---|---|---|
| Moderately Healthy | Very Inexpensive | Succulent | Moderately Close |
| Moderately Healthy | Very Inexpensive | Succulent | Very Close |
| Moderately Healthy | Very Inexpensive | Succulent | Moderately Far |
| Moderately Healthy | Very Inexpensive | Succulent | Very Far |
| Moderately Healthy | Very Inexpensive | Succulent | None |
| Moderately Healthy | Very Inexpensive | Delicious | Moderately Close |
| Moderately Healthy | Very Inexpensive | Delicious | Very Close |
| Moderately Healthy | Very Inexpensive | Delicious | Moderately Far |
| Moderately Healthy | Very Inexpensive | Delicious | Very Far |
| Moderately Healthy | Very Inexpensive | Delicious | None |
| Moderately Healthy | Very Inexpensive | Savory | Moderately Close |

Next, a utility payoff column is added to the reverse induction combination table, the utility payoff column containing a utility payoff score for each and every combination of options (i.e., each row) in the reverse induction combination table. The values for the cells in the utility payoff column are determined and assigned in two sub steps. In the first sub step, the reverse induction combination table is searched for the row containing the combination of options that exactly matches the combination of options in the scenario pathway table (shown in Table 5 above) corresponding to the status quo outcome scenario. When that row is found, that combination (row) is assigned a utility payoff score of zero (“0”). In this case, the status quo outcome scenario is doing “NOTHING” for lunch, and the combination of options corresponding to the status quo scenario of Doing “Nothing” for lunch is the combination of the “MODERATELY HEALTHY” option for the Health factor, “ACCEPTABLE” option for the Taste factor, the “FREE” option for the Cost factor and the “NONE” option for the Distance factor. See Table 16 below containing the combination from the scenario pathway table corresponding to the status quo scenario. Accordingly, Jane's reverse induction combination table is searched to find the one row containing the option combination of “MODERATELY HEALTHY,” “ACCEPTABLE,” “FREE” and “NONE,” and then a utility payoff score of zero (“0”) is placed in the cell of the utility payoff column next to that particular combination.

TABLE 16
STATUS QUO SCENARIO FACTOR OPTION COMBINATION

| | HEALTH | TASTE | COST | DISTANCE |
|---|---|---|---|---|
| NOTHING | MODERATELY | ACCEPT- | FREE | NONE |
| (STATUS QUO) | UNHEALTHY | ABLE | | |

Next, as shown in step S420 of FIG. 4, and starting from the row in the reverse induction combination table with the utility payoff score of “0” corresponding to the status quo outcome scenario, an ordinal array is run in both directions up and down the reverse induction combination table to assign relatively higher and lower utility payoff scores, respectively, to every other combination (row) in the selected stakeholder's reverse induction combination table as one moves away from the combination containing the zero utility payoff score. One method of running the ordinal array comprises successively incrementing the assigned utility payoff score by one for each row as one runs up the reverse induction combination table (starting from the row containing the “0” score), and decrementing the assigned utility payoff score by one for each row as one runs down one row in the reverse induction combination table. It should be understood by those reading this disclosure, however, that the sizes of the increment and decrement does not have to be “1” so long as the values in each row are relatively higher as one moves up the table and relatively lower as one moves down the table. So, for example, the scores could be assigned by choosing to increment and decrement the scores by “2” or “5” or “100,” without departing from the scope of the present invention.

As stated previously, Jane's reverse induction combination table contains a total of 625 rows of option combinations. The row in Jane's reverse induction combination table, which contains the set of options as the status quo scenario (“MODERATELY HEALTHY,” “ACCEPTABLE,” “FREE” and “NONE”), happens to be the row that is exactly 299 rows below the top row in the table and exactly 325 rows above the bottom row in the table. Accordingly, the 300th row in the table (counting from the top) is selected as the status quo row in Jane's reverse induction combination table and that particular row is given a utility payoff score of “0.” Then an ordinal array is run in both directions up and down Jane's reverse induction combination table to produce the utility payoff schedule shown in Table 17 below.

TABLE 17
JANE'S UTILITY PAYOFF SCHEDULE (COMPLETE)

| | | | | Utility | |
|---|---|---|---|---|---|
| | | | | Payoff | Each Defined |
| Health | Cost | Taste | Distance | Score | Scenario |
| Moderately | Very Inexpensive | Succulent | Moderately | 299 | |
| Healthy | | | Close | | |
| Moderately | Very Inexpensive | Succulent | Very Close | 298 | |
| Healthy | | | | | |
| Moderately | Very Inexpensive | Succulent | Moderately | 297 | |
| Healthy | | | Far | | |
| Moderately | Very Inexpensive | Succulent | Very Far | 296 | |
| Healthy | | | | | |
| Moderately | Very Inexpensive | Succulent | None | 295 | |
| Healthy | | | | | |
| Moderately | Very Inexpensive | Delicious | Moderately | 294 | |
| Healthy | | | Close | | |
| Moderately | Very Inexpensive | Delicious | Very Close | 293 | |
| Healthy | | | | | |
| Moderately | Very Inexpensive | Delicious | Moderately | 292 | |
| Healthy | | | Far | | |
| Moderately | Very Inexpensive | Delicious | Very Far | 291 | |
| Healthy | | | | | |
| Moderately | Very Inexpensive | Delicious | None | 290 | |
| Healthy | | | | | |
| Moderately | Very Inexpensive | Savory | Moderately | 289 | |
| Healthy | | | Close | | |
| Moderately | Very Inexpensive | Savory | Very Close | 288 | |
| Healthy | | | | | |
| Moderately | Very Inexpensive | Savory | Moderately | 287 | |
| Healthy | | | Far | | |
| Moderately | Very Inexpensive | Savory | Very Far | 286 | |
| Healthy | | | | | |
| Moderately | Very Inexpensive | Savory | None | 285 | |
| Healthy | | | | | |
| Moderately | Very Inexpensive | Good-Tasting | Moderately | 284 | |
| Healthy | | | Close | | |
| Moderately | Very Inexpensive | Good-Tasting | Very Close | 283 | |
| Healthy | | | | | |
| Moderately | Very Inexpensive | Good-Tasting | Moderately | 282 | |
| Healthy | | | Far | | |
| Moderately | Very Inexpensive | Good-Tasting | Very Far | 281 | |
| Healthy | | | | | |
| Moderately | Very Inexpensive | Good-Tasting | None | 280 | |
| Healthy | | | | | |
| Moderately | Very Inexpensive | Acceptable | Moderately | 279 | |
| Healthy | | | Close | | |
| Moderately | Very Inexpensive | Acceptable | Very Close | 278 | |
| Healthy | | | | | |
| Moderately | Very Inexpensive | Acceptable | Moderately | 277 | |
| Healthy | | | Far | | |
| Moderately | Very Inexpensive | Acceptable | Very Far | 276 | |
| Healthy | | | | | |
| Moderately | Very Inexpensive | Acceptable | None | 275 | |
| Healthy | | | | | |
| Moderately | Free | Succulent | Moderately | 274 | |
| Healthy | | | Close | | |
| Moderately | Free | Succulent | Very Close | 273 | |
| Healthy | | | | | |
| Moderately | Free | Succulent | Moderately | 272 | |
| Healthy | | | Far | | |
| Moderately | Free | Succulent | Very Far | 271 | |
| Healthy | | | | | |
| Moderately | Free | Succulent | None | 270 | |
| Healthy | | | | | |
| Moderately | Free | Delicious | Moderately | 269 | |
| Healthy | | | Close | | |
| Moderately | Free | Delicious | Very Close | 268 | |
| Healthy | | | | | |
| Moderately | Free | Delicious | Moderately | 267 | |
| Healthy | | | Far | | |
| Moderately | Free | Delicious | Very Far | 266 | |
| Healthy | | | | | |
| Moderately | Free | Delicious | None | 265 | |
| Healthy | | | | | |
| Moderately | Free | Savory | Moderately | 264 | |
| Healthy | | | Close | | |
| Moderately | Free | Savory | Very Close | 263 | |
| Healthy | | | | | |
| Moderately | Free | Savory | Moderately | 262 | |
| Healthy | | | Far | | |
| Moderately | Free | Savory | Very Far | 261 | |
| Healthy | | | | | |
| Moderately | Free | Savory | None | 260 | |
| Healthy | | | | | |
| Moderately | Free | Good-Tasting | Moderately | 259 | |
| Healthy | | | Close | | |
| Moderately | Free | Good-Tasting | Very Close | 258 | |
| Healthy | | | | | |
| Moderately | Free | Good-Tasting | Moderately | 257 | |
| Healthy | | | Far | | |
| Moderately | Free | Good-Tasting | Very Far | 256 | |
| Healthy | | | | | |
| Moderately | Free | Good-Tasting | None | 255 | |
| Healthy | | | | | |
| Moderately | Free | Acceptable | Moderately | 254 | |
| Healthy | | | Close | | |
| Moderately | Free | Acceptable | Very Close | 253 | |
| Healthy | | | | | |
| Moderately | Free | Acceptable | Moderately | 252 | |
| Healthy | | | Far | | |
| Moderately | Free | Acceptable | Very Far | 251 | |
| Healthy | | | | | |
| Moderately | Free | Acceptable | None | 250 | |
| Healthy | | | | | |
| Moderately | Moderately | Succulent | Moderately | 249 | |
| Healthy | Inexpensive | | Close | | |
| Moderately | Moderately | Succulent | Very Close | 248 | |
| Healthy | Inexpensive | | | | |
| Moderately | Moderately | Succulent | Moderately | 247 | |
| Healthy | Inexpensive | | Far | | |
| Moderately | Moderately | Succulent | Very Far | 246 | |
| Healthy | Inexpensive | | | | |
| Moderately | Moderately | Succulent | None | 245 | |
| Healthy | Inexpensive | | | | |
| Moderately | Moderately | Delicious | Moderately | 244 | |
| Healthy | Inexpensive | | Close | | |
| Moderately | Moderately | Delicious | Very Close | 243 | |
| Healthy | Inexpensive | | | | |
| Moderately | Moderately | Delicious | Moderately | 242 | |
| Healthy | Inexpensive | | Far | | |
| Moderately | Moderately | Delicious | Very Far | 241 | |
| Healthy | Inexpensive | | | | |
| Moderately | Moderately | Delicious | None | 240 | |
| Healthy | Inexpensive | | | | |
| Moderately | Moderately | Savory | Moderately | 239 | |
| Healthy | Inexpensive | | Close | | |
| Moderately | Moderately | Savory | Very Close | 238 | |
| Healthy | Inexpensive | | | | |
| Moderately | Moderately | Savory | Moderately | 237 | |
| Healthy | Inexpensive | | Far | | |
| Moderately | Moderately | Savory | Very Far | 236 | |
| Healthy | Inexpensive | | | | |
| Moderately | Moderately | Savory | None | 235 | |
| Healthy | Inexpensive | | | | |
| Moderately | Moderately | Good-Tasting | Moderately | 234 | |
| Healthy | Inexpensive | | Close | | |
| Moderately | Moderately | Good-Tasting | Very Close | 233 | |
| Healthy | Inexpensive | | | | |
| Moderately | Moderately | Good-Tasting | Moderately | 232 | |
| Healthy | Inexpensive | | Far | | |
| Moderately | Moderately | Good-Tasting | Very Far | 231 | — |
| Healthy | Inexpensive | | | | |
| Moderately | Moderately | Good-Tasting | None | 230 | |
| Healthy | Inexpensive | | | | |
| Moderately | Moderately | Acceptable | Moderately | 229 | |
| Healthy | Inexpensive | | Close | | |
| Moderately | Moderately | Acceptable | Very Close | 228 | |
| Healthy | Inexpensive | | | | |
| Moderately | Moderately | Acceptable | Moderately | 227 | |
| Healthy | Inexpensive | | Far | | |
| Moderately | Moderately | Acceptable | Very Far | 226 | |
| Healthy | Inexpensive | | | | |
| Moderately | Moderately | Acceptable | None | 225 | |
| Healthy | Inexpensive | | | | |
| Moderately | Moderately | Succulent | Moderately | 224 | |
| Healthy | Expensive | | Close | | |
| Moderately | Moderately | Succulent | Very Close | 223 | |
| Healthy | Expensive | | | | |
| Moderately | Moderately | Succulent | Moderately | 222 | |
| Healthy | Expensive | | Far | | |
| Moderately | Moderately | Succulent | Very Far | 221 | |
| Healthy | Expensive | | | | |
| Moderately | Moderately | Succulent | None | 220 | |
| Healthy | Expensive | | | | |
| Moderately | Moderately | Delicious | Moderately | 219 | |
| Healthy | Expensive | | Close | | |
| Moderately | Moderately | Delicious | Very Close | 218 | |
| Healthy | Expensive | | | | |
| Moderately | Moderately | Delicious | Moderately | 217 | |
| Healthy | Expensive | | Far | | |
| Moderately | Moderately | Delicious | Very Far | 216 | |
| Healthy | Expensive | | | | |
| Moderately | Moderately | Delicious | None | 215 | |
| Healthy | Expensive | | | | |
| Moderately | Moderately | Savory | Moderately | 214 | |
| Healthy | Expensive | | Close | | |
| Moderately | Moderately | Savory | Very Close | 213 | |
| Healthy | Expensive | | | | |
| Moderately | Moderately | Savory | Moderately | 212 | |
| Healthy | Expensive | | Far | | |
| Moderately | Moderately | Savory | Very Far | 211 | |
| Healthy | Expensive | | | | |
| Moderately | Moderately | Savory | None | 210 | |
| Healthy | Expensive | | | | |
| Moderately | Moderately | Good-Tasting | Moderately | 209 | |
| Healthy | Expensive | | Close | | |
| Moderately | Moderately | Good-Tasting | Very Close | 208 | |
| Healthy | Expensive | | | | |
| Moderately | Moderately | Good-Tasting | Moderately | 207 | |
| Healthy | Expensive | | Far | | |
| Moderately | Moderately | Good-Tasting | Very Far | 206 | |
| Healthy | Expensive | | | | |
| Moderately | Moderately | Good-Tasting | None | 205 | |
| Healthy | Expensive | | | | |
| Moderately | Moderately | Acceptable | Moderately | 204 | |
| Healthy | Expensive | | Close | | |
| Moderately | Moderately | Acceptable | Very Close | 203 | |
| Healthy | Expensive | | | | |
| Moderately | Moderately | Acceptable | Moderately | 202 | |
| Healthy | Expensive | | Far | | |
| Moderately | Moderately | Acceptable | Very Far | 201 | |
| Healthy | Expensive | | | | |
| Moderately | Moderately | Acceptable | None | 200 | |
| Healthy | Expensive | | | | |
| Moderately | Very Expensive | Succulent | Moderately | 199 | |
| Healthy | | | Close | | |
| Moderately | Very Expensive | Succulent | Very Close | 198 | |
| Healthy | | | | | |
| Moderately | Very Expensive | Succulent | Moderately | 197 | |
| Healthy | | | Far | | |
| Moderately | Very Expensive | Succulent | Very Far | 196 | |
| Healthy | | | | | |
| Moderately | Very Expensive | Succulent | None | 195 | |
| Healthy | | | | | |
| Moderately | Very Expensive | Delicious | Moderately | 194 | |
| Healthy | | | Close | | |
| Moderately | Very Expensive | Delicious | Very Close | 193 | |
| Healthy | | | | | |
| Moderately | Very Expensive | Delicious | Moderately | 192 | |
| Healthy | | | Far | | |
| Moderately | Very Expensive | Delicious | Very Far | 191 | |
| Healthy | | | | | |
| Moderately | Very Expensive | Delicious | None | 190 | |
| Healthy | | | | | |
| Moderately | Very Expensive | Savory | Moderately | 189 | |
| Healthy | | | Close | | |
| Moderately | Very Expensive | Savory | Very Close | 188 | |
| Healthy | | | | | |
| Moderately | Very Expensive | Savory | Moderately | 187 | |
| Healthy | | | Far | | |
| Moderately | Very Expensive | Savory | Very Far | 186 | |
| Healthy | | | | | |
| Moderately | Very Expensive | Savory | None | 185 | |
| Healthy | | | | | |
| Moderately | Very Expensive | Good-Tasting | Moderately | 184 | |
| Healthy | | | Close | | |
| Moderately | Very Expensive | Good-Tasting | Very Close | 183 | |
| Healthy | | | | | |
| Moderately | Very Expensive | Good-Tasting | Moderately | 182 | |
| Healthy | | | Far | | |
| Moderately | Very Expensive | Good-Tasting | Very Far | 181 | |
| Healthy | | | | | |
| Moderately | Very Expensive | Good-Tasting | None | 180 | |
| Healthy | | | | | |
| Moderately | Very Expensive | Acceptable | Moderately | 179 | |
| Healthy | | | Close | | |
| Moderately | Very Expensive | Acceptable | Very Close | 178 | |
| Healthy | | | | | |
| Moderately | Very Expensive | Acceptable | Moderately | 177 | |
| Healthy | | | Far | | |
| Moderately | Very Expensive | Acceptable | Very Far | 176 | |
| Healthy | | | | | |
| Moderately | Very Expensive | Acceptable | None | 175 | |
| Healthy | | | | | |
| Very Healthy | Very Inexpensive | Succulent | Moderately | 174 | |
| | | | Close | | |
| Very Healthy | Very Inexpensive | Succulent | Very Close | 173 | |
| Very Healthy | Very Inexpensive | Succulent | Moderately | 172 | |
| | | | Far | | |
| Very Healthy | Very Inexpensive | Succulent | Very Far | 171 | |
| Very Healthy | Very Inexpensive | Succulent | None | 170 | |
| Very Healthy | Very Inexpensive | Delicious | Moderately | 169 | |
| | | | Close | | |
| Very Healthy | Very Inexpensive | Delicious | Very Close | 168 | |
| Very Healthy | Very Inexpensive | Delicious | Moderately | 167 | |
| | | | Far | | |
| Very Healthy | Very Inexpensive | Delicious | Very Far | 166 | |
| Very Healthy | Very Inexpensive | Delicious | None | 165 | |
| Very Healthy | Very Inexpensive | Savory | Moderately | 164 | |
| | | | Close | | |
| Very Healthy | Very Inexpensive | Savory | Very Close | 163 | |
| Very Healthy | Very Inexpensive | Savory | Moderately | 162 | |
| | | | Far | | |
| Very Healthy | Very Inexpensive | Savory | Very Far | 161 | |
| Very Healthy | Very Inexpensive | Savory | None | 160 | |
| Very Healthy | Very Inexpensive | Good-Tasting | Moderately | 159 | |
| | | | Close | | |
| Very Healthy | Very Inexpensive | Good-Tasting | Very Close | 158 | |
| Very Healthy | Very Inexpensive | Good-Tasting | Moderately | 157 | |
| | | | Far | | |
| Very Healthy | Very Inexpensive | Good-Tasting | Very Far | 156 | |
| Very Healthy | Very Inexpensive | Good-Tasting | None | 155 | |
| Very Healthy | Very Inexpensive | Acceptable | Moderately | 154 | |
| | | | Close | | |
| Very Healthy | Very Inexpensive | Acceptable | Very Close | 153 | |
| Very Healthy | Very Inexpensive | Acceptable | Moderately | 152 | |
| | | | Far | | |
| Very Healthy | Very Inexpensive | Acceptable | Very Far | 151 | |
| Very Healthy | Very Inexpensive | Acceptable | None | 150 | |
| Very Healthy | Free | Succulent | Moderately | 149 | |
| | | | Close | | |
| Very Healthy | Free | Succulent | Very Close | 148 | |
| Very Healthy | Free | Succulent | Moderately | 147 | |
| | | | Far | | |
| Very Healthy | Free | Succulent | Very Far | 146 | |
| Very Healthy | Free | Succulent | None | 145 | |
| Very Healthy | Free | Delicious | Moderately | 144 | |
| | | | Close | | |
| Very Healthy | Free | Delicious | Very Close | 143 | |
| Very Healthy | Free | Delicious | Moderately | 142 | |
| | | | Far | | |
| Very Healthy | Free | Delicious | Very Far | 141 | |
| Very Healthy | Free | Delicious | None | 140 | |
| Very Healthy | Free | Savory | Moderately | 139 | |
| | | | Close | | |
| Very Healthy | Free | Savory | Very Close | 138 | |
| Very Healthy | Free | Savory | Moderately | 137 | |
| | | | Far | | |
| Very Healthy | Free | Savory | Very Far | 136 | |
| Very Healthy | Free | Savory | None | 135 | |
| Very Healthy | Free | Good-Tasting | Moderately | 134 | |
| | | | Close | | |
| Very Healthy | Free | Good-Tasting | Very Close | 133 | |
| Very Healthy | Free | Good-Tasting | Moderately | 132 | |
| | | | Far | | |
| Very Healthy | Free | Good-Tasting | Very Far | 131 | |
| Very Healthy | Free | Good-Tasting | None | 130 | |
| Very Healthy | Free | Acceptable | Moderately | 129 | |
| | | | Close | | |
| Very Healthy | Free | Acceptable | Very Close | 128 | |
| Very Healthy | Free | Acceptable | Moderately | 127 | |
| | | | Far | | |
| Very Healthy | Free | Acceptable | Very Far | 126 | |
| Very Healthy | Free | Acceptable | None | 125 | |
| Very Healthy | Moderately | Succulent | Moderately | 124 | |
| | Inexpensive | | Close | | |
| Very Healthy | Moderately | Succulent | Very Close | 123 | |
| | Inexpensive | | | | |
| Very Healthy | Moderately | Succulent | Moderately | 122 | |
| | Inexpensive | | Far | | |
| Very Healthy | Moderately | Succulent | Very Far | 121 | |
| | Inexpensive | | | | |
| Very Healthy | Moderately | Succulent | None | 120 | |
| | Inexpensive | | | | |
| Very Healthy | Moderately | Delicious | Moderately | 119 | |
| | Inexpensive | | Close | | |
| Very Healthy | Moderately | Delicious | Very Close | 118 | |
| | Inexpensive | | | | |
| Very Healthy | Moderately | Delicious | Moderately | 117 | |
| | Inexpensive | | Far | | |
| Very Healthy | Moderately | Delicious | Very Far | 116 | |
| | Inexpensive | | | | |
| Very Healthy | Moderately | Delicious | None | 115 | |
| | Inexpensive | | | | |
| Very Healthy | Moderately | Savory | Moderately | 114 | |
| | Inexpensive | | Close | | |
| Very Healthy | Moderately | Savory | Very Close | 113 | |
| | Inexpensive | | | | |
| Very Healthy | Moderately | Savory | Moderately | 112 | |
| | Inexpensive | | Far | | |
| Very Healthy | Moderately | Savory | Very Far | 111 | |
| | Inexpensive | | | | |
| Very Healthy | Moderately | Savory | None | 110 | |
| | Inexpensive | | | | |
| Very Healthy | Moderately | Good-Tasting | Moderately | 109 | |
| | Inexpensive | | Close | | |
| Very Healthy | Moderately | Good-Tasting | Very Close | 108 | |
| | Inexpensive | | | | |
| Very Healthy | Moderately | Good-Tasting | Moderately | 107 | |
| | Inexpensive | | Far | | |
| Very Healthy | Moderately | Good-Tasting | Very Far | 106 | |
| | Inexpensive | | | | |
| Very Healthy | Moderately | Good-Tasting | None | 105 | |
| | Inexpensive | | | | |
| Very Healthy | Moderately | Acceptable | Moderately | 104 | |
| | Inexpensive | | Close | | |
| Very Healthy | Moderately | Acceptable | Very Close | 103 | |
| | Inexpensive | | | | |
| Very Healthy | Moderately | Acceptable | Moderately | 102 | |
| | Inexpensive | | Far | | |
| Very Healthy | Moderately | Acceptable | Very Far | 101 | |
| | Inexpensive | | | | |
| Very Healthy | Moderately | Acceptable | None | 100 | |
| | Inexpensive | | | | |
| Very Healthy | Moderately | Succulent | Moderately | 99 | |
| | Expensive | | Close | | |
| Very Healthy | Moderately | Succulent | Very Close | 98 | |
| | Expensive | | | | |
| Very Healthy | Moderately | Succulent | Moderately | 97 | |
| | Expensive | | Far | | |
| Very Healthy | Moderately | Succulent | Very Far | 96 | |
| | Expensive | | | | |
| Very Healthy | Moderately | Succulent | None | 95 | |
| | Expensive | | | | |
| Very Healthy | Moderately | Delicious | Moderately | 94 | |
| | Expensive | | Close | | |
| Very Healthy | Moderately | Delicious | Very Close | 93 | |
| | Expensive | | | | |
| Very Healthy | Moderately | Delicious | Moderately | 92 | |
| | Expensive | | Far | | |
| Very Healthy | Moderately | Delicious | Very Far | 91 | |
| | Expensive | | | | |
| Very Healthy | Moderately | Delicious | None | 90 | |
| | Expensive | | | | |
| Very Healthy | Moderately | Savory | Moderately | 89 | |
| | Expensive | | Close | | |
| Very Healthy | Moderately | Savory | Very Close | 88 | |
| | Expensive | | | | |
| Very Healthy | Moderately | Savory | Moderately | 87 | |
| | Expensive | | Far | | |
| Very Healthy | Moderately | Savory | Very Far | 86 | |
| | Expensive | | | | |
| Very Healthy | Moderately | Savory | None | 85 | |
| | Expensive | | | | |
| Very Healthy | Moderately | Good-Tasting | Moderately | 84 | |
| | Expensive | | Close | | |
| Very Healthy | Moderately | Good-Tasting | Very Close | 83 | |
| | Expensive | | | | |
| Very Healthy | Moderately | Good-Tasting | Moderately | 82 | |
| | Expensive | | Far | | |
| Very Healthy | Moderately | Good-Tasting | Very Far | 81 | |
| | Expensive | | | | |
| Very Healthy | Moderately | Good-Tasting | None | 80 | |
| | Expensive | | | | |
| Very Healthy | Moderately | Acceptable | Moderately | 79 | |
| | Expensive | | Close | | |
| Very Healthy | Moderately | Acceptable | Very Close | 78 | |
| | Expensive | | | | |
| Very Healthy | Moderately | Acceptable | Moderately | 77 | |
| | Expensive | | Far | | |
| Very Healthy | Moderately | Acceptable | Very Far | 76 | |
| | Expensive | | | | |
| Very Healthy | Moderately | Acceptable | None | 75 | |
| | Expensive | | | | |
| Very Healthy | Very Expensive | Succulent | Moderately | 74 | |
| | | | Close | | |
| Very Healthy | Very Expensive | Succulent | Very Close | 73 | |
| Very Healthy | Very Expensive | Succulent | Moderately | 72 | |
| | | | Far | | |
| Very Healthy | Very Expensive | Succulent | Very Far | 71 | |
| Very Healthy | Very Expensive | Succulent | None | 70 | |
| Very Healthy | Very Expensive | Delicious | Moderately | 69 | |
| | | | Close | | |
| Very Healthy | Very Expensive | Delicious | Very Close | 68 | |
| Very Healthy | Very Expensive | Delicious | Moderately | 67 | |
| | | | Far | | |
| Very Healthy | Very Expensive | Delicious | Very Far | 66 | |
| Very Healthy | Very Expensive | Delicious | None | 65 | |
| Very Healthy | Very Expensive | Savory | Moderately | 64 | |
| | | | Close | | |
| Very Healthy | Very Expensive | Savory | Very Close | 63 | |
| Very Healthy | Very Expensive | Savory | Moderately | 62 | |
| | | | Far | | |
| Very Healthy | Very Expensive | Savory | Very Far | 61 | |
| Very Healthy | Very Expensive | Savory | None | 60 | |
| Very Healthy | Very Expensive | Good-Tasting | Moderately | 59 | |
| | | | Close | | |
| Very Healthy | Very Expensive | Good-Tasting | Very Close | 58 | |
| Very Healthy | Very Expensive | Good-Tasting | Moderately | 57 | |
| | | | Far | | |
| Very Healthy | Very Expensive | Good-Tasting | Very Far | 56 | |
| Very Healthy | Very Expensive | Good-Tasting | None | 55 | |
| Very Healthy | Very Expensive | Acceptable | Moderately | 54 | |
| | | | Close | | |
| Very Healthy | Very Expensive | Acceptable | Very Close | 53 | |
| Very Healthy | Very Expensive | Acceptable | Moderately | 52 | |
| | | | Far | | |
| Very Healthy | Very Expensive | Acceptable | Very Far | 51 | |
| Very Healthy | Very Expensive | Acceptable | None | 50 | |
| Moderately | Very Inexpensive | Succulent | Moderately | 49 | |
| Unhealthy | | | Close | | |
| Moderately | Very Inexpensive | Succulent | Very Close | 48 | |
| Unhealthy | | | | | |
| Moderately | Very Inexpensive | Succulent | Moderately | 47 | |
| Unhealthy | | | Far | | |
| Moderately | Very Inexpensive | Succulent | Very Far | 46 | |
| Unhealthy | | | | | |
| Moderately | Very Inexpensive | Succulent | None | 45 | |
| Unhealthy | | | | | |
| Moderately | Very Inexpensive | Delicious | Moderately | 44 | |
| Unhealthy | | | Close | | |
| Moderately | Very Inexpensive | Delicious | Very Close | 43 | |
| Unhealthy | | | | | |
| Moderately | Very Inexpensive | Delicious | Moderately | 42 | |
| Unhealthy | | | Far | | |
| Moderately | Very Inexpensive | Delicious | Very Far | 41 | |
| Unhealthy | | | | | |
| Moderately | Very Inexpensive | Delicious | None | 40 | |
| Unhealthy | | | | | |
| Moderately | Very Inexpensive | Savory | Moderately | 39 | |
| Unhealthy | | | Close | | |
| Moderately | Very Inexpensive | Savory | Very Close | 38 | |
| Unhealthy | | | | | |
| Moderately | Very Inexpensive | Savory | Moderately | 37 | |
| Unhealthy | | | Far | | |
| Moderately | Very Inexpensive | Savory | Very Far | 36 | |
| Unhealthy | | | | | |
| Moderately | Very Inexpensive | Savory | None | 35 | |
| Unhealthy | | | | | |
| Moderately | Very Inexpensive | Good-Tasting | Moderately | 34 | |
| Unhealthy | | | Close | | |
| Moderately | Very Inexpensive | Good-Tasting | Very Close | 33 | |
| Unhealthy | | | | | |
| Moderately | Very Inexpensive | Good-Tasting | Moderately | 32 | |
| Unhealthy | | | Far | | |
| Moderately | Very Inexpensive | Good-Tasting | Very Far | 31 | |
| Unhealthy | | | | | |
| Moderately | Very Inexpensive | Good-Tasting | None | 30 | |
| Unhealthy | | | | | |
| Moderately | Very Inexpensive | Acceptable | Moderately | 29 | |
| Unhealthy | | | Close | | |
| Moderately | Very Inexpensive | Acceptable | Very Close | 28 | |
| Unhealthy | | | | | |
| Moderately | Very Inexpensive | Acceptable | Moderately | 27 | |
| Unhealthy | | | Far | | |
| Moderately | Very Inexpensive | Acceptable | Very Far | 26 | |
| Unhealthy | | | | | |
| Moderately | Very Inexpensive | Acceptable | None | 25 | |
| Unhealthy | | | | | |
| Moderately | Free | Succulent | Moderately | 24 | |
| Unhealthy | | | Close | | |
| Moderately | Free | Succulent | Very Close | 23 | |
| Unhealthy | | | | | |
| Moderately | Free | Succulent | Moderately | 22 | |
| Unhealthy | | | Far | | |
| Moderately | Free | Succulent | Very Far | 21 | |
| Unhealthy | | | | | |
| Moderately | Free | Succulent | None | 20 | |
| Unhealthy | | | | | |
| Moderately | Free | Delicious | Moderately | 19 | |
| Unhealthy | | | Close | | |
| Moderately | Free | Delicious | Very Close | 18 | |
| Unhealthy | | | | | |
| Moderately | Free | Delicious | Moderately | 17 | |
| Unhealthy | | | Far | | |
| Moderately | Free | Delicious | Very Far | 16 | |
| Unhealthy | | | | | |
| Moderately | Free | Delicious | None | 15 | |
| Unhealthy | | | | | |
| Moderately | Free | Savory | Moderately | 14 | |
| Unhealthy | | | Close | | |
| Moderately | Free | Savory | Very Close | 13 | |
| Unhealthy | | | | | |
| Moderately | Free | Savory | Moderately | 12 | |
| Unhealthy | | | Far | | |
| Moderately | Free | Savory | Very Far | 11 | |
| Unhealthy | | | | | |
| Moderately | Free | Savory | None | 10 | |
| Unhealthy | | | | | |
| Moderately | Free | Good-Tasting | Moderately | 9 | |
| Unhealthy | | | Close | | |
| Moderately | Free | Good-Tasting | Very Close | 8 | |
| Unhealthy | | | | | |
| Moderately | Free | Good-Tasting | Moderately | 7 | |
| Unhealthy | | | Far | | |
| Moderately | Free | Good-Tasting | Very Far | 6 | |
| Unhealthy | | | | | |
| Moderately | Free | Good-Tasting | None | 5 | |
| Unhealthy | | | | | |
| Moderately | Free | Acceptable | Moderately | 4 | |
| Unhealthy | | | Close | | |
| Moderately | Free | Acceptable | Very Close | 3 | |
| Unhealthy | | | | | |
| Moderately | Free | Acceptable | Moderately | 2 | |
| Unhealthy | | | Far | | |
| Moderately | Free | Acceptable | Very Far | 1 | |
| Unhealthy | | | | | |
| Moderately | Free | Acceptable | None | 0 | Nothing (Status |
| Unhealthy | | | | | Quo) |
| Moderately | Moderately | Succulent | Moderately | −1 | |
| Unhealthy | Inexpensive | | Close | | |
| Moderately | Moderately | Succulent | Very Close | −2 | |
| Unhealthy | Inexpensive | | | | |
| Moderately | Moderately | Succulent | Moderately | −3 | |
| Unhealthy | Inexpensive | | Far | | |
| Moderately | Moderately | Succulent | Very Far | −4 | |
| Unhealthy | Inexpensive | | | | |
| Moderately | Moderately | Succulent | None | −5 | |
| Unhealthy | Inexpensive | | | | |
| Moderately | Moderately | Delicious | Moderately | −6 | |
| Unhealthy | Inexpensive | | Close | | |
| Moderately | Moderately | Delicious | Very Close | −7 | |
| Unhealthy | Inexpensive | | | | |
| Moderately | Moderately | Delicious | Moderately | −8 | |
| Unhealthy | Inexpensive | | Far | | |
| Moderately | Moderately | Delicious | Very Far | −9 | |
| Unhealthy | Inexpensive | | | | |
| Moderately | Moderately | Delicious | None | −10 | |
| Unhealthy | Inexpensive | | | | |
| Moderately | Moderately | Savory | Moderately | −11 | |
| Unhealthy | Inexpensive | | Close | | |
| Moderately | Moderately | Savory | Very Close | −12 | |
| Unhealthy | Inexpensive | | | | |
| Moderately | Moderately | Savory | Moderately | −13 | |
| Unhealthy | Inexpensive | | Far | | |
| Moderately | Moderately | Savory | Very Far | −14 | |
| Unhealthy | Inexpensive | | | | |
| Moderately | Moderately | Savory | None | −15 | |
| Unhealthy | Inexpensive | | | | |
| Moderately | Moderately | Good-Tasting | Moderately | −16 | |
| Unhealthy | Inexpensive | | Close | | |
| Moderately | Moderately | Good-Tasting | Very Close | −17 | |
| Unhealthy | Inexpensive | | | | |
| Moderately | Moderately | Good-Tasting | Moderately | −18 | |
| Unhealthy | Inexpensive | | Far | | |
| Moderately | Moderately | Good-Tasting | Very Far | −19 | |
| Unhealthy | Inexpensive | | | | |
| Moderately | Moderately | Good-Tasting | None | −20 | |
| Unhealthy | Inexpensive | | | | |
| Moderately | Moderately | Acceptable | Moderately | −21 | |
| Unhealthy | Inexpensive | | Close | | |
| Moderately | Moderately | Acceptable | Very Close | −22 | |
| Unhealthy | Inexpensive | | | | |
| Moderately | Moderately | Acceptable | Moderately | −23 | |
| Unhealthy | Inexpensive | | Far | | |
| Moderately | Moderately | Acceptable | Very Far | −24 | |
| Unhealthy | Inexpensive | | | | |
| Moderately | Moderately | Acceptable | None | −25 | |
| Unhealthy | Inexpensive | | | | |
| Moderately | Moderately | Succulent | Moderately | −26 | |
| Unhealthy | Expensive | | Close | | |
| Moderately | Moderately | Succulent | Very Close | −27 | |
| Unhealthy | Expensive | | | | |
| Moderately | Moderately | Succulent | Moderately | −28 | |
| Unhealthy | Expensive | | Far | | |
| Moderately | Moderately | Succulent | Very Far | −29 | |
| Unhealthy | Expensive | | | | |
| Moderately | Moderately | Succulent | None | −30 | |
| Unhealthy | Expensive | | | | |
| Moderately | Moderately | Delicious | Moderately | −31 | |
| Unhealthy | Expensive | | Close | | |
| Moderately | Moderately | Delicious | Very Close | −32 | |
| Unhealthy | Expensive | | | | |
| Moderately | Moderately | Delicious | Moderately | −33 | Chipotle |
| Unhealthy | Expensive | | Far | | |
| Moderately | Moderately | Delicious | Very Far | −34 | |
| Unhealthy | Expensive | | | | |
| Moderately | Moderately | Delicious | None | −35 | |
| Unhealthy | Expensive | | | | |
| Moderately | Moderately | Savory | Moderately | −36 | |
| Unhealthy | Expensive | | Close | | |
| Moderately | Moderately | Savory | Very Close | −37 | |
| Unhealthy | Expensive | | | | |
| Moderately | Moderately | Savory | Moderately | −38 | |
| Unhealthy | Expensive | | Far | | |
| Moderately | Moderately | Savory | Very Far | −39 | |
| Unhealthy | Expensive | | | | |
| Moderately | Moderately | Savory | None | −40 | |
| Unhealthy | Expensive | | | | |
| Moderately | Moderately | Good-Tasting | Moderately | −41 | |
| Unhealthy | Expensive | | Close | | |
| Moderately | Moderately | Good-Tasting | Very Close | −42 | |
| Unhealthy | Expensive | | | | |
| Moderately | Moderately | Good-Tasting | Moderately | −43 | |
| Unhealthy | Expensive | | Far | | |
| Moderately | Moderately | Good-Tasting | Very Far | −44 | |
| Unhealthy | Expensive | | | | |
| Moderately | Moderately | Good-Tasting | None | −45 | |
| Unhealthy | Expensive | | | | |
| Moderately | Moderately | Acceptable | Moderately | −46 | |
| Unhealthy | Expensive | | Close | | |
| Moderately | Moderately | Acceptable | Very Close | −47 | |
| Unhealthy | Expensive | | | | |
| Moderately | Moderately | Acceptable | Moderately | −48 | |
| Unhealthy | Expensive | | Far | | |
| Moderately | Moderately | Acceptable | Very Far | −49 | |
| Unhealthy | Expensive | | | | |
| Moderately | Moderately | Acceptable | None | −50 | |
| Unhealthy | Expensive | | | | |
| Moderately | Very Expensive | Succulent | Moderately | −51 | |
| Unhealthy | | | Close | | |
| Moderately | Very Expensive | Succulent | Very Close | −52 | |
| Unhealthy | | | | | |
| Moderately | Very Expensive | Succulent | Moderately | −53 | |
| Unhealthy | | | Far | | |
| Moderately | Very Expensive | Succulent | Very Far | −54 | |
| Unhealthy | | | | | |
| Moderately | Very Expensive | Succulent | None | −55 | |
| Unhealthy | | | | | |
| Moderately | Very Expensive | Delicious | Moderately | −56 | |
| Unhealthy | | | Close | | |
| Moderately | Very Expensive | Delicious | Very Close | −57 | |
| Unhealthy | | | | | |
| Moderately | Very Expensive | Delicious | Moderately | −58 | |
| Unhealthy | | | Far | | |
| Moderately | Very Expensive | Delicious | Very Far | −59 | |
| Unhealthy | | | | | |
| Moderately | Very Expensive | Delicious | None | −60 | |
| Unhealthy | | | | | |
| Moderately | Very Expensive | Savory | Moderately | −61 | |
| Unhealthy | | | Close | | |
| Moderately | Very Expensive | Savory | Very Close | −62 | |
| Unhealthy | | | | | |
| Moderately | Very Expensive | Savory | Moderately | −63 | |
| Unhealthy | | | Far | | |
| Moderately | Very Expensive | Savory | Very Far | −64 | |
| Unhealthy | | | | | |
| Moderately | Very Expensive | Savory | None | −65 | |
| Unhealthy | | | | | |
| Moderately | Very Expensive | Good-Tasting | Moderately | −66 | |
| Unhealthy | | | Close | | |
| Moderately | Very Expensive | Good-Tasting | Very Close | −67 | |
| Unhealthy | | | | | |
| Moderately | Very Expensive | Good-Tasting | Moderately | −68 | |
| Unhealthy | | | Far | | |
| Moderately | Very Expensive | Good-Tasting | Very Far | −69 | |
| Unhealthy | | | | | |
| Moderately | Very Expensive | Good-Tasting | None | −70 | |
| Unhealthy | | | | | |
| Moderately | Very Expensive | Acceptable | Moderately | −71 | |
| Unhealthy | | | Close | | |
| Moderately | Very Expensive | Acceptable | Very Close | −72 | |
| Unhealthy | | | | | |
| Moderately | Very Expensive | Acceptable | Moderately | −73 | |
| Unhealthy | | | Far | | |
| Moderately | Very Expensive | Acceptable | Very Far | −74 | |
| Unhealthy | | | | | |
| Moderately | Very Expensive | Acceptable | None | −75 | |
| Unhealthy | | | | | |
| Neutral | Very Inexpensive | Succulent | Moderately | −76 | |
| | | | Close | | |
| Neutral | Very Inexpensive | Succulent | Very Close | −77 | |
| Neutral | Very Inexpensive | Succulent | Moderately | −78 | |
| | | | Far | | |
| Neutral | Very Inexpensive | Succulent | Very Far | −79 | |
| Neutral | Very Inexpensive | Succulent | None | −80 | |
| Neutral | Very Inexpensive | Delicious | Moderately | −81 | |
| | | | Close | | |
| Neutral | Very Inexpensive | Delicious | Very Close | −82 | |
| Neutral | Very Inexpensive | Delicious | Moderately | −83 | |
| | | | Far | | |
| Neutral | Very Inexpensive | Delicious | Very Far | −84 | |
| Neutral | Very Inexpensive | Delicious | None | −85 | |
| Neutral | Very Inexpensive | Savory | Moderately | −86 | |
| | | | Close | | |
| Neutral | Very Inexpensive | Savory | Very Close | −87 | |
| Neutral | Very Inexpensive | Savory | Moderately | −88 | |
| | | | Far | | |
| Neutral | Very Inexpensive | Savory | Very Far | −89 | |
| Neutral | Very Inexpensive | Savory | None | −90 | |
| Neutral | Very Inexpensive | Good-Tasting | Moderately | −91 | |
| | | | Close | | |
| Neutral | Very Inexpensive | Good-Tasting | Very Close | −92 | |
| Neutral | Very Inexpensive | Good-Tasting | Moderately | −93 | |
| | | | Far | | |
| Neutral | Very Inexpensive | Good-Tasting | Very Far | −94 | |
| Neutral | Very Inexpensive | Good-Tasting | None | −95 | |
| Neutral | Very Inexpensive | Acceptable | Moderately | −96 | |
| | | | Close | | |
| Neutral | Very Inexpensive | Acceptable | Very Close | −97 | |
| Neutral | Very Inexpensive | Acceptable | Moderately | −98 | |
| | | | Far | | |
| Neutral | Very Inexpensive | Acceptable | Very Far | −99 | |
| Neutral | Very Inexpensive | Acceptable | None | −100 | |
| Neutral | Free | Succulent | Moderately | −101 | |
| | | | Close | | |
| Neutral | Free | Succulent | Very Close | −102 | |
| Neutral | Free | Succulent | Moderately | −103 | |
| | | | Far | | |
| Neutral | Free | Succulent | Very Far | −104 | |
| Neutral | Free | Succulent | None | −105 | |
| Neutral | Free | Delicious | Moderately | −106 | |
| | | | Close | | |
| Neutral | Free | Delicious | Very Close | −107 | |
| Neutral | Free | Delicious | Moderately | −108 | |
| | | | Far | | |
| Neutral | Free | Delicious | Very Far | −109 | |
| Neutral | Free | Delicious | None | −110 | |
| Neutral | Free | Savory | Moderately | −111 | |
| | | | Close | | |
| Neutral | Free | Savory | Very Close | −112 | |
| Neutral | Free | Savory | Moderately | −113 | |
| | | | Far | | |
| Neutral | Free | Savory | Very Far | −114 | |
| Neutral | Free | Savory | None | −115 | |
| Neutral | Free | Good-Tasting | Moderately | −116 | |
| | | | Close | | |
| Neutral | Free | Good-Tasting | Very Close | −117 | |
| Neutral | Free | Good-Tasting | Moderately | −118 | |
| | | | Far | | |
| Neutral | Free | Good-Tasting | Very Far | −119 | |
| Neutral | Free | Good-Tasting | None | −120 | |
| Neutral | Free | Acceptable | Moderately | −121 | |
| | | | Close | | |
| Neutral | Free | Acceptable | Very Close | −122 | |
| Neutral | Free | Acceptable | Moderately | −123 | |
| | | | Far | | |
| Neutral | Free | Acceptable | Very Far | −124 | |
| Neutral | Free | Acceptable | None | −125 | |
| Neutral | Moderately | Succulent | Moderately | −126 | |
| | Inexpensive | | Close | | |
| Neutral | Moderately | Succulent | Very Close | −127 | |
| | Inexpensive | | | | |
| Neutral | Moderately | Succulent | Moderately | −128 | |
| | Inexpensive | | Far | | |
| Neutral | Moderately | Succulent | Very Far | −129 | |
| | Inexpensive | | | | |
| Neutral | Moderately | Succulent | None | −130 | |
| | Inexpensive | | | | |
| Neutral | Moderately | Delicious | Moderately | −131 | |
| | Inexpensive | | Close | | |
| Neutral | Moderately | Delicious | Very Close | −132 | |
| | Inexpensive | | | | |
| Neutral | Moderately | Delicious | Moderately | −133 | |
| | Inexpensive | | Far | | |
| Neutral | Moderately | Delicious | Very Far | −134 | |
| | Inexpensive | | | | |
| Neutral | Moderately | Delicious | None | −135 | |
| | Inexpensive | | | | |
| Neutral | Moderately | Savory | Moderately | −136 | |
| | Inexpensive | | Close | | |
| Neutral | Moderately | Savory | Very Close | −137 | |
| | Inexpensive | | | | |
| Neutral | Moderately | Savory | Moderately | −138 | |
| | Inexpensive | | Far | | |
| Neutral | Moderately | Savory | Very Far | −139 | |
| | Inexpensive | | | | |
| Neutral | Moderately | Savory | None | −140 | |
| | Inexpensive | | | | |
| Neutral | Moderately | Good-Tasting | Moderately | −141 | |
| | Inexpensive | | Close | | |
| Neutral | Moderately | Good-Tasting | Very Close | −142 | |
| | Inexpensive | | | | |
| Neutral | Moderately | Good-Tasting | Moderately | −143 | |
| | Inexpensive | | Far | | |
| Neutral | Moderately | Good-Tasting | Very Far | −144 | |
| | Inexpensive | | | | |
| Neutral | Moderately | Good-Tasting | None | −145 | |
| | Inexpensive | | | | |
| Neutral | Moderately | Acceptable | Moderately | −146 | |
| | Inexpensive | | Close | | |
| Neutral | Moderately | Acceptable | Very Close | −147 | |
| | Inexpensive | | | | |
| Neutral | Moderately | Acceptable | Moderately | −148 | |
| | Inexpensive | | Far | | |
| Neutral | Moderately | Acceptable | Very Far | −149 | |
| | Inexpensive | | | | |
| Neutral | Moderately | Acceptable | None | −150 | |
| | Inexpensive | | | | |
| Neutral | Moderately | Succulent | Moderately | −151 | |
| | Expensive | | Close | | |
| Neutral | Moderately | Succulent | Very Close | −152 | |
| | Expensive | | | | |
| Neutral | Moderately | Succulent | Moderately | −153 | |
| | Expensive | | Far | | |
| Neutral | Moderately | Succulent | Very Far | −154 | |
| | Expensive | | | | |
| Neutral | Moderately | Succulent | None | −155 | |
| | Expensive | | | | |
| Neutral | Moderately | Delicious | Moderately | −156 | |
| | Expensive | | Close | | |
| Neutral | Moderately | Delicious | Very Close | −157 | |
| | Expensive | | | | |
| Neutral | Moderately | Delicious | Moderately | −158 | |
| | Expensive | | Far | | |
| Neutral | Moderately | Delicious | Very Far | −159 | |
| | Expensive | | | | |
| Neutral | Moderately | Delicious | None | −160 | |
| | Expensive | | | | |
| Neutral | Moderately | Savory | Moderately | −161 | |
| | Expensive | | Close | | |
| Neutral | Moderately | Savory | Very Close | −162 | |
| | Expensive | | | | |
| Neutral | Moderately | Savory | Moderately | −163 | |
| | Expensive | | Far | | |
| Neutral | Moderately | Savory | Very Far | −164 | |
| | Expensive | | | | |
| Neutral | Moderately | Savory | None | −165 | |
| | Expensive | | | | |
| Neutral | Moderately | Good-Tasting | Moderately | −166 | |
| | Expensive | | Close | | |
| Neutral | Moderately | Good-Tasting | Very Close | −167 | |
| | Expensive | | | | |
| Neutral | Moderately | Good-Tasting | Moderately | −168 | |
| | Expensive | | Far | | |
| Neutral | Moderately | Good-Tasting | Very Far | −169 | |
| | Expensive | | | | |
| Neutral | Moderately | Good-Tasting | None | −170 | |
| | Expensive | | | | |
| Neutral | Moderately | Acceptable | Moderately | −171 | |
| | Expensive | | Close | | |
| Neutral | Moderately | Acceptable | Very Close | −172 | |
| | Expensive | | | | |
| Neutral | Moderately | Acceptable | Moderately | −173 | |
| | Expensive | | Far | | |
| Neutral | Moderately | Acceptable | Very Far | −174 | |
| | Expensive | | | | |
| Neutral | Moderately | Acceptable | None | −175 | |
| | Expensive | | | | |
| Neutral | Very Expensive | Succulent | Moderately | −176 | |
| | | | Close | | |
| Neutral | Very Expensive | Succulent | Very Close | −177 | |
| Neutral | Very Expensive | Succulent | Moderately | −178 | |
| | | | Far | | |
| Neutral | Very Expensive | Succulent | Very Far | −179 | |
| Neutral | Very Expensive | Succulent | None | −180 | |
| Neutral | Very Expensive | Delicious | Moderately | −181 | |
| | | | Close | | |
| Neutral | Very Expensive | Delicious | Very Close | −182 | |
| Neutral | Very Expensive | Delicious | Moderately | −183 | |
| | | | Far | | |
| Neutral | Very Expensive | Delicious | Very Far | −184 | |
| Neutral | Very Expensive | Delicious | None | −185 | |
| Neutral | Very Expensive | Savory | Moderately | −186 | |
| | | | Close | | |
| Neutral | Very Expensive | Savory | Very Close | −187 | |
| Neutral | Very Expensive | Savory | Moderately | −188 | |
| | | | Far | | |
| Neutral | Very Expensive | Savory | Very Far | −189 | |
| Neutral | Very Expensive | Savory | None | −190 | |
| Neutral | Very Expensive | Good-Tasting | Moderately | −191 | |
| | | | Close | | |
| Neutral | Very Expensive | Good-Tasting | Very Close | −192 | |
| Neutral | Very Expensive | Good-Tasting | Moderately | −193 | |
| | | | Far | | |
| Neutral | Very Expensive | Good-Tasting | Very Far | −194 | |
| Neutral | Very Expensive | Good-Tasting | None | −195 | |
| Neutral | Very Expensive | Acceptable | Moderately | −196 | |
| | | | Close | | |
| Neutral | Very Expensive | Acceptable | Very Close | −197 | |
| Neutral | Very Expensive | Acceptable | Moderately | −198 | |
| | | | Far | | |
| Neutral | Very Expensive | Acceptable | Very Far | −199 | |
| Neutral | Very Expensive | Acceptable | None | −200 | |
| Very | Very Inexpensive | Succulent | Moderately | −201 | |
| Unhealthy | | | Close | | |
| Very | Very Inexpensive | Succulent | Very Close | −202 | |
| Unhealthy | | | | | |
| Very | Very Inexpensive | Succulent | Moderately | −203 | |
| Unhealthy | | | Far | | |
| Very | Very Inexpensive | Succulent | Very Far | −204 | |
| Unhealthy | | | | | |
| Very | Very Inexpensive | Succulent | None | −205 | |
| Unhealthy | | | | | |
| Very | Very Inexpensive | Delicious | Moderately | −206 | |
| Unhealthy | | | Close | | |
| Very | Very Inexpensive | Delicious | Very Close | −207 | |
| Unhealthy | | | | | |
| Very | Very Inexpensive | Delicious | Moderately | −208 | |
| Unhealthy | | | Far | | |
| Very | Very Inexpensive | Delicious | Very Far | −209 | |
| Unhealthy | | | | | |
| Very | Very Inexpensive | Delicious | None | −210 | |
| Unhealthy | | | | | |
| Very | Very Inexpensive | Savory | Moderately | −211 | McDonalds |
| Unhealthy | | | Close | | |
| Very | Very Inexpensive | Savory | Very Close | −212 | |
| Unhealthy | | | | | |
| Very | Very Inexpensive | Savory | Moderately | −213 | |
| Unhealthy | | | Far | | |
| Very | Very Inexpensive | Savory | Very Far | −214 | |
| Unhealthy | | | | | |
| Very | Very Inexpensive | Savory | None | −215 | |
| Unhealthy | | | | | |
| Very | Very Inexpensive | Good-Tasting | Moderately | −216 | |
| Unhealthy | | | Close | | |
| Very | Very Inexpensive | Good-Tasting | Very Close | −217 | |
| Unhealthy | | | | | |
| Very | Very Inexpensive | Good-Tasting | Moderately | −218 | |
| Unhealthy | | | Far | | |
| Very | Very Inexpensive | Good-Tasting | Very Far | −219 | |
| Unhealthy | | | | | |
| Very | Very Inexpensive | Good-Tasting | None | −220 | |
| Unhealthy | | | | | |
| Very | Very Inexpensive | Acceptable | Moderately | −221 | |
| Unhealthy | | | Close | | |
| Very | Very Inexpensive | Acceptable | Very Close | −222 | |
| Unhealthy | | | | | |
| Very | Very Inexpensive | Acceptable | Moderately | −223 | |
| Unhealthy | | | Far | | |
| Very | Very Inexpensive | Acceptable | Very Far | −224 | |
| Unhealthy | | | | | |
| Very | Very Inexpensive | Acceptable | None | −225 | |
| Unhealthy | | | | | |
| Very | Free | Succulent | Moderately | −226 | |
| Unhealthy | | | Close | | |
| Very | Free | Succulent | Very Close | −227 | |
| Unhealthy | | | | | |
| Very | Free | Succulent | Moderately | −228 | |
| Unhealthy | | | Far | | |
| Very | Free | Succulent | Very Far | −229 | |
| Unhealthy | | | | | |
| Very | Free | Succulent | None | −230 | |
| Unhealthy | | | | | |
| Very | Free | Delicious | Moderately | −231 | |
| Unhealthy | | | Close | | |
| Very | Free | Delicious | Very Close | −232 | |
| Unhealthy | | | | | |
| Very | Free | Delicious | Moderately | −233 | |
| Unhealthy | | | Far | | |
| Very | Free | Delicious | Very Far | −234 | |
| Unhealthy | | | | | |
| Very | Free | Delicious | None | −235 | |
| Unhealthy | | | | | |
| Very | Free | Savory | Moderately | −236 | |
| Unhealthy | | | Close | | |
| Very | Free | Savory | Very Close | −237 | |
| Unhealthy | | | | | |
| Very | Free | Savory | Moderately | −238 | |
| Unhealthy | | | Far | | |
| Very | Free | Savory | Very Far | −239 | |
| Unhealthy | | | | | |
| Very | Free | Savory | None | −240 | |
| Unhealthy | | | | | |
| Very | Free | Good-Tasting | Moderately | −241 | |
| Unhealthy | | | Close | | |
| Very | Free | Good-Tasting | Very Close | −242 | |
| Unhealthy | | | | | |
| Very | Free | Good-Tasting | Moderately | −243 | |
| Unhealthy | | | Far | | |
| Very | Free | Good-Tasting | Very Far | −244 | |
| Unhealthy | | | | | |
| Very | Free | Good-Tasting | None | −245 | |
| Unhealthy | | | | | |
| Very | Free | Acceptable | Moderately | −246 | |
| Unhealthy | | | Close | | |
| Very | Free | Acceptable | Very Close | −247 | |
| Unhealthy | | | | | |
| Very | Free | Acceptable | Moderately | −248 | |
| Unhealthy | | | Far | | |
| Very | Free | Acceptable | Very Far | −249 | |
| Unhealthy | | | | | |
| Very | Free | Acceptable | None | −250 | |
| Unhealthy | | | | | |
| Very | Moderately | Succulent | Moderately | −251 | |
| Unhealthy | Inexpensive | | Close | | |
| Very | Moderately | Succulent | Very Close | −252 | |
| Unhealthy | Inexpensive | | | | |
| Very | Moderately | Succulent | Moderately | −253 | |
| Unhealthy | Inexpensive | | Far | | |
| Very | Moderately | Succulent | Very Far | −254 | |
| Unhealthy | Inexpensive | | | | |
| Very | Moderately | Succulent | None | −255 | |
| Unhealthy | Inexpensive | | | | |
| Very | Moderately | Delicious | Moderately | −256 | |
| Unhealthy | Inexpensive | | Close | | |
| Very | Moderately | Delicious | Very Close | −257 | |
| Unhealthy | Inexpensive | | | | |
| Very | Moderately | Delicious | Moderately | −258 | |
| Unhealthy | Inexpensive | | Far | | |
| Very | Moderately | Delicious | Very Far | −259 | |
| Unhealthy | Inexpensive | | | | |
| Very | Moderately | Delicious | None | −260 | |
| Unhealthy | Inexpensive | | | | |
| Very | Moderately | Savory | Moderately | −261 | |
| Unhealthy | Inexpensive | | Close | | |
| Very | Moderately | Savory | Very Close | −262 | |
| Unhealthy | Inexpensive | | | | |
| Very | Moderately | Savory | Moderately | −263 | |
| Unhealthy | Inexpensive | | Far | | |
| Very | Moderately | Savory | Very Far | −264 | |
| Unhealthy | Inexpensive | | | | |
| Very | Moderately | Savory | None | −265 | |
| Unhealthy | Inexpensive | | | | |
| Very | Moderately | Good-Tasting | Moderately | −266 | |
| Unhealthy | Inexpensive | | Close | | |
| Very | Moderately | Good-Tasting | Very Close | −267 | |
| Unhealthy | Inexpensive | | | | |
| Very | Moderately | Good-Tasting | Moderately | −268 | |
| Unhealthy | Inexpensive | | Far | | |
| Very | Moderately | Good-Tasting | Very Far | −269 | |
| Unhealthy | Inexpensive | | | | |
| Very | Moderately | Good-Tasting | None | −270 | |
| Unhealthy | Inexpensive | | | | |
| Very | Moderately | Acceptable | Moderately | −271 | |
| Unhealthy | Inexpensive | | Close | | |
| Very | Moderately | Acceptable | Very Close | −272 | |
| Unhealthy | Inexpensive | | | | |
| Very | Moderately | Acceptable | Moderately | −273 | |
| Unhealthy | Inexpensive | | Far | | |
| Very | Moderately | Acceptable | Very Far | −274 | |
| Unhealthy | Inexpensive | | | | |
| Very | Moderately | Acceptable | None | −275 | |
| Unhealthy | Inexpensive | | | | |
| Very | Moderately | Succulent | Moderately | −276 | |
| Unhealthy | Expensive | | Close | | |
| Very | Moderately | Succulent | Very Close | −277 | |
| Unhealthy | Expensive | | | | |
| Very | Moderately | Succulent | Moderately | −278 | |
| Unhealthy | Expensive | | Far | | |
| Very | Moderately | Succulent | Very Far | −279 | |
| Unhealthy | Expensive | | | | |
| Very | Moderately | Succulent | None | −280 | |
| Unhealthy | Expensive | | | | |
| Very | Moderately | Delicious | Moderately | −281 | |
| Unhealthy | Expensive | | Close | | |
| Very | Moderately | Delicious | Very Close | −282 | |
| Unhealthy | Expensive | | | | |
| Very | Moderately | Delicious | Moderately | −283 | |
| Unhealthy | Expensive | | Far | | |
| Very | Moderately | Delicious | Very Far | −284 | |
| Unhealthy | Expensive | | | | |
| Very | Moderately | Delicious | None | −285 | |
| Unhealthy | Expensive | | | | |
| Very | Moderately | Savory | Moderately | −286 | |
| Unhealthy | Expensive | | Close | | |
| Very | Moderately | Savory | Very Close | −287 | |
| Unhealthy | Expensive | | | | |
| Very | Moderately | Savory | Moderately | −288 | |
| Unhealthy | Expensive | | Far | | |
| Very | Moderately | Savory | Very Far | −289 | |
| Unhealthy | Expensive | | | | |
| Very | Moderately | Savory | None | −290 | |
| Unhealthy | Expensive | | | | |
| Very | Moderately | Good-Tasting | Moderately | −291 | |
| Unhealthy | Expensive | | Close | | |
| Very | Moderately | Good-Tasting | Very Close | −292 | |
| Unhealthy | Expensive | | | | |
| Very | Moderately | Good-Tasting | Moderately | −293 | |
| Unhealthy | Expensive | | Far | | |
| Very | Moderately | Good-Tasting | Very Far | −294 | |
| Unhealthy | Expensive | | | | |
| Very | Moderately | Good-Tasting | None | −295 | |
| Unhealthy | Expensive | | | | |
| Very | Moderately | Acceptable | Moderately | −296 | |
| Unhealthy | Expensive | | Close | | |
| Very | Moderately | Acceptable | Very Close | −297 | |
| Unhealthy | Expensive | | | | |
| Very | Moderately | Acceptable | Moderately | −298 | |
| Unhealthy | Expensive | | Far | | |
| Very | Moderately | Acceptable | Very Far | −299 | |
| Unhealthy | Expensive | | | | |
| Very | Moderately | Acceptable | None | −300 | |
| Unhealthy | Expensive | | | | |
| Very | Very Expensive | Succulent | Moderately | −301 | |
| Unhealthy | | | Close | | |
| Very | Very Expensive | Succulent | Very Close | −302 | |
| Unhealthy | | | | | |
| Very | Very Expensive | Succulent | Moderately | −303 | |
| Unhealthy | | | Far | | |
| Very | Very Expensive | Succulent | Very Far | −304 | |
| Unhealthy | | | | | |
| Very | Very Expensive | Succulent | None | −305 | |
| Unhealthy | | | | | |
| Very | Very Expensive | Delicious | Moderately | −306 | |
| Unhealthy | | | Close | | |
| Very | Very Expensive | Delicious | Very Close | −307 | |
| Unhealthy | | | | | |
| Very | Very Expensive | Delicious | Moderately | −308 | |
| Unhealthy | | | Far | | |
| Very | Very Expensive | Delicious | Very Far | −309 | |
| Unhealthy | | | | | |
| Very | Very Expensive | Delicious | None | −310 | |
| Unhealthy | | | | | |
| Very | Very Expensive | Savory | Moderately | −311 | |
| Unhealthy | | | Close | | |
| Very | Very Expensive | Savory | Very Close | −312 | |
| Unhealthy | | | | | |
| Very | Very Expensive | Savory | Moderately | −313 | |
| Unhealthy | | | Far | | |
| Very | Very Expensive | Savory | Very Far | −314 | |
| Unhealthy | | | | | |
| Very | Very Expensive | Savory | None | −315 | |
| Unhealthy | | | | | |
| Very | Very Expensive | Good-Tasting | Moderately | −316 | |
| Unhealthy | | | Close | | |
| Very | Very Expensive | Good-Tasting | Very Close | −317 | |
| Unhealthy | | | | | |
| Very | Very Expensive | Good-Tasting | Moderately | −318 | |
| Unhealthy | | | Far | | |
| Very | Very Expensive | Good-Tasting | Very Far | −319 | |
| Unhealthy | | | | | |
| Very | Very Expensive | Good-Tasting | None | −320 | |
| Unhealthy | | | | | |
| Very | Very Expensive | Acceptable | Moderately | −321 | |
| Unhealthy | | | Close | | |
| Very | Very Expensive | Acceptable | Very Close | −322 | |
| Unhealthy | | | | | |
| Very | Very Expensive | Acceptable | Moderately | −323 | |
| Unhealthy | | | Far | | |
| Very | Very Expensive | Acceptable | Very Far | −324 | |
| Unhealthy | | | | | |
| Very | Very Expensive | Acceptable | None | −325 | |
| Unhealthy | | | | | |

After utility payoff scores are assigned to each and every option combination (i.e., each and every row) in the reverse induction combination table, thereby creating a utility payoff schedule for the selected stakeholder, the utility payoff schedule is searched to identify therein the three rows that have the same option combinations as the three other possible outcome scenarios (SUBWAY, McDONALDS and CHIPOLTLE) in the scenario pathway table of Table 5 above. When the three rows with the matching combinations of options are found, the numbers in the utility payoff column for those three rows are recorded as the utility payoff scores for those three possible outcome scenarios, respectively. As shown in Table 17 above, the three rows in Jane's utility payoff schedule that exactly match the scenario pathway table combinations for the SUBWAY, McDONALDS and CHIPOTLE outcome scenarios, respectively, are the rows that have utility payoff scores of 231 for SUBWAY, −33 for CHIPOTLE and −211 for McDONALDS. Consequently, Jane's utility payoff scores for each one of the possible outcome scenarios are extracted from Jane's utility payoff schedule and recorded as shown in Table 18 below:

TABLE 18
JANE'S UTILITY PAYOFF SCORES BY SCENARIO

| Outcome Scenario | Utility Payoff Score |
|---|---|
| SUBWAY | 231 |
| NOTHING | 0 |
| CHIPOTLE | −33 |
| McDONALDS | −211 |

At step S430, the selected stakeholder's “reality-based position” in respect to the range of possible outcome scenarios is determined. The selected stakeholder's reality-based position is the outcome scenario with the most positive (least negative) utility payoff score in the stakeholder's utility payoff schedule. Thus, according to Jane's utility payoff schedule, it can be seen that Jane's reality-based position is not the same as his stated position, as indicated in Table 7 above. According to Table 7 above, Jane's stated position is to go to Chipotle for lunch. However, his reality-based position, which is more reliably calculated, in accordance with the present invention, using Jane's priority rankings for the factors and the factor options associated with the range of possible outcome scenarios, is to go to Subway for lunch.

Finally, as indicated by steps S435 and S440 in FIG. 4, the system (or method) of the present invention repeats all of the above-described steps for Stage III of operation for the next stakeholder in the set of stakeholders. In this case, the system would generate a reverse induction combination table for Carl comprising all of the possible combinations of factors and options based on Carl's rankings of factors and options, and then convert Carl's reverse induction combination table into a utility payoff schedule for Carl by assigning a utility score of “0” to the row containing the status quo combination of options and running an ordinal array up and down the reverse induction combination table. Carl's utility payoff schedule, shown in Table 19 below, will also contain 625 rows of option combinations. However, because Carl's priority rankings for factors and priority rankings for options are different from Jane's priority rankings for factors and options, the rows corresponding to each outcome scenario in the range of possible outcome scenarios are located in different places in the schedule, and therefore are assigned different utility payoff scores when compared to the utility payoff scores assigned to those scenarios for Jane. Based on Carl's factor and option rankings, Carl's utility payoff schedule would look as shown below in Table 19.

TABLE 19
CARL'S UTILITY PAYOFF SCHEDULE
Carl's Utility Payoff Schedule

| | | | | Utility | |
|---|---|---|---|---|---|
| | | | | Payoff | Each Defined |
| Taste | Distance | Health | Cost | Score | Scenario |
| Savory | Moderately | Neutral | Moderately | 494 | |
| | Far | | Expensive | | |
| Savory | Moderately | Neutral | Very Expensive | 493 | |
| | Far | | | | |
| Savory | Moderately | Neutral | Moderately | 492 | |
| | Far | | Inexpensive | | |
| Savory | Moderately | Neutral | Very Inexpensive | 491 | |
| | Far | | | | |
| Savory | Moderately | Neutral | Free | 490 | |
| | Far | | | | |
| Savory | Moderately | Moderately Healthy | Moderately | 489 | |
| | Far | | Expensive | | |
| Savory | Moderately | Moderately Healthy | Very Expensive | 488 | |
| | Far | | | | |
| Savory | Moderately | Moderately Healthy | Moderately | 487 | |
| | Far | | Inexpensive | | |
| Savory | Moderately | Moderately Healthy | Very Inexpensive | 486 | |
| | Far | | | | |
| Savory | Moderately | Moderately Healthy | Free | 485 | |
| | Far | | | | |
| Savory | Moderately | Very Healthy | Moderately | 484 | |
| | Far | | Expensive | | |
| Savory | Moderately | Very Healthy | Very Expensive | 483 | |
| | Far | | | | |
| Savory | Moderately | Very Healthy | Moderately | 482 | |
| | Far | | Inexpensive | | |
| Savory | Moderately | Very Healthy | Very Inexpensive | 481 | |
| | Far | | | | |
| Savory | Moderately | Very Healthy | Free | 480 | |
| | Far | | | | |
| Savory | Moderately | Moderately | Moderately | 479 | |
| | Far | Unhealthy | Expensive | | |
| Savory | Moderately | Moderately | Very Expensive | 478 | |
| | Far | Unhealthy | | | |
| Savory | Moderately | Moderately | Moderately | 477 | |
| | Far | Unhealthy | Inexpensive | | |
| Savory | Moderately | Moderately | Very Inexpensive | 476 | |
| | Far | Unhealthy | | | |
| Savory | Moderately | Moderately | Free | 475 | |
| | Far | Unhealthy | | | |
| Savory | Moderately | Very Unhealthy | Moderately | 474 | |
| | Far | | Expensive | | |
| Savory | Moderately | Very Unhealthy | Very Expensive | 473 | |
| | Far | | | | |
| Savory | Moderately | Very Unhealthy | Moderately | 472 | |
| | Far | | Inexpensive | | |
| Savory | Moderately | Very Unhealthy | Very Inexpensive | 471 | |
| | Far | | | | |
| Savory | Moderately | Very Unhealthy | Free | 470 | |
| | Far | | | | |
| Savory | Very Far | Neutral | Moderately | 469 | |
| | | | Expensive | | |
| Savory | Very Far | Neutral | Very Expensive | 468 | |
| Savory | Very Far | Neutral | Moderately | 467 | |
| | | | Inexpensive | | |
| Savory | Very Far | Neutral | Very Inexpensive | 466 | |
| Savory | Very Far | Neutral | Free | 465 | |
| Savory | Very Far | Moderately Healthy | Moderately | 464 | |
| | | | Expensive | | |
| Savory | Very Far | Moderately Healthy | Very Expensive | 463 | |
| Savory | Very Far | Moderately Healthy | Moderately | 462 | |
| | | | Inexpensive | | |
| Savory | Very Far | Moderately Healthy | Very Inexpensive | 461 | |
| Savory | Very Far | Moderately Healthy | Free | 460 | |
| Savory | Very Far | Very Healthy | Moderately | 459 | |
| | | | Expensive | | |
| Savory | Very Far | Very Healthy | Very Expensive | 458 | |
| Savory | Very Far | Very Healthy | Moderately | 457 | |
| | | | Inexpensive | | |
| Savory | Very Far | Very Healthy | Very Inexpensive | 456 | |
| Savory | Very Far | Very Healthy | Free | 455 | |
| Savory | Very Far | Moderately | Moderately | 454 | |
| | | Unhealthy | Expensive | | |
| Savory | Very Far | Moderately | Very Expensive | 453 | |
| | | Unhealthy | | | |
| Savory | Very Far | Moderately | Moderately | 452 | |
| | | Unhealthy | Inexpensive | | |
| Savory | Very Far | Moderately | Very Inexpensive | 451 | |
| | | Unhealthy | | | |
| Savory | Very Far | Moderately | Free | 450 | |
| | | Unhealthy | | | |
| Savory | Very Far | Very Unhealthy | Moderately | 449 | |
| | | | Expensive | | |
| Savory | Very Far | Very Unhealthy | Very Expensive | 448 | |
| Savory | Very Far | Very Unhealthy | Moderately | 447 | |
| | | | Inexpensive | | |
| Savory | Very Far | Very Unhealthy | Very Inexpensive | 446 | |
| Savory | Very Far | Very Unhealthy | Free | 445 | |
| Savory | Moderately | Neutral | Moderately | 444 | |
| | Close | | Expensive | | |
| Savory | Moderately | Neutral | Very Expensive | 443 | |
| | Close | | | | |
| Savory | Moderately | Neutral | Moderately | 442 | |
| | Close | | Inexpensive | | |
| Savory | Moderately | Neutral | Very Inexpensive | 441 | |
| | Close | | | | |
| Savory | Moderately | Neutral | Free | 440 | |
| | Close | | | | |
| Savory | Moderately | Moderately Healthy | Moderately | 439 | |
| | Close | | Expensive | | |
| Savory | Moderately | Moderately Healthy | Very Expensive | 438 | |
| | Close | | | | |
| Savory | Moderately | Moderately Healthy | Moderately | 437 | |
| | Close | | Inexpensive | | |
| Savory | Moderately | Moderately Healthy | Very Inexpensive | 436 | |
| | Close | | | | |
| Savory | Moderately | Moderately Healthy | Free | 435 | |
| | Close | | | | |
| Savory | Moderately | Very Healthy | Moderately | 434 | |
| | Close | | Expensive | | |
| Savory | Moderately | Very Healthy | Very Expensive | 433 | |
| | Close | | | | |
| Savory | Moderately | Very Healthy | Moderately | 432 | |
| | Close | | Inexpensive | | |
| Savory | Moderately | Very Healthy | Very Inexpensive | 431 | |
| | Close | | | | |
| Savory | Moderately | Very Healthy | Free | 430 | |
| | Close | | | | |
| Savory | Moderately | Moderately | Moderately | 429 | |
| | Close | Unhealthy | Expensive | | |
| Savory | Moderately | Moderately | Very Expensive | 428 | |
| | Close | Unhealthy | | | |
| Savory | Moderately | Moderately | Moderately | 427 | |
| | Close | Unhealthy | Inexpensive | | |
| Savory | Moderately | Moderately | Very Inexpensive | 426 | |
| | Close | Unhealthy | | | |
| Savory | Moderately | Moderately | Free | 425 | |
| | Close | Unhealthy | | | |
| Savory | Moderately | Very Unhealthy | Moderately | 424 | |
| | Close | | Expensive | | |
| Savory | Moderately | Very Unhealthy | Very Expensive | 423 | |
| | Close | | | | |
| Savory | Moderately | Very Unhealthy | Moderately | 422 | |
| | Close | | Inexpensive | | |
| Savory | Moderately | Very Unhealthy | Very Inexpensive | 421 | McDonalds |
| | Close | | | | |
| Savory | Moderately | Very Unhealthy | Free | 420 | |
| | Close | | | | |
| Savory | Very Close | Neutral | Moderately | 419 | |
| | | | Expensive | | |
| Savory | Very Close | Neutral | Very Expensive | 418 | |
| Savory | Very Close | Neutral | Moderately | 417 | |
| | | | Inexpensive | | |
| Savory | Very Close | Neutral | Very Inexpensive | 416 | |
| Savory | Very Close | Neutral | Free | 415 | |
| Savory | Very Close | Moderately Healthy | Moderately | 414 | |
| | | | Expensive | | |
| Savory | Very Close | Moderately Healthy | Very Expensive | 413 | |
| Savory | Very Close | Moderately Healthy | Moderately | 412 | |
| | | | Inexpensive | | |
| Savory | Very Close | Moderately Healthy | Very Inexpensive | 411 | |
| Savory | Very Close | Moderately Healthy | Free | 410 | |
| Savory | Very Close | Very Healthy | Moderately | 409 | |
| | | | Expensive | | |
| Savory | Very Close | Very Healthy | Very Expensive | 408 | |
| Savory | Very Close | Very Healthy | Moderately | 407 | |
| | | | Inexpensive | | |
| Savory | Very Close | Very Healthy | Very Inexpensive | 406 | |
| Savory | Very Close | Very Healthy | Free | 405 | |
| Savory | Very Close | Moderately | Moderately | 404 | |
| | | Unhealthy | Expensive | | |
| Savory | Very Close | Moderately | Very Expensive | 403 | |
| | | Unhealthy | | | |
| Savory | Very Close | Moderately | Moderately | 402 | |
| | | Unhealthy | Inexpensive | | |
| Savory | Very Close | Moderately | Very Inexpensive | 401 | |
| | | Unhealthy | | | |
| Savory | Very Close | Moderately | Free | 400 | |
| | | Unhealthy | | | |
| Savory | Very Close | Very Unhealthy | Moderately | 399 | |
| | | | Expensive | | |
| Savory | Very Close | Very Unhealthy | Very Expensive | 398 | |
| Savory | Very Close | Very Unhealthy | Moderately | 397 | |
| | | | Inexpensive | | |
| Savory | Very Close | Very Unhealthy | Very Inexpensive | 396 | |
| Savory | Very Close | Very Unhealthy | Free | 395 | |
| Savory | None | Neutral | Moderately | 394 | |
| | | | Expensive | | |
| Savory | None | Neutral | Very Expensive | 393 | |
| Savory | None | Neutral | Moderately | 392 | |
| | | | Inexpensive | | |
| Savory | None | Neutral | Very Inexpensive | 391 | |
| Savory | None | Neutral | Free | 390 | |
| Savory | None | Moderately Healthy | Moderately | 389 | |
| | | | Expensive | | |
| Savory | None | Moderately Healthy | Very Expensive | 388 | |
| Savory | None | Moderately Healthy | Moderately | 387 | |
| | | | Inexpensive | | |
| Savory | None | Moderately Healthy | Very Inexpensive | 386 | |
| Savory | None | Moderately Healthy | Free | 385 | |
| Savory | None | Very Healthy | Moderately | 384 | |
| | | | Expensive | | |
| Savory | None | Very Healthy | Very Expensive | 383 | |
| Savory | None | Very Healthy | Moderately | 382 | |
| | | | Inexpensive | | |
| Savory | None | Very Healthy | Very Inexpensive | 381 | |
| Savory | None | Very Healthy | Free | 380 | |
| Savory | None | Moderately | Moderately | 379 | |
| | | Unhealthy | Expensive | | |
| Savory | None | Moderately | Very Expensive | 378 | |
| | | Unhealthy | | | |
| Savory | None | Moderately | Moderately | 377 | |
| | | Unhealthy | Inexpensive | | |
| Savory | None | Moderately | Very Inexpensive | 376 | |
| | | Unhealthy | | | |
| Savory | None | Moderately | Free | 375 | |
| | | Unhealthy | | | |
| Savory | None | Very Unhealthy | Moderately | 374 | |
| | | | Expensive | | |
| Savory | None | Very Unhealthy | Very Expensive | 373 | |
| Savory | None | Very Unhealthy | Moderately | 372 | |
| | | | Inexpensive | | |
| Savory | None | Very Unhealthy | Very Inexpensive | 371 | |
| Savory | None | Very Unhealthy | Free | 370 | |
| Good-Tasting | Moderately | Neutral | Moderately | 369 | |
| | Far | | Expensive | | |
| Good-Tasting | Moderately | Neutral | Very Expensive | 368 | |
| | Far | | | | |
| Good-Tasting | Moderately | Neutral | Moderately | 367 | |
| | Far | | Inexpensive | | |
| Good-Tasting | Moderately | Neutral | Very Inexpensive | 366 | |
| | Far | | | | |
| Good-Tasting | Moderately | Neutral | Free | 365 | |
| | Far | | | | |
| Good-Tasting | Moderately | Moderately Healthy | Moderately | 364 | |
| | Far | | Expensive | | |
| Good-Tasting | Moderately | Moderately Healthy | Very Expensive | 363 | |
| | Far | | | | |
| Good-Tasting | Moderately | Moderately Healthy | Moderately | 362 | |
| | Far | | Inexpensive | | |
| Good-Tasting | Moderately | Moderately Healthy | Very Inexpensive | 361 | |
| | Far | | | | |
| Good-Tasting | Moderately | Moderately Healthy | Free | 360 | |
| | Far | | | | |
| Good-Tasting | Moderately | Very Healthy | Moderately | 359 | |
| | Far | | Expensive | | |
| Good-Tasting | Moderately | Very Healthy | Very Expensive | 358 | |
| | Far | | | | |
| Good-Tasting | Moderately | Very Healthy | Moderately | 357 | |
| | Far | | Inexpensive | | |
| Good-Tasting | Moderately | Very Healthy | Very Inexpensive | 356 | |
| | Far | | | | |
| Good-Tasting | Moderately | Very Healthy | Free | 355 | |
| | Far | | | | |
| Good-Tasting | Moderately | Moderately | Moderately | 354 | |
| | Far | Unhealthy | Expensive | | |
| Good-Tasting | Moderately | Moderately | Very Expensive | 353 | |
| | Far | Unhealthy | | | |
| Good-Tasting | Moderately | Moderately | Moderately | 352 | |
| | Far | Unhealthy | Inexpensive | | |
| Good-Tasting | Moderately | Moderately | Very Inexpensive | 351 | |
| | Far | Unhealthy | | | |
| Good-Tasting | Moderately | Moderately | Free | 350 | |
| | Far | Unhealthy | | | |
| Good-Tasting | Moderately | Very Unhealthy | Moderately | 349 | |
| | Far | | Expensive | | |
| Good-Tasting | Moderately | Very Unhealthy | Very Expensive | 348 | |
| | Far | | | | |
| Good-Tasting | Moderately | Very Unhealthy | Moderately | 347 | |
| | Far | | Inexpensive | | |
| Good-Tasting | Moderately | Very Unhealthy | Very Inexpensive | 346 | |
| | Far | | | | |
| Good-Tasting | Moderately | Very Unhealthy | Free | 345 | |
| | Far | | | | |
| Good-Tasting | Very Far | Neutral | Moderately | 344 | |
| | | | Expensive | | |
| Good-Tasting | Very Far | Neutral | Very Expensive | 343 | |
| Good-Tasting | Very Far | Neutral | Moderately | 342 | |
| | | | Inexpensive | | |
| Good-Tasting | Very Far | Neutral | Very Inexpensive | 341 | |
| Good-Tasting | Very Far | Neutral | Free | 340 | |
| Good-Tasting | Very Far | Moderately Healthy | Moderately | 339 | |
| | | | Expensive | | |
| Good-Tasting | Very Far | Moderately Healthy | Very Expensive | 338 | |
| Good-Tasting | Very Far | Moderately Healthy | Moderately | 337 | Subway |
| | | | Inexpensive | | |
| Good-Tasting | Very Far | Moderately Healthy | Very Inexpensive | 336 | |
| Good-Tasting | Very Far | Moderately Healthy | Free | 335 | |
| Good-Tasting | Very Far | Very Healthy | Moderately | 334 | |
| | | | Expensive | | |
| Good-Tasting | Very Far | Very Healthy | Very Expensive | 333 | |
| Good-Tasting | Very Far | Very Healthy | Moderately | 332 | |
| | | | Inexpensive | | |
| Good-Tasting | Very Far | Very Healthy | Very Inexpensive | 331 | |
| Good-Tasting | Very Far | Very Healthy | Free | 330 | |
| Good-Tasting | Very Far | Moderately | Moderately | 329 | |
| | | Unhealthy | Expensive | | |
| Good-Tasting | Very Far | Moderately | Very Expensive | 328 | |
| | | Unhealthy | | | |
| Good-Tasting | Very Far | Moderately | Moderately | 327 | |
| | | Unhealthy | Inexpensive | | |
| Good-Tasting | Very Far | Moderately | Very Inexpensive | 326 | |
| | | Unhealthy | | | |
| Good-Tasting | Very Far | Moderately | Free | 325 | |
| | | Unhealthy | | | |
| Good-Tasting | Very Far | Very Unhealthy | Moderately | 324 | |
| | | | Expensive | | |
| Good-Tasting | Very Far | Very Unhealthy | Very Expensive | 323 | |
| Good-Tasting | Very Far | Very Unhealthy | Moderately | 322 | |
| | | | Inexpensive | | |
| Good-Tasting | Very Far | Very Unhealthy | Very Inexpensive | 321 | |
| Good-Tasting | Very Far | Very Unhealthy | Free | 320 | |
| Good-Tasting | Moderately | Neutral | Moderately | 319 | |
| | Close | | Expensive | | |
| Good-Tasting | Moderately | Neutral | Very Expensive | 318 | |
| | Close | | | | |
| Good-Tasting | Moderately | Neutral | Moderately | 317 | |
| | Close | | Inexpensive | | |
| Good-Tasting | Moderately | Neutral | Very Inexpensive | 316 | |
| | Close | | | | |
| Good-Tasting | Moderately | Neutral | Free | 315 | |
| | Close | | | | |
| Good-Tasting | Moderately | Moderately Healthy | Moderately | 314 | |
| | Close | | Expensive | | |
| Good-Tasting | Moderately | Moderately Healthy | Very Expensive | 313 | |
| | Close | | | | |
| Good-Tasting | Moderately | Moderately Healthy | Moderately | 312 | |
| | Close | | Inexpensive | | |
| Good-Tasting | Moderately | Moderately Healthy | Very Inexpensive | 311 | |
| | Close | | | | |
| Good-Tasting | Moderately | Moderately Healthy | Free | 310 | |
| | Close | | | | |
| Good-Tasting | Moderately | Very Healthy | Moderately | 309 | |
| | Close | | Expensive | | |
| Good-Tasting | Moderately | Very Healthy | Very Expensive | 308 | |
| | Close | | | | |
| Good-Tasting | Moderately | Very Healthy | Moderately | 307 | |
| | Close | | Inexpensive | | |
| Good-Tasting | Moderately | Very Healthy | Very Inexpensive | 306 | |
| | Close | | | | |
| Good-Tasting | Moderately | Very Healthy | Free | 305 | |
| | Close | | | | |
| Good-Tasting | Moderately | Moderately | Moderately | 304 | |
| | Close | Unhealthy | Expensive | | |
| Good-Tasting | Moderately | Moderately | Very Expensive | 303 | |
| | Close | Unhealthy | | | |
| Good-Tasting | Moderately | Moderately | Moderately | 302 | |
| | Close | Unhealthy | Inexpensive | | |
| Good-Tasting | Moderately | Moderately | Very Inexpensive | 301 | |
| | Close | Unhealthy | | | |
| Good-Tasting | Moderately | Moderately | Free | 300 | |
| | Close | Unhealthy | | | |
| Good-Tasting | Moderately | Very Unhealthy | Moderately | 299 | |
| | Close | | Expensive | | |
| Good-Tasting | Moderately | Very Unhealthy | Very Expensive | 298 | |
| | Close | | | | |
| Good-Tasting | Moderately | Very Unhealthy | Moderately | 297 | |
| | Close | | Inexpensive | | |
| Good-Tasting | Moderately | Very Unhealthy | Very Inexpensive | 296 | |
| | Close | | | | |
| Good-Tasting | Moderately | Very Unhealthy | Free | 295 | |
| | Close | | | | |
| Good-Tasting | Very Close | Neutral | Moderately | 294 | |
| | | | Expensive | | |
| Good-Tasting | Very Close | Neutral | Very Expensive | 293 | |
| Good-Tasting | Very Close | Neutral | Moderately | 292 | |
| | | | Inexpensive | | |
| Good-Tasting | Very Close | Neutral | Very Inexpensive | 291 | |
| Good-Tasting | Very Close | Neutral | Free | 290 | |
| Good-Tasting | Very Close | Moderately Healthy | Moderately | 289 | |
| | | | Expensive | | |
| Good-Tasting | Very Close | Moderately Healthy | Very Expensive | 288 | |
| Good-Tasting | Very Close | Moderately Healthy | Moderately | 287 | |
| | | | Inexpensive | | |
| Good-Tasting | Very Close | Moderately Healthy | Very Inexpensive | 286 | |
| Good-Tasting | Very Close | Moderately Healthy | Free | 285 | |
| Good-Tasting | Very Close | Very Healthy | Moderately | 284 | |
| | | | Expensive | | |
| Good-Tasting | Very Close | Very Healthy | Very Expensive | 283 | |
| Good-Tasting | Very Close | Very Healthy | Moderately | 282 | |
| | | | Inexpensive | | |
| Good-Tasting | Very Close | Very Healthy | Very Inexpensive | 281 | |
| Good-Tasting | Very Close | Very Healthy | Free | 280 | |
| Good-Tasting | Very Close | Moderately | Moderately | 279 | |
| | | Unhealthy | Expensive | | |
| Good-Tasting | Very Close | Moderately | Very Expensive | 278 | |
| | | Unhealthy | | | |
| Good-Tasting | Very Close | Moderately | Moderately | 277 | |
| | | Unhealthy | Inexpensive | | |
| Good-Tasting | Very Close | Moderately | Very Inexpensive | 276 | |
| | | Unhealthy | | | |
| Good-Tasting | Very Close | Moderately | Free | 275 | |
| | | Unhealthy | | | |
| Good-Tasting | Very Close | Very Unhealthy | Moderately | 274 | |
| | | | Expensive | | |
| Good-Tasting | Very Close | Very Unhealthy | Very Expensive | 273 | |
| Good-Tasting | Very Close | Very Unhealthy | Moderately | 272 | |
| | | | Inexpensive | | |
| Good-Tasting | Very Close | Very Unhealthy | Very Inexpensive | 271 | |
| Good-Tasting | Very Close | Very Unhealthy | Free | 270 | |
| Good-Tasting | None | Neutral | Moderately | 269 | |
| | | | Expensive | | |
| Good-Tasting | None | Neutral | Very Expensive | 268 | |
| Good-Tasting | None | Neutral | Moderately | 267 | |
| | | | Inexpensive | | |
| Good-Tasting | None | Neutral | Very Inexpensive | 266 | |
| Good-Tasting | None | Neutral | Free | 265 | |
| Good-Tasting | None | Moderately Healthy | Moderately | 264 | |
| | | | Expensive | | |
| Good-Tasting | None | Moderately Healthy | Very Expensive | 263 | |
| Good-Tasting | None | Moderately Healthy | Moderately | 262 | |
| | | | Inexpensive | | |
| Good-Tasting | None | Moderately Healthy | Very Inexpensive | 261 | |
| Good-Tasting | None | Moderately Healthy | Free | 260 | |
| Good-Tasting | None | Very Healthy | Moderately | 259 | |
| | | | Expensive | | |
| Good-Tasting | None | Very Healthy | Very Expensive | 258 | |
| Good-Tasting | None | Very Healthy | Moderately | 257 | |
| | | | Inexpensive | | |
| Good-Tasting | None | Very Healthy | Very Inexpensive | 256 | |
| Good-Tasting | None | Very Healthy | Free | 255 | |
| Good-Tasting | None | Moderately | Moderately | 254 | |
| | | Unhealthy | Expensive | | |
| Good-Tasting | None | Moderately | Very Expensive | 253 | |
| | | Unhealthy | | | |
| Good-Tasting | None | Moderately | Moderately | 252 | |
| | | Unhealthy | Inexpensive | | |
| Good-Tasting | None | Moderately | Very Inexpensive | 251 | |
| | | Unhealthy | | | |
| Good-Tasting | None | Moderately | Free | 250 | |
| | | Unhealthy | | | |
| Good-Tasting | None | Very Unhealthy | Moderately | 249 | |
| | | | Expensive | | |
| Good-Tasting | None | Very Unhealthy | Very Expensive | 248 | |
| Good-Tasting | None | Very Unhealthy | Moderately | 247 | |
| | | | Inexpensive | | |
| Good-Tasting | None | Very Unhealthy | Very Inexpensive | 246 | |
| Good-Tasting | None | Very Unhealthy | Free | 245 | |
| Delicious | Moderately | Neutral | Moderately | 244 | |
| | Far | | Expensive | | |
| Delicious | Moderately | Neutral | Very Expensive | 243 | |
| | Far | | | | |
| Delicious | Moderately | Neutral | Moderately | 242 | |
| | Far | | Inexpensive | | |
| Delicious | Moderately | Neutral | Very Inexpensive | 241 | |
| | Far | | | | |
| Delicious | Moderately | Neutral | Free | 240 | |
| | Far | | | | |
| Delicious | Moderately | Moderately Healthy | Moderately | 239 | |
| | Far | | Expensive | | |
| Delicious | Moderately | Moderately Healthy | Very Expensive | 238 | |
| | Far | | | | |
| Delicious | Moderately | Moderately Healthy | Moderately | 237 | |
| | Far | | Inexpensive | | |
| Delicious | Moderately | Moderately Healthy | Very Inexpensive | 236 | |
| | Far | | | | |
| Delicious | Moderately | Moderately Healthy | Free | 235 | |
| | Far | | | | |
| Delicious | Moderately | Very Healthy | Moderately | 234 | |
| | Far | | Expensive | | |
| Delicious | Moderately | Very Healthy | Very Expensive | 233 | |
| | Far | | | | |
| Delicious | Moderately | Very Healthy | Moderately | 232 | |
| | Far | | Inexpensive | | |
| Delicious | Moderately | Very Healthy | Very Inexpensive | 231 | |
| | Far | | | | |
| Delicious | Moderately | Very Healthy | Free | 230 | |
| | Far | | | | |
| Delicious | Moderately | Moderately | Moderately | 229 | Chipotle |
| | Far | Unhealthy | Expensive | | |
| Delicious | Moderately | Moderately | Very Expensive | 228 | |
| | Far | Unhealthy | | | |
| Delicious | Moderately | Moderately | Moderately | 227 | |
| | Far | Unhealthy | Inexpensive | | |
| Delicious | Moderately | Moderately | Very Inexpensive | 226 | |
| | Far | Unhealthy | | | |
| Delicious | Moderately | Moderately | Free | 225 | |
| | Far | Unhealthy | | | |
| Delicious | Moderately | Very Unhealthy | Moderately | 224 | |
| | Far | | Expensive | | |
| Delicious | Moderately | Very Unhealthy | Very Expensive | 223 | |
| | Far | | | | |
| Delicious | Moderately | Very Unhealthy | Moderately | 222 | |
| | Far | | Inexpensive | | |
| Delicious | Moderately | Very Unhealthy | Very Inexpensive | 221 | |
| | Far | | | | |
| Delicious | Moderately | Very Unhealthy | Free | 220 | |
| | Far | | | | |
| Delicious | Very Far | Neutral | Moderately | 219 | |
| | | | Expensive | | |
| Delicious | Very Far | Neutral | Very Expensive | 218 | |
| Delicious | Very Far | Neutral | Moderately | 217 | |
| | | | Inexpensive | | |
| Delicious | Very Far | Neutral | Very Inexpensive | 216 | |
| Delicious | Very Far | Neutral | Free | 215 | |
| Delicious | Very Far | Moderately Healthy | Moderately | 214 | |
| | | | Expensive | | |
| Delicious | Very Far | Moderately Healthy | Very Expensive | 213 | |
| Delicious | Very Far | Moderately Healthy | Moderately | 212 | |
| | | | Inexpensive | | |
| Delicious | Very Far | Moderately Healthy | Very Inexpensive | 211 | |
| Delicious | Very Far | Moderately Healthy | Free | 210 | |
| Delicious | Very Far | Very Healthy | Moderately | 209 | |
| | | | Expensive | | |
| Delicious | Very Far | Very Healthy | Very Expensive | 208 | |
| Delicious | Very Far | Very Healthy | Moderately | 207 | |
| | | | Inexpensive | | |
| Delicious | Very Far | Very Healthy | Very Inexpensive | 206 | |
| Delicious | Very Far | Very Healthy | Free | 205 | |
| Delicious | Very Far | Moderately | Moderately | 204 | |
| | | Unhealthy | Expensive | | |
| Delicious | Very Far | Moderately | Very Expensive | 203 | |
| | | Unhealthy | | | |
| Delicious | Very Far | Moderately | Moderately | 202 | |
| | | Unhealthy | Inexpensive | | |
| Delicious | Very Far | Moderately | Very Inexpensive | 201 | |
| | | Unhealthy | | | |
| Delicious | Very Far | Moderately | Free | 200 | |
| | | Unhealthy | | | |
| Delicious | Very Far | Very Unhealthy | Moderately | 199 | |
| | | | Expensive | | |
| Delicious | Very Far | Very Unhealthy | Very Expensive | 198 | |
| Delicious | Very Far | Very Unhealthy | Moderately | 197 | |
| | | | Inexpensive | | |
| Delicious | Very Far | Very Unhealthy | Very Inexpensive | 196 | |
| Delicious | Very Far | Very Unhealthy | Free | 195 | |
| Delicious | Moderately | Neutral | Moderately | 194 | |
| | Close | | Expensive | | |
| Delicious | Moderately | Neutral | Very Expensive | 193 | |
| | Close | | | | |
| Delicious | Moderately | Neutral | Moderately | 192 | |
| | Close | | Inexpensive | | |
| Delicious | Moderately | Neutral | Very Inexpensive | 191 | |
| | Close | | | | |
| Delicious | Moderately | Neutral | Free | 190 | |
| | Close | | | | |
| Delicious | Moderately | Moderately Healthy | Moderately | 189 | |
| | Close | | Expensive | | |
| Delicious | Moderately | Moderately Healthy | Very Expensive | 188 | |
| | Close | | | | |
| Delicious | Moderately | Moderately Healthy | Moderately | 187 | |
| | Close | | Inexpensive | | |
| Delicious | Moderately | Moderately Healthy | Very Inexpensive | 186 | |
| | Close | | | | |
| Delicious | Moderately | Moderately Healthy | Free | 185 | |
| | Close | | | | |
| Delicious | Moderately | Very Healthy | Moderately | 184 | |
| | Close | | Expensive | | |
| Delicious | Moderately | Very Healthy | Very Expensive | 183 | |
| | Close | | | | |
| Delicious | Moderately | Very Healthy | Moderately | 182 | |
| | Close | | Inexpensive | | |
| Delicious | Moderately | Very Healthy | Very Inexpensive | 181 | |
| | Close | | | | |
| Delicious | Moderately | Very Healthy | Free | 180 | |
| | Close | | | | |
| Delicious | Moderately | Moderately | Moderately | 179 | |
| | Close | Unhealthy | Expensive | | |
| Delicious | Moderately | Moderately | Very Expensive | 178 | |
| | Close | Unhealthy | | | |
| Delicious | Moderately | Moderately | Moderately | 177 | |
| | Close | Unhealthy | Inexpensive | | |
| Delicious | Moderately | Moderately | Very Inexpensive | 176 | |
| | Close | Unhealthy | | | |
| Delicious | Moderately | Moderately | Free | 175 | |
| | Close | Unhealthy | | | |
| Delicious | Moderately | Very Unhealthy | Moderately | 174 | |
| | Close | | Expensive | | |
| Delicious | Moderately | Very Unhealthy | Very Expensive | 173 | |
| | Close | | | | |
| Delicious | Moderately | Very Unhealthy | Moderately | 172 | |
| | Close | | Inexpensive | | |
| Delicious | Moderately | Very Unhealthy | Very Inexpensive | 171 | |
| | Close | | | | |
| Delicious | Moderately | Very Unhealthy | Free | 170 | |
| | Close | | | | |
| Delicious | Very Close | Neutral | Moderately | 169 | |
| | | | Expensive | | |
| Delicious | Very Close | Neutral | Very Expensive | 168 | |
| Delicious | Very Close | Neutral | Moderately | 167 | |
| | | | Inexpensive | | |
| Delicious | Very Close | Neutral | Very Inexpensive | 166 | |
| Delicious | Very Close | Neutral | Free | 165 | |
| Delicious | Very Close | Moderately Healthy | Moderately | 164 | |
| | | | Expensive | | |
| Delicious | Very Close | Moderately Healthy | Very Expensive | 163 | |
| Delicious | Very Close | Moderately Healthy | Moderately | 162 | |
| | | | Inexpensive | | |
| Delicious | Very Close | Moderately Healthy | Very Inexpensive | 161 | |
| Delicious | Very Close | Moderately Healthy | Free | 160 | |
| Delicious | Very Close | Very Healthy | Moderately | 159 | |
| | | | Expensive | | |
| Delicious | Very Close | Very Healthy | Very Expensive | 158 | |
| Delicious | Very Close | Very Healthy | Moderately | 157 | |
| | | | Inexpensive | | |
| Delicious | Very Close | Very Healthy | Very Inexpensive | 156 | |
| Delicious | Very Close | Very Healthy | Free | 155 | |
| Delicious | Very Close | Moderately | Moderately | 154 | |
| | | Unhealthy | Expensive | | |
| Delicious | Very Close | Moderately | Very Expensive | 153 | |
| | | Unhealthy | | | |
| Delicious | Very Close | Moderately | Moderately | 152 | |
| | | Unhealthy | Inexpensive | | |
| Delicious | Very Close | Moderately | Very Inexpensive | 151 | |
| | | Unhealthy | | | |
| Delicious | Very Close | Moderately | Free | 150 | |
| | | Unhealthy | | | |
| Delicious | Very Close | Very Unhealthy | Moderately | 149 | |
| | | | Expensive | | |
| Delicious | Very Close | Very Unhealthy | Very Expensive | 148 | |
| Delicious | Very Close | Very Unhealthy | Moderately | 147 | |
| | | | Inexpensive | | |
| Delicious | Very Close | Very Unhealthy | Very Inexpensive | 146 | |
| Delicious | Very Close | Very Unhealthy | Free | 145 | |
| Delicious | None | Neutral | Moderately | 144 | |
| | | | Expensive | | |
| Delicious | None | Neutral | Very Expensive | 143 | |
| Delicious | None | Neutral | Moderately | 142 | |
| | | | Inexpensive | | |
| Delicious | None | Neutral | Very Inexpensive | 141 | |
| Delicious | None | Neutral | Free | 140 | |
| Delicious | None | Moderately Healthy | Moderately | 139 | |
| | | | Expensive | | |
| Delicious | None | Moderately Healthy | Very Expensive | 138 | |
| Delicious | None | Moderately Healthy | Moderately | 137 | |
| | | | Inexpensive | | |
| Delicious | None | Moderately Healthy | Very Inexpensive | 136 | |
| Delicious | None | Moderately Healthy | Free | 135 | |
| Delicious | None | Very Healthy | Moderately | 134 | |
| | | | Expensive | | |
| Delicious | None | Very Healthy | Very Expensive | 133 | |
| Delicious | None | Very Healthy | Moderately | 132 | |
| | | | Inexpensive | | |
| Delicious | None | Very Healthy | Very Inexpensive | 131 | |
| Delicious | None | Very Healthy | Free | 130 | |
| Delicious | None | Moderately | Moderately | 129 | |
| | | Unhealthy | Expensive | | |
| Delicious | None | Moderately | Very Expensive | 128 | |
| | | Unhealthy | | | |
| Delicious | None | Moderately | Moderately | 127 | |
| | | Unhealthy | Inexpensive | | |
| Delicious | None | Moderately | Very Inexpensive | 126 | |
| | | Unhealthy | | | |
| Delicious | None | Moderately | Free | 125 | |
| | | Unhealthy | | | |
| Delicious | None | Very Unhealthy | Moderately | 124 | |
| | | | Expensive | | |
| Delicious | None | Very Unhealthy | Very Expensive | 123 | |
| Delicious | None | Very Unhealthy | Moderately | 122 | |
| | | | Inexpensive | | |
| Delicious | None | Very Unhealthy | Very Inexpensive | 121 | |
| Delicious | None | Very Unhealthy | Free | 120 | |
| Acceptable | Moderately | Neutral | Moderately | 119 | |
| | Far | | Expensive | | |
| Acceptable | Moderately | Neutral | Very Expensive | 118 | |
| | Far | | | | |
| Acceptable | Moderately | Neutral | Moderately | 117 | |
| | Far | | Inexpensive | | |
| Acceptable | Moderately | Neutral | Very Inexpensive | 116 | |
| | Far | | | | |
| Acceptable | Moderately | Neutral | Free | 115 | |
| | Far | | | | |
| Acceptable | Moderately | Moderately Healthy | Moderately | 114 | |
| | Far | | Expensive | | |
| Acceptable | Moderately | Moderately Healthy | Very Expensive | 113 | |
| | Far | | | | |
| Acceptable | Moderately | Moderately Healthy | Moderately | 112 | |
| | Far | | Inexpensive | | |
| Acceptable | Moderately | Moderately Healthy | Very Inexpensive | 111 | |
| | Far | | | | |
| Acceptable | Moderately | Moderately Healthy | Free | 110 | |
| | Far | | | | |
| Acceptable | Moderately | Very Healthy | Moderately | 109 | |
| | Far | | Expensive | | |
| Acceptable | Moderately | Very Healthy | Very Expensive | 108 | |
| | Far | | | | |
| Acceptable | Moderately | Very Healthy | Moderately | 107 | |
| | Far | | Inexpensive | | |
| Acceptable | Moderately | Very Healthy | Very Inexpensive | 106 | |
| | Far | | | | |
| Acceptable | Moderately | Very Healthy | Free | 105 | |
| | Far | | | | |
| Acceptable | Moderately | Moderately | Moderately | 104 | |
| | Far | Unhealthy | Expensive | | |
| Acceptable | Moderately | Moderately | Very Expensive | 103 | |
| | Far | Unhealthy | | | |
| Acceptable | Moderately | Moderately | Moderately | 102 | |
| | Far | Unhealthy | Inexpensive | | |
| Acceptable | Moderately | Moderately | Very Inexpensive | 101 | |
| | Far | Unhealthy | | | |
| Acceptable | Moderately | Moderately | Free | 100 | |
| | Far | Unhealthy | | | |
| Acceptable | Moderately | Very Unhealthy | Moderately | 99 | |
| | Far | | Expensive | | |
| Acceptable | Moderately | Very Unhealthy | Very Expensive | 98 | |
| | Far | | | | |
| Acceptable | Moderately | Very Unhealthy | Moderately | 97 | |
| | Far | | Inexpensive | | |
| Acceptable | Moderately | Very Unhealthy | Very Inexpensive | 96 | |
| | Far | | | | |
| Acceptable | Moderately | Very Unhealthy | Free | 95 | |
| | Far | | | | |
| Acceptable | Very Far | Neutral | Moderately | 94 | |
| | | | Expensive | | |
| Acceptable | Very Far | Neutral | Very Expensive | 93 | |
| Acceptable | Very Far | Neutral | Moderately | 92 | |
| | | | Inexpensive | | |
| Acceptable | Very Far | Neutral | Very Inexpensive | 91 | |
| Acceptable | Very Far | Neutral | Free | 90 | |
| Acceptable | Very Far | Moderately Healthy | Moderately | 89 | |
| | | | Expensive | | |
| Acceptable | Very Far | Moderately Healthy | Very Expensive | 88 | |
| Acceptable | Very Far | Moderately Healthy | Moderately | 87 | |
| | | | Inexpensive | | |
| Acceptable | Very Far | Moderately Healthy | Very Inexpensive | 86 | |
| Acceptable | Very Far | Moderately Healthy | Free | 85 | |
| Acceptable | Very Far | Very Healthy | Moderately | 84 | |
| | | | Expensive | | |
| Acceptable | Very Far | Very Healthy | Very Expensive | 83 | |
| Acceptable | Very Far | Very Healthy | Moderately | 82 | |
| | | | Inexpensive | | |
| Acceptable | Very Far | Very Healthy | Very Inexpensive | 81 | |
| Acceptable | Very Far | Very Healthy | Free | 80 | |
| Acceptable | Very Far | Moderately | Moderately | 79 | |
| | | Unhealthy | Expensive | | |
| Acceptable | Very Far | Moderately | Very Expensive | 78 | |
| | | Unhealthy | | | |
| Acceptable | Very Far | Moderately | Moderately | 77 | |
| | | Unhealthy | Inexpensive | | |
| Acceptable | Very Far | Moderately | Very Inexpensive | 76 | |
| | | Unhealthy | | | |
| Acceptable | Very Far | Moderately | Free | 75 | |
| | | Unhealthy | | | |
| Acceptable | Very Far | Very Unhealthy | Moderately | 74 | |
| | | | Expensive | | |
| Acceptable | Very Far | Very Unhealthy | Very Expensive | 73 | |
| Acceptable | Very Far | Very Unhealthy | Moderately | 72 | |
| | | | Inexpensive | | |
| Acceptable | Very Far | Very Unhealthy | Very Inexpensive | 71 | |
| Acceptable | Very Far | Very Unhealthy | Free | 70 | |
| Acceptable | Moderately | Neutral | Moderately | 69 | |
| | Close | | Expensive | | |
| Acceptable | Moderately | Neutral | Very Expensive | 68 | |
| | Close | | | | |
| Acceptable | Moderately | Neutral | Moderately | 67 | |
| | Close | | Inexpensive | | |
| Acceptable | Moderately | Neutral | Very Inexpensive | 66 | |
| | Close | | | | |
| Acceptable | Moderately | Neutral | Free | 65 | |
| | Close | | | | |
| Acceptable | Moderately | Moderately Healthy | Moderately | 64 | |
| | Close | | Expensive | | |
| Acceptable | Moderately | Moderately Healthy | Very Expensive | 63 | |
| | Close | | | | |
| Acceptable | Moderately | Moderately Healthy | Moderately | 62 | |
| | Close | | Inexpensive | | |
| Acceptable | Moderately | Moderately Healthy | Very Inexpensive | 61 | |
| | Close | | | | |
| Acceptable | Moderately | Moderately Healthy | Free | 60 | |
| | Close | | | | |
| Acceptable | Moderately | Very Healthy | Moderately | 59 | |
| | Close | | Expensive | | |
| Acceptable | Moderately | Very Healthy | Very Expensive | 58 | |
| | Close | | | | |
| Acceptable | Moderately | Very Healthy | Moderately | 57 | |
| | Close | | Inexpensive | | |
| Acceptable | Moderately | Very Healthy | Very Inexpensive | 56 | |
| | Close | | | | |
| Acceptable | Moderately | Very Healthy | Free | 55 | |
| | Close | | | | |
| Acceptable | Moderately | Moderately | Moderately | 54 | |
| | Close | Unhealthy | Expensive | | |
| Acceptable | Moderately | Moderately | Very Expensive | 53 | |
| | Close | Unhealthy | | | |
| Acceptable | Moderately | Moderately | Moderately | 52 | |
| | Close | Unhealthy | Inexpensive | | |
| Acceptable | Moderately | Moderately | Very Inexpensive | 51 | |
| | Close | Unhealthy | | | |
| Acceptable | Moderately | Moderately | Free | 50 | |
| | Close | Unhealthy | | | |
| Acceptable | Moderately | Very Unhealthy | Moderately | 49 | |
| | Close | | Expensive | | |
| Acceptable | Moderately | Very Unhealthy | Very Expensive | 48 | |
| | Close | | | | |
| Acceptable | Moderately | Very Unhealthy | Moderately | 47 | |
| | Close | | Inexpensive | | |
| Acceptable | Moderately | Very Unhealthy | Very Inexpensive | 46 | |
| | Close | | | | |
| Acceptable | Moderately | Very Unhealthy | Free | 45 | |
| | Close | | | | |
| Acceptable | Very Close | Neutral | Moderately | 44 | |
| | | | Expensive | | |
| Acceptable | Very Close | Neutral | Very Expensive | 43 | |
| Acceptable | Very Close | Neutral | Moderately | 42 | |
| | | | Inexpensive | | |
| Acceptable | Very Close | Neutral | Very Inexpensive | 41 | |
| Acceptable | Very Close | Neutral | Free | 40 | |
| Acceptable | Very Close | Moderately Healthy | Moderately | 39 | |
| | | | Expensive | | |
| Acceptable | Very Close | Moderately Healthy | Very Expensive | 38 | |
| Acceptable | Very Close | Moderately Healthy | Moderately | 37 | |
| | | | Inexpensive | | |
| Acceptable | Very Close | Moderately Healthy | Very Inexpensive | 36 | |
| Acceptable | Very Close | Moderately Healthy | Free | 35 | |
| Acceptable | Very Close | Very Healthy | Moderately | 34 | |
| | | | Expensive | | |
| Acceptable | Very Close | Very Healthy | Very Expensive | 33 | |
| Acceptable | Very Close | Very Healthy | Moderately | 32 | |
| | | | Inexpensive | | |
| Acceptable | Very Close | Very Healthy | Very Inexpensive | 31 | |
| Acceptable | Very Close | Very Healthy | Free | 30 | |
| Acceptable | Very Close | Moderately | Moderately | 29 | |
| | | Unhealthy | Expensive | | |
| Acceptable | Very Close | Moderately | Very Expensive | 28 | |
| | | Unhealthy | | | |
| Acceptable | Very Close | Moderately | Moderately | 27 | |
| | | Unhealthy | Inexpensive | | |
| Acceptable | Very Close | Moderately | Very Inexpensive | 26 | |
| | | Unhealthy | | | |
| Acceptable | Very Close | Moderately | Free | 25 | |
| | | Unhealthy | | | |
| Acceptable | Very Close | Very Unhealthy | Moderately | 24 | |
| | | | Expensive | | |
| Acceptable | Very Close | Very Unhealthy | Very Expensive | 23 | |
| Acceptable | Very Close | Very Unhealthy | Moderately | 22 | |
| | | | Inexpensive | | |
| Acceptable | Very Close | Very Unhealthy | Very Inexpensive | 21 | |
| Acceptable | Very Close | Very Unhealthy | Free | 20 | |
| Acceptable | None | Neutral | Moderately | 19 | |
| | | | Expensive | | |
| Acceptable | None | Neutral | Very Expensive | 18 | |
| Acceptable | None | Neutral | Moderately | 17 | |
| | | | Inexpensive | | |
| Acceptable | None | Neutral | Very Inexpensive | 16 | |
| Acceptable | None | Neutral | Free | 15 | |
| Acceptable | None | Moderately Healthy | Moderately | 14 | |
| | | | Expensive | | |
| Acceptable | None | Moderately Healthy | Very Expensive | 13 | |
| Acceptable | None | Moderately Healthy | Moderately | 12 | |
| | | | Inexpensive | | |
| Acceptable | None | Moderately Healthy | Very Inexpensive | 11 | |
| Acceptable | None | Moderately Healthy | Free | 10 | |
| Acceptable | None | Very Healthy | Moderately | 9 | |
| | | | Expensive | | |
| Acceptable | None | Very Healthy | Very Expensive | 8 | |
| Acceptable | None | Very Healthy | Moderately | 7 | |
| | | | Inexpensive | | |
| Acceptable | None | Very Healthy | Very Inexpensive | 6 | |
| Acceptable | None | Very Healthy | Free | 5 | |
| Acceptable | None | Moderately | Moderately | 4 | |
| | | Unhealthy | Expensive | | |
| Acceptable | None | Moderately | Very Expensive | 3 | |
| | | Unhealthy | | | |
| Acceptable | None | Moderately | Moderately | 2 | |
| | | Unhealthy | Inexpensive | | |
| Acceptable | None | Moderately | Very Inexpensive | 1 | |
| | | Unhealthy | | | |
| Acceptable | None | Moderately | Free | 0 | Nothing (Status |
| | | Unhealthy | | | Quo) |
| Acceptable | None | Very Unhealthy | Moderately | −1 | |
| | | | Expensive | | |
| Acceptable | None | Very Unhealthy | Very Expensive | −2 | |
| Acceptable | None | Very Unhealthy | Moderately | −3 | |
| | | | Inexpensive | | |
| Acceptable | None | Very Unhealthy | Very Inexpensive | −4 | |
| Acceptable | None | Very Unhealthy | Free | −5 | |
| Succulent | Moderately | Neutral | Moderately | −6 | |
| | Far | | Expensive | | |
| Succulent | Moderately | Neutral | Very Expensive | −7 | |
| | Far | | | | |
| Succulent | Moderately | Neutral | Moderately | −8 | |
| | Far | | Inexpensive | | |
| Succulent | Moderately | Neutral | Very Inexpensive | −9 | |
| | Far | | | | |
| Succulent | Moderately | Neutral | Free | −10 | |
| | Far | | | | |
| Succulent | Moderately | Moderately Healthy | Moderately | −11 | |
| | Far | | Expensive | | |
| Succulent | Moderately | Moderately Healthy | Very Expensive | −12 | |
| | Far | | | | |
| Succulent | Moderately | Moderately Healthy | Moderately | −13 | |
| | Far | | Inexpensive | | |
| Succulent | Moderately | Moderately Healthy | Very Inexpensive | −14 | |
| | Far | | | | |
| Succulent | Moderately | Moderately Healthy | Free | −15 | |
| | Far | | | | |
| Succulent | Moderately | Very Healthy | Moderately | −16 | |
| | Far | | Expensive | | |
| Succulent | Moderately | Very Healthy | Very Expensive | −17 | |
| | Far | | | | |
| Succulent | Moderately | Very Healthy | Moderately | −18 | |
| | Far | | Inexpensive | | |
| Succulent | Moderately | Very Healthy | Very Inexpensive | −19 | |
| | Far | | | | |
| Succulent | Moderately | Very Healthy | Free | −20 | |
| | Far | | | | |
| Succulent | Moderately | Moderately | Moderately | −21 | |
| | Far | Unhealthy | Expensive | | |
| Succulent | Moderately | Moderately | Very Expensive | −22 | |
| | Far | Unhealthy | | | |
| Succulent | Moderately | Moderately | Moderately | −23 | |
| | Far | Unhealthy | Inexpensive | | |
| Succulent | Moderately | Moderately | Very Inexpensive | −24 | |
| | Far | Unhealthy | | | |
| Succulent | Moderately | Moderately | Free | −25 | |
| | Far | Unhealthy | | | |
| Succulent | Moderately | Very Unhealthy | Moderately | −26 | |
| | Far | | Expensive | | |
| Succulent | Moderately | Very Unhealthy | Very Expensive | −27 | |
| | Far | | | | |
| Succulent | Moderately | Very Unhealthy | Moderately | −28 | |
| | Far | | Inexpensive | | |
| Succulent | Moderately | Very Unhealthy | Very Inexpensive | −29 | |
| | Far | | | | |
| Succulent | Moderately | Very Unhealthy | Free | −30 | |
| | Far | | | | |
| Succulent | Very Far | Neutral | Moderately | −31 | |
| | | | Expensive | | |
| Succulent | Very Far | Neutral | Very Expensive | −32 | |
| Succulent | Very Far | Neutral | Moderately | −33 | |
| | | | Inexpensive | | |
| Succulent | Very Far | Neutral | Very Inexpensive | −34 | |
| Succulent | Very Far | Neutral | Free | −35 | |
| Succulent | Very Far | Moderately Healthy | Moderately | −36 | |
| | | | Expensive | | |
| Succulent | Very Far | Moderately Healthy | Very Expensive | −37 | |
| Succulent | Very Far | Moderately Healthy | Moderately | −38 | |
| | | | Inexpensive | | |
| Succulent | Very Far | Moderately Healthy | Very Inexpensive | −39 | |
| Succulent | Very Far | Moderately Healthy | Free | −40 | |
| Succulent | Very Far | Very Healthy | Moderately | −41 | |
| | | | Expensive | | |
| Succulent | Very Far | Very Healthy | Very Expensive | −42 | |
| Succulent | Very Far | Very Healthy | Moderately | −43 | |
| | | | Inexpensive | | |
| Succulent | Very Far | Very Healthy | Very Inexpensive | −44 | |
| Succulent | Very Far | Very Healthy | Free | −45 | |
| Succulent | Very Far | Moderately | Moderately | −46 | |
| | | Unhealthy | Expensive | | |
| Succulent | Very Far | Moderately | Very Expensive | −47 | |
| | | Unhealthy | | | |
| Succulent | Very Far | Moderately | Moderately | −48 | |
| | | Unhealthy | Inexpensive | | |
| Succulent | Very Far | Moderately | Very Inexpensive | −49 | |
| | | Unhealthy | | | |
| Succulent | Very Far | Moderately | Free | −50 | |
| | | Unhealthy | | | |
| Succulent | Very Far | Very Unhealthy | Moderately | −51 | |
| | | | Expensive | | |
| Succulent | Very Far | Very Unhealthy | Very Expensive | −52 | |
| Succulent | Very Far | Very Unhealthy | Moderately | −53 | |
| | | | Inexpensive | | |
| Succulent | Very Far | Very Unhealthy | Very Inexpensive | −54 | |
| Succulent | Very Far | Very Unhealthy | Free | −55 | |
| Succulent | Moderately | Neutral | Moderately | −56 | |
| | Close | | Expensive | | |
| Succulent | Moderately | Neutral | Very Expensive | −57 | |
| | Close | | | | |
| Succulent | Moderately | Neutral | Moderately | −58 | |
| | Close | | Inexpensive | | |
| Succulent | Moderately | Neutral | Very Inexpensive | −59 | |
| | Close | | | | |
| Succulent | Moderately | Neutral | Free | −60 | |
| | Close | | | | |
| Succulent | Moderately | Moderately Healthy | Moderately | −61 | |
| | Close | | Expensive | | |
| Succulent | Moderately | Moderately Healthy | Very Expensive | −62 | |
| | Close | | | | |
| Succulent | Moderately | Moderately Healthy | Moderately | −63 | |
| | Close | | Inexpensive | | |
| Succulent | Moderately | Moderately Healthy | Very Inexpensive | −64 | |
| | Close | | | | |
| Succulent | Moderately | Moderately Healthy | Free | −65 | |
| | Close | | | | |
| Succulent | Moderately | Very Healthy | Moderately | −66 | |
| | Close | | Expensive | | |
| Succulent | Moderately | Very Healthy | Very Expensive | −67 | |
| | Close | | | | |
| Succulent | Moderately | Very Healthy | Moderately | −68 | |
| | Close | | Inexpensive | | |
| Succulent | Moderately | Very Healthy | Very Inexpensive | −69 | |
| | Close | | | | |
| Succulent | Moderately | Very Healthy | Free | −70 | |
| | Close | | | | |
| Succulent | Moderately | Moderately | Moderately | −71 | |
| | Close | Unhealthy | Expensive | | |
| Succulent | Moderately | Moderately | Very Expensive | −72 | |
| | Close | Unhealthy | | | |
| Succulent | Moderately | Moderately | Moderately | −73 | |
| | Close | Unhealthy | Inexpensive | | |
| Succulent | Moderately | Moderately | Very Inexpensive | −74 | |
| | Close | Unhealthy | | | |
| Succulent | Moderately | Moderately | Free | −75 | |
| | Close | Unhealthy | | | |
| Succulent | Moderately | Very Unhealthy | Moderately | −76 | |
| | Close | | Expensive | | |
| Succulent | Moderately | Very Unhealthy | Very Expensive | −77 | |
| | Close | | | | |
| Succulent | Moderately | Very Unhealthy | Moderately | −78 | |
| | Close | | Inexpensive | | |
| Succulent | Moderately | Very Unhealthy | Very Inexpensive | −79 | |
| | Close | | | | |
| Succulent | Moderately | Very Unhealthy | Free | −80 | |
| | Close | | | | |
| Succulent | Very Close | Neutral | Moderately | −81 | |
| | | | Expensive | | |
| Succulent | Very Close | Neutral | Very Expensive | −82 | |
| Succulent | Very Close | Neutral | Moderately | −83 | |
| | | | Inexpensive | | |
| Succulent | Very Close | Neutral | Very Inexpensive | −84 | |
| Succulent | Very Close | Neutral | Free | −85 | |
| Succulent | Very Close | Moderately Healthy | Moderately | −86 | |
| | | | Expensive | | |
| Succulent | Very Close | Moderately Healthy | Very Expensive | −87 | |
| Succulent | Very Close | Moderately Healthy | Moderately | −88 | |
| | | | Inexpensive | | |
| Succulent | Very Close | Moderately Healthy | Very Inexpensive | −89 | |
| Succulent | Very Close | Moderately Healthy | Free | −90 | |
| Succulent | Very Close | Very Healthy | Moderately | −91 | |
| | | | Expensive | | |
| Succulent | Very Close | Very Healthy | Very Expensive | −92 | |
| Succulent | Very Close | Very Healthy | Moderately | −93 | |
| | | | Inexpensive | | |
| Succulent | Very Close | Very Healthy | Very Inexpensive | −94 | |
| Succulent | Very Close | Very Healthy | Free | −95 | |
| Succulent | Very Close | Moderately | Moderately | −96 | |
| | | Unhealthy | Expensive | | |
| Succulent | Very Close | Moderately | Very Expensive | −97 | |
| | | Unhealthy | | | |
| Succulent | Very Close | Moderately | Moderately | −98 | |
| | | Unhealthy | Inexpensive | | |
| Succulent | Very Close | Moderately | Very Inexpensive | −99 | |
| | | Unhealthy | | | |
| Succulent | Very Close | Moderately | Free | −100 | |
| | | Unhealthy | | | |
| Succulent | Very Close | Very Unhealthy | Moderately | −101 | |
| | | | Expensive | | |
| Succulent | Very Close | Very Unhealthy | Very Expensive | −102 | |
| Succulent | Very Close | Very Unhealthy | Moderately | −103 | |
| | | | Inexpensive | | |
| Succulent | Very Close | Very Unhealthy | Very Inexpensive | −104 | |
| Succulent | Very Close | Very Unhealthy | Free | −105 | |
| Succulent | None | Neutral | Moderately | −106 | |
| | | | Expensive | | |
| Succulent | None | Neutral | Very Expensive | −107 | |
| Succulent | None | Neutral | Moderately | −108 | |
| | | | Inexpensive | | |
| Succulent | None | Neutral | Very Inexpensive | −109 | |
| Succulent | None | Neutral | Free | −110 | |
| Succulent | None | Moderately Healthy | Moderately | −111 | |
| | | | Expensive | | |
| Succulent | None | Moderately Healthy | Very Expensive | −112 | |
| Succulent | None | Moderately Healthy | Moderately | −113 | |
| | | | Inexpensive | | |
| Succulent | None | Moderately Healthy | Very Inexpensive | −114 | |
| Succulent | None | Moderately Healthy | Free | −115 | |
| Succulent | None | Very Healthy | Moderately | −116 | |
| | | | Expensive | | |
| Succulent | None | Very Healthy | Very Expensive | −117 | |
| Succulent | None | Very Healthy | Moderately | −118 | |
| | | | Inexpensive | | |
| Succulent | None | Very Healthy | Very Inexpensive | −119 | |
| Succulent | None | Very Healthy | Free | −120 | |
| Succulent | None | Moderately | Moderately | −121 | |
| | | Unhealthy | Expensive | | |
| Succulent | None | Moderately | Very Expensive | −122 | |
| | | Unhealthy | | | |
| Succulent | None | Moderately | Moderately | −123 | |
| | | Unhealthy | Inexpensive | | |
| Succulent | None | Moderately | Very Inexpensive | −124 | |
| | | Unhealthy | | | |
| Succulent | None | Moderately | Free | −125 | |
| | | Unhealthy | | | |
| Succulent | None | Very Unhealthy | Moderately | −126 | |
| | | | Expensive | | |
| Succulent | None | Very Unhealthy | Very Expensive | −127 | |
| Succulent | None | Very Unhealthy | Moderately | −128 | |
| | | | Inexpensive | | |
| Succulent | None | Very Unhealthy | Very Inexpensive | −129 | |
| Succulent | None | Very Unhealthy | Free | −130 | |

Although Carl's utility payoff schedule also contains exactly 625 option combinations (rows), the row containing the combination of options that correspond to the status quo combination in the scenario pathway table of Table 5 above (i.e., the option combination of “MODERATELY HEALTHY,” “ACCEPTABLE,” “FREE” and “NONE”) will be in a different location, relative to the top and bottom rows of the 625-row table, because Carl's rankings of the factors and options are different from Jane's rankings of the factors and options, and the reverse induction step therefore puts the status quo combination in a different location in Carl's schedule. More specifically, based on Carl's rankings of factors and options, the row in Carl's utility payoff schedule containing the status quo combination of options falls in the 496th row in the schedule (counting down from the top row) instead of the 300th row of the schedule (counting down from the top row) as was the case in Jane's utility payoff schedule. As a result of the status quo row being located closer to the bottom of the 625-row table, rather than roughly in the middle, the utility payoff scores obtained by running an ordinal array in both directions up and down Carl's reverse induction combination table produces utility payoff scores for each possible outcome scenario for Carl that are different from the utility payoff scores obtained for each one of the possible outcome scenarios for Jane. Table 20 below shows utility payoff scores recorded for Carl for each one of the possible outcome scenarios during step S425 of FIG. 4.

TABLE 20
CARL'S UTILITY PAYOFF SCORES BY SCENARIO

| Outcome Scenario | Utility Payoff Score |
|---|---|
| McDONALDS | 421 |
| SUBWAY | 337 |
| CHIPOTLE | 229 |
| NOTHING | 0 |

For step S430 of FIG. 4, going to McDonalds for lunch is recorded as Carl's “reality-based position” in respect to the range of possible outcome scenarios, despite the fact that his “stated position” (recorded in Table 7 above) was to go to Subway, because Carl's utility payoff score for the outcome scenario of going to McDonalds is the most positive (least negative) utility payoff score among all of Carl's utility payoff scores for all of the possible outcome scenarios. Carl's reality-based position will almost always be more reliable than his stated position because his reality-based position is derived, in accordance with the present invention, by taking into account Carl's priorities in respect to both the factors and the factor options associated with the defined issue.

It should be noted that the organizational structures of the reverse induction combination tables and the utility payoff schedules, as well as the processes for creating them, may vary significantly, depending on which embodiment of the present invention is being used. The discussion above describes how these tables might be created and how they might look when a manual or semi-automated embodiment of the present invention is being used to create them on paper, on a spreadsheet, or other electronically displayed document. In an automated embodiment of the present invention, however, it would not be necessary to create or use tables with the same appearances and structure as the tables above, so long as the computer system is programmed to track and manipulate the data values in such a way as to produce the same utility payoff scores based on the factor and option rankings in combination with status quo indexing.

Stage III of operation is complete when utility payoff scores have been calculated and recorded for all of the stakeholders for all of the possible outcome scenarios in the range of possible outcome scenarios for the defined issue. In the next stage of operation, Stage IV, the utility payoff scores, influence ratings and levels of concern for each stakeholder produced and recorded in the three previous stages of operation may be used to determine and record, among other things, the most likely egalitarian outcome scenario and/or the most likely influence-weighted outcome scenario in the range of possible outcome scenarios. FIG. 5 contains a flow diagram illustrating by way of example the steps performed in Stage IV of operation, according to one embodiment of the invention, to determine the most likely outcomes.

First, as shown in step S505 of FIG. 5, the egalitarian outcome scenario for the defined issue is determined by calculating the average payoff score for each one of the outcome scenarios in the range of possible outcome scenarios. The egalitarian outcome scenario is the outcome scenario that is most likely to occur because it has the most positive (least negative) average utility payoff score, not taking into account the influence ratings or the levels of concern for the stakeholders. The average utility payoff scores for each one of the possible outcome scenarios is calculated in the conventional manner by calculating the sum of all of the stakeholders' utility payoff scores for a selected outcome scenario, and then dividing that sum by the number of stakeholders. For our lunch example, the average utility payoff scores for each one of the possible outcome scenarios are shown in the right-most column of Table 21 below.

TABLE 21
UTILITY PAYOFF SCORES PER SCENARIO

| | Jane's Utility | Carl's Utility | Average Utility |
|---|---|---|---|
| Outcome Scenario | Payoff Scores | Payoff Scores | Payoff Score |
| McDONALDS | −211 | 421 | 105 |
| SUBWAY | 231 | 337 | 284* |
| CHIPOTLE | −33 | 229 | 98 |
| NOTHING | 0 | 0 | 0 |

Based on the average utility payoff scores for all of the possible outcome scenarios shown in the rightmost column of Table 21 above, it can be determined that, the most positive (least negative) average utility payoff score is 284, which is the average, across all stakeholders, for the outcome scenario of going to Subway for lunch. Therefore, the outcome scenario of going to Subway for lunch is the outcome scenario that is most likely to occur for the defined issue of what to do for lunch when influence and concern levels are not considered. Conversely, because doing nothing for lunch has the least positive (most negative) average utility payoff score in Table 21 above, doing nothing for lunch is the outcome scenario that Jane and Carl are least likely to select for the defined issue based on their utility payoff scores for skipping lunch.

In many situations where the goal is to rank possible outcomes according to their likelihood of coming to past, it will be apparent that some of the stakeholders will have more influence over the outcome than other stakeholders, and some of the stakeholders will care more about the defined issue and the range of possible outcomes than other stakeholders. In these situations, it is often necessary or desirable to account for the stakeholder's relative levels of influence on the issue, as well as their relative levels of concern about the issue. Accordingly, at step S510, embodiments of the present invention may obtain (or retrieve from memory) information and/or data representing the stakeholders' relative levels of influence, the stakeholders' relative levels of concern, or both influence and concern. In the discussion of the stakeholder influence and concern information shown in Table 7 above, it was established that, as between the two stakeholders, Jane and Carl, Jane has a relatively higher level of influence than Carl on the issue of going to lunch (100 vs. 90). However, we also established in the previous discussion that Carl's level of concern (60) about the issue is relatively greater than Jane's level of concern (40) about the same issue. In some embodiments of the present invention, the influence ratings obtained or retrieved in step S510 are unweighted by the levels of concern. In other embodiments, however, the influence ratings for each stakeholder may be weighted by the levels of concern by multiplying the influence ratings by the concern levels. In this example, the influence ratings for Jane and Carl are weighted by their respective levels of concern by multiplying the influence rating values for each stakeholder by the level of concern value for each stakeholder. This produces a concern-weighted influence rating of 4,000 (or 100×40) for Jane, and a concern-weighted influence rating of 5400 (or 90×60) for Carl.

Using these concern-weighted influence values for Jane and Carl, it is now possible to calculate and record the concern and influence weighted payoff scores for each stakeholder for each one of the possible outcome scenarios. This is accomplished at step S515 of FIG. 5 by multiplying the concern-weighted influence ratings for each stakeholder by their utility payoff scores for each one of the possible outcome scenarios. For Jane, carrying out this step comprises multiplying Jane's concern-weighted influence rating (4000) by Jane's utility payoff scores for each one of the outcome scenarios (i.e., −211 for McDonalds, 231 for Subway, and −33 for Chipotle). For Carl, carrying out this step comprises multiplying Carl's concern-weighted influence rating (5400) by Carl's utility payoff scores for each one of the outcome scenarios (−421 for McDonalds, 337 for Subway, and −229 for Chipotle). The products of these calculations are shown in the second and third columns of Table 22 below.

After the influence weighted utility payoff scores for each stakeholder and each possible outcome scenario are recorded, the average influence weighted payoff scores for each possible outcome scenario across all stakeholders is calculated using, for example, the conventional method for calculating an average value for a collection of values. In this case, the average influence weighted payoff scores for each possible outcome scenario is equal to the average of Jane's influence weighted payoff and Carl's influence weighted payoff, or (Jane's influence weighted payoff+Carl's influence weighted payoff)/2. The results of these calculations are shown in final column of Table 22 below.

TABLE 22
INFLUENCE-WEIGHTED PAYOFF SCORES PER SCENARIO

| | Jane's IWP | Carl's IWP | Average IWP |
|---|---|---|---|
| Outcome Scenario | Scores | Scores | Scores |
| McDONALDS | −844,000 | −2,273,400 | −1,558,700 |
| SUBWAY | 924,000 | 1,819,800 | 1,371,900* |
| CHIPOTLE | −132,000 | −1,236,600 | −684,300 |
| NOTHING | 0 | 0 | 0 |

Based on the numbers in the cells of the rightmost column of Table 22, the most positive (least negative) average influence weighted payoff score is 1,371,900, which is the score associated with the outcome scenario of going to Subway for lunch. Therefore, in this case, going to Subway is still the most likely outcome scenario when the relative influence and relative levels of concern of the two stakeholders in our example are considered and factored into the analysis. Therefore, in this case, the egalitarian most likely outcome scenario is the same as the influence-weighted most likely outcome scenario. It will be recognized by those skilled in the art, however, that in some situations, the egalitarian most likely outcome scenario and influence-weighted most likely outcome scenario will be different from each other.

Notably, there are alternative ways of calculating the average influence-weighted payoff scores for the stakeholders. One alternative method is to use the formula shown in step S520 of FIG. 5. As shown in step S520, the average influence weighted payoff score for an outcome scenario may also be calculated as the sum of the stakeholders' payoffs, multiplied by their relative level of influence, divided by the total sum of influence. So in terms of the lunch example with Carl and Jane, the average influence weighted payoff is equal to (Carl's payoff*Carl's influence+Jane's Payoff*Jane's influence)/(Janes influence+Carl's influence). The result of using this formula is that the AIWP=−331.638. This method of calculating the AIWP, which is similar to adjusting currency for inflation, may be more appropriate under some circumstances because it (1) normalizes the utilities value in order to appropriately compare with the egalitarian outcomes, and (2) captures the countervailing effect of people with similar influence but different preferences by permitting the weighted positive and negative utility values to cancel each other out. The reason is because, when comparing the egalitarian outcome with the weighted influence outcome, it is preferable that the values be comparable, not just across the scenarios but between egalitarian and influence based outcomes. Also, this method cancels out the positive and negative utility values, which produces a useful countervailing effect on the overall outcome in cases where there are almost as many negative payoffs as there are positive payoffs with comparable weights.

In some embodiments, all of the outcome scenarios may be displayed or printed in a list, wherein the list is ordered according to the relative values calculated for the average influence-weighted payoff scores. In other words, the range of possible outcome scenarios are displayed or printed in rank order from the scenario with the highest average influence-weighted payoff score to the scenario with the lowest average influence-weighted payoff score. In other embodiments, only the highest ranked outcome scenario (i.e., the outcome scenario with the most positive average influence-weighted utility payoff score) may be printed or displayed, or otherwise presented for a user, stakeholder, system operator or analyst.

When a negotiation over a given issue involves multiple stakeholders, and strong disagreements among those stakeholders are making it difficult for the stakeholders to reach a consensus and/or develop a resolution for the issue, it is usually due to the fact that those stakeholders, despite what they may be saying to the public about their stated positions, in fact have reality-based positions that are considerably at odds with each other, if not mutually exclusive. These conflicting and/or mutually exclusive reality-based positions frequently lead to significant delays in finding an acceptable solution and sometimes prevent the negotiators from resolving the issue at all. On the other hand, when the reality-based positions of the stakeholders are substantially aligned, then consensus and resolution tend to be achieved in far less time and with far less pain and effort on the part of the stakeholders and/or negotiators. Accordingly, the amount of controversy, disagreement and delay (i.e., the amount of “friction”) that can be expected to arise during a negotiation among multiple stakeholders with varying levels of influence and concern about the issue is roughly proportional to the variance between the influence-weighted utility payoff scores for he stakeholders. Therefore, in embodiments of the present invention, the amount of friction for a defined issue involving multiple stakeholders is calculated, at step S530, by calculating the variance among all of the influence-weighted payoff scores for all of the stakeholders across all of the possible outcome scenarios. More specifically, the amount of friction (A.O.F.) associated with each possible outcome scenario in the range of possible outcome scenarios for the defined issue may be calculated in accordance with the formula:

A.O.F.=max (influence*utility payoff)−min (influence*utility payoff)

Continuing with our lunch example, the amount of friction associated with each one of the possible outcome scenarios may be calculated as:

A.O.F. (McDonalds)=−2,273,400−(−844,000)=−1,429,400

A.O.F. (Subway)=1,819,800−924,000=895,800

A.O.F. (Chipotle)=−1,236,600−(−132,000)=1,368,600

Consequently, based on the influence-weighted payoff scores of Jane and Carl, the outcome scenario about which Jane and Carl disagree the most, and is therefore likely to cause the most amount of friction, is the outcome scenario of going to McDonalds for lunch because going to McDonalds has the most positive (least negative) value for A.O.F. Ideally, the rank-ordered list of possible outcome scenarios presented to the user, stakeholder, subject matter expert or analyst includes, for each possible outcome scenario, the amount of friction associated with that possible outcome scenario.

Applying the Process to More Complex Issues

For purposes of illustration and ease of comprehension, the operation of the present invention has been described in considerable detail above in the context of a relatively simplistic defined issue (i.e., what to do for lunch today) and a relatively very small number of stakeholders (Jane and Carl). It will be appreciated, however, that the value of the present invention lies in its potential for helping people and organizations in business, politics and law analyze and rank the ranges of possible outcome scenarios associated with a variety of much more complex issues involving many more stakeholders, who may have different and diverse stated positions, reality-based positions and levels of influence and concern about those complex issues. For instance, the process and the steps described and used above to determine and rank the range of possible outcome scenarios for the issue of “what to do for lunch today” could also be used to determine and rank ranges of possible outcome scenarios for transnational issues (such as negotiations over international regulations on telecommunications, negotiations over peace in the Middle-East, and negotiations over nuclear compliance), foreign national issues (such as ceasefire negotiations in Syria, police reform negotiations in Honduras, peace negotiations in Burma) and domestic and legislative issues (such as Federal Reserve Board decisions on U.S. interest rate hikes, legislation concerning the Affordable Care Act or negotiations and legislation concerning the Keystone pipeline). These are but a few examples of the types of complex issues involving multiple stakeholders that could be more reliably analyzed using embodiments of the present invention to predict and rank ranges of possible outcome scenarios.

Suppose, for example, that instead of analyzing the issue of what to do for lunch today, an embodiment of the present invention is used to analyze and rank the range of possible outcomes associated with the issue of “What will be the likely impact of a Counter-Isis campaign?” While the stakeholder and issue input parameters, including the range of possible outcome scenarios, the set of factors, the range of options, the stakeholders, the influence ratings and the levels of concern, would necessarily be completely different, the overall process and the steps used for ranking the possible outcome scenarios associated with the new issue would be exactly the same.

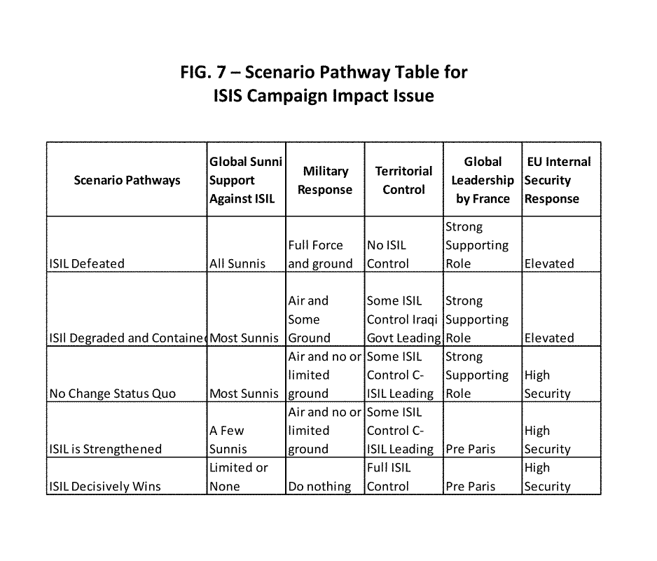

In particular, the process would begin by defining and recording a collection of issue input parameters by carrying out the steps shown in FIG. 2, including the steps of receiving and recording the defined issue (step S205), receiving and recording the range of possible outcome scenarios, including the status quo scenario (step S210), receiving and recording the set of factors for the defined issue (step S212), receiving and recording the ranges of options for the defined set of factors (step S213), and linking the options to the defined range of possible outcome scenarios to create the scenario pathway table (steps S215-S245). FIGS. 6A-6D show exemplary data that might be defined, received and/or recorded as a result of carrying out steps S205, S210, S212 and S213 of FIG. 2 for the newly defined issue of “What will be the likely impact of a counter-ISIS campaign?” Specifically, the table in FIG. 6A shows the information that could be received and recorded as representing the newly defined issue. The table in FIG. 6B shows the range of possible outcome scenarios, including a status quo outcome scenario that might be defined, received and/or recorded for the newly defined issue. In this case, “no change” in the status of ISIL is defined as the status quo outcome scenario. The table in FIG. 6C shows the set of factors that might be received and recorded for the newly defined issue, assuming that it is concluded by the user, by a system operator, by an analyst, by a subject matter expert, or some combination of users, system operators, analysts or subject matter experts, that the most important factors affecting the likely outcome for the issue are military responses, territorial control, global support for the Sunnis, global leadership for the campaign and European Union internal security responses. The table in FIG. 6D shows the range of options that might be defined, received and/or recorded for the defined set of factors for the newly defined issue. For the possible outcome scenarios, factors and options associated with the defined issue of “What will be the likely impact of a counter-ISIL campaign,” linking the options to the possible outcome scenarios to create a scenario pathway table might produce the table shown in FIG. 7 (or a data structure in the memory of a computer system that substantially reflects the relationships shown the table of FIG. 7).

After defining and recording the issue input parameters for the ISIS campaign issue, the next step in the process comprises defining, receiving and/or recording a collection of stakeholder input parameters in accordance with the steps of FIG. 3, including identifying the stakeholders (step S305), their stated positions, and their relative levels of influence and concern for the defined issue (steps S315 and S320), and the stakeholders' rankings of factors and options (steps S330-S355). By way of example, the table in FIG. 8A shows that an exemplary set of stakeholders for this issue could be identified as the United States, Russia, Saudi Arabia, Turkey, ISIL, Iran, the Iraqi Government, the Assad Regime, France Qatar and the European Union; and the table in FIG. 8B illustrates a potential set of rankings of the factors and options for just one of the stakeholders, namely the United States. A set of such rankings are defined, received and/or recorded for all of the stakeholders so that, in accordance with the steps of FIG. 4, a reverse induction combination table and utility payoff schedule can be generated for each stakeholder.

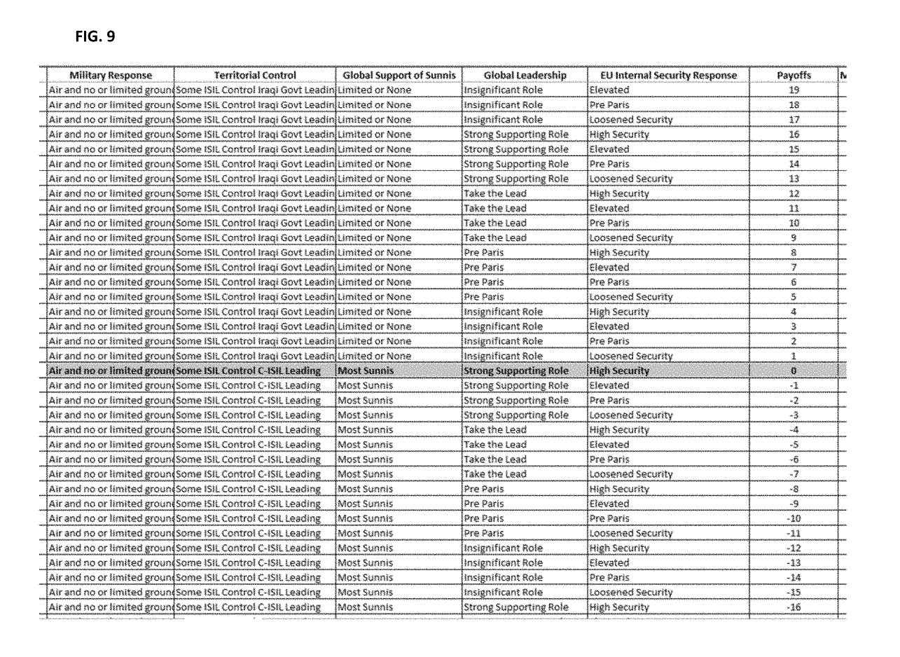

As previously discussed for the lunch example, the utility payoff scores for each stakeholder for each outcome scenario are determined by assigning a utility payoff score of “0” to the combination of options in the stakeholder's reverse induction combination table corresponding to the status quo scenario combination in the scenario pathway table depicted in FIG. 7, and then running an ordinal array up and down the reverse induction combination table (starting from the row containing the “0” score), successively incrementing the assigned utility payoff score by one for each row as one runs up the table and decrementing the assigned utility payoff score by one for each row as one runs down the table. See step S420 of FIG. 4. FIG. 9 shows an example of a portion of a utility payoff schedule that could be generated for one of the stakeholders for the defined issue by carrying out the steps of S410 and S415 of FIG. 4. The resulting utility payoff scores in the utility payoff schedule are recorded and compared against each other for each stakeholder, in accordance with steps S425 and S430 of FIG. 4, to determine each stakeholder's reality-based position for the defined issue. If desired, the utility payoff scores for each possible outcome scenario may then be averaged across all of the stakeholders and compared to each other, in accordance with step S505 of FIG. 5 in order to determine an egalitarian outcome scenario for the defined issue.

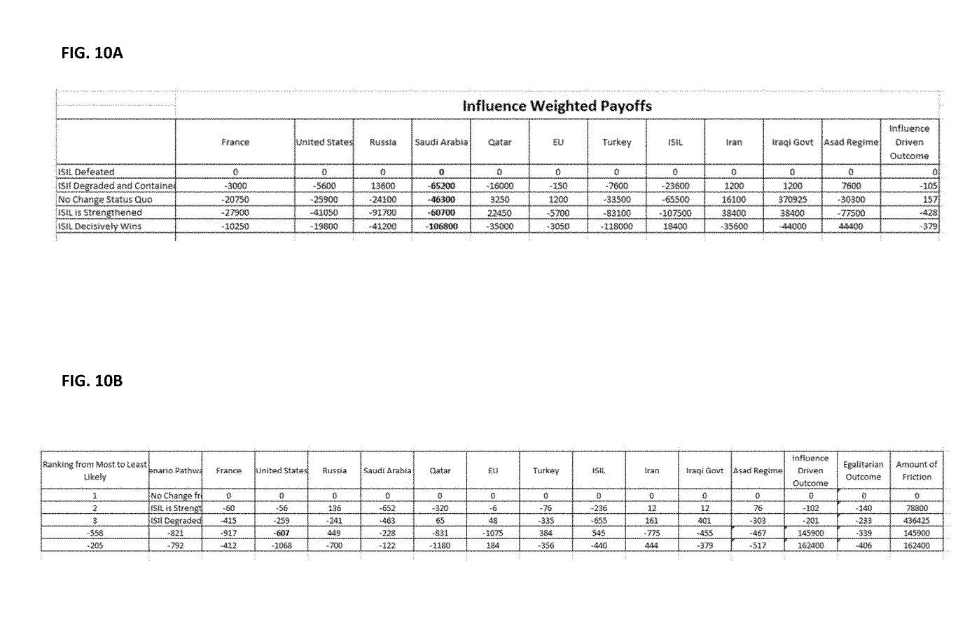

Once the utility payoff scores and reality-based positions for each stakeholder for each possible outcome scenario are known, those scores also may be weighted by the previously-received influence and concern levels for each stakeholder, in accordance with steps S510 and S515, to determine the influence-weighted payoff scores for each possible outcome scenario in the range of possible outcome scenarios. The table in FIG. 10A shows an example of the influence-weighted payoff scores that might be generated by performing this step for each stakeholder in the ISIS campaign example. Finally, as previously described, the influence-weighted utility payoff scores for all of the possible outcome scenarios may be averaged across all of the stakeholders and then ranked, in accordance with steps S525 and S530 of FIG. 5, to determine and present the most likely outcome scenario, as well as the amount of friction associated with each possible outcome scenario in the range of possible outcome scenarios for the defined issue. Exemplary results of performing these calculations are illustrated by the table of FIG. 10B.

### Exemplary Computer-Implemented Embodiments

In one exemplary embodiment of the present invention, there is provided an outcome scenario ranking system for ranking possible outcome scenarios within a range of possible outcome scenarios for an issue involving multiple stakeholders. In general, the outcome scenario ranking system comprises a computer system (or a networked collection of computer systems) configured to receive and record a set of issue and stakeholder input parameters associated with a defined issue. The system processes the issue and stakeholder input parameters, according to the steps described herein, to produce and display to the user the outcome scenario that is most likely to occur, or alternatively, an ordered list of the possible outcome scenarios, wherein the sequence of outcome scenarios in the ordered list is based on average utility payoff scores for each one of the possible outcome scenarios, as calculated by the logical components of the outcome scenario ranking system. Typically, the outcome scenario with the highest average utility payoff score will be ranked first and shown first in the ordered list of possible outcome scenarios, while the outcome scenario with the lowest average utility payoff score will be ranked last and shown last in the ordered list. Thus, the outcome scenarios in the ordered list are sequenced to run from most likely to occur to least likely to occur. Depending on the specific goals and objectives of the user or the system operator, however, the system may be configured to display the ordered list so that the least likely outcome scenario is listed first and the most likely scenario is listed last. In still other situations, the system may be configured to present the outcome scenarios in no particular order, along with the calculated rankings and/or utility payoff scores for each outcome scenario, so that the relative likelihoods of each outcome scenario can be readily ascertained without relying on the ordering of the list.

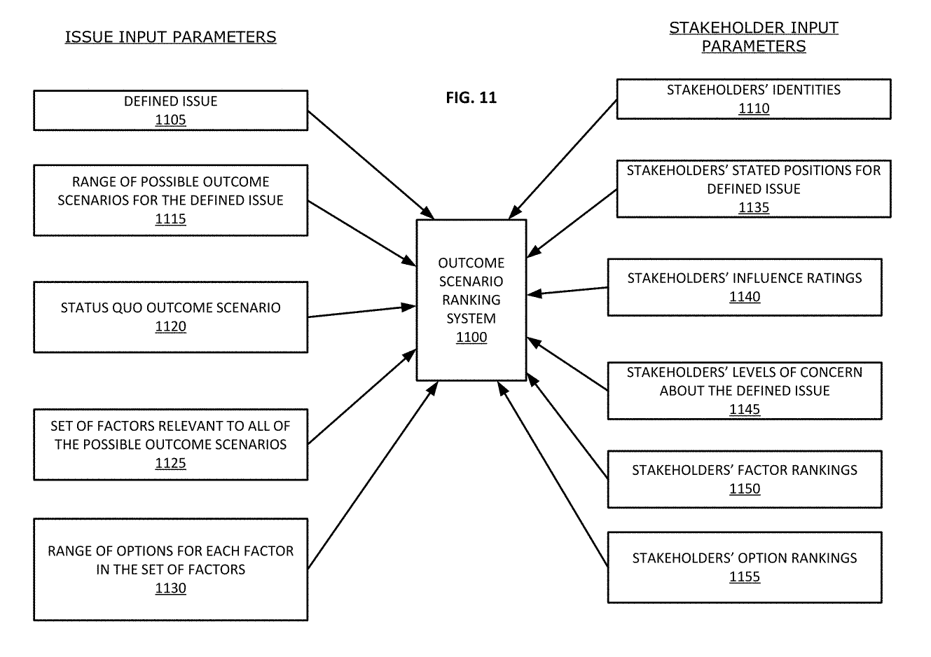

FIG. 11 contains a data flow diagram illustrating at a high-level several different kinds of data inputs received and recorded by one embodiment of the outcome scenario ranking system of the present invention. As shown in FIG. 11, outcome scenario ranking system 1100 receives and records issue input parameters, including issue information representing or describing the defined issue 1105, the range of possible outcome scenarios for the defined issue 1115, the status quo outcome scenario for the defined issue 1120, the set of factors 1125 relevant to all of the possible outcome scenarios, and the range of options 1130 for each factor in the set of factors. Outcome scenario ranking system 1100 also receives and records a collection of stakeholder input parameters about the stakeholders, including the stakeholders' identities 1110, the stakeholders' stated positions 1135 on the defined issue, the stakeholders' influence ratings 1140, the stakeholders' levels of concern 1145 about the defined issue, the stakeholders' factor rankings 1150 and the stakeholders' option rankings 1155. Typically, but not necessarily, the issue and stakeholder input parameters will be supplied to the outcome scenario ranking system as alphanumeric character strings, which could be typed by a user in response to prompts from a user interface program running on the outcome scenario ranking system 1100, or otherwise automatically retrieved from a data file made accessible by or transmitted from one or more other computer systems. Once received, these issue and stakeholder input parameters are recorded in a primary or secondary memory storage area located on or associated with the outcome scenario ranking system 1100.

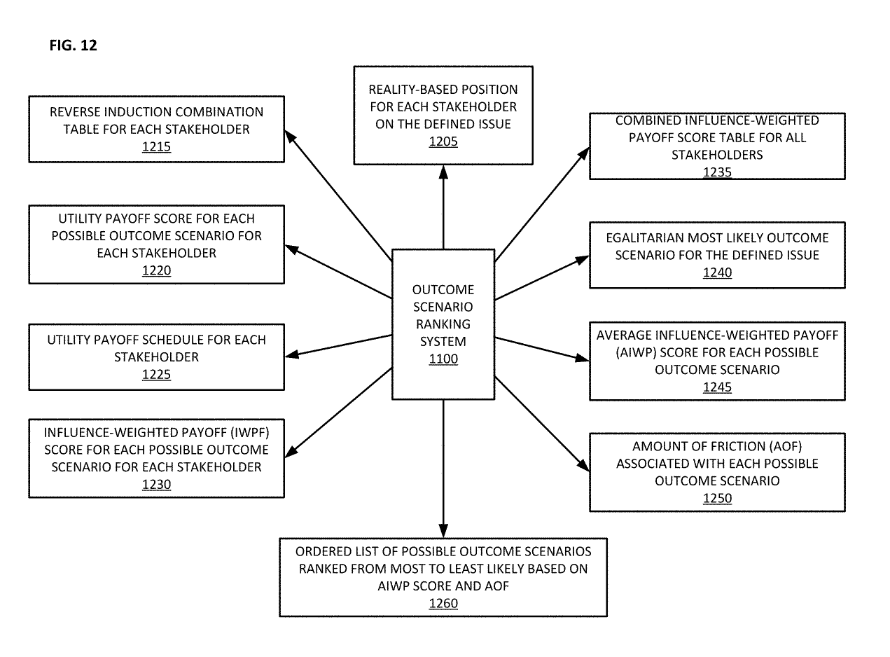

FIG. 12 contains another data flow diagram illustrating by way of example several different kinds of outputs (and potential outputs) that could be produced by the exemplary outcome scenario ranking system 1100 shown in FIG. 11. As shown in FIG. 12, the outcome scenario ranking system 1100 may be configured to determine, display and/or present a multiplicity of different outputs, depending on the specific objectives, requirements and wishes of the users and/or system operators. These outputs may include a reverse induction combination table 1215 for each stakeholder, a utility payoff score 1220 for each outcome scenario for each stakeholder, a utility payoff schedule 1225 for each stakeholder, an influence-weighted payoff score 1230 for each possible outcome scenario for each stakeholder, a reality-based position 1205 for each stakeholder, a combined influence-weighted payoff score table 1235 for all stakeholders, an egalitarian most likely outcome scenario 1240, an average influence-weighted payoff (AIWP) score 1245 for each possible outcome scenario, an amount of friction (AOF) 1250 for each possible outcome scenario, and an ordered list 1260 of possible outcome scenarios ranked from most to least likely based on the AIWP scores and the amount of friction for each one of the possible outcome scenarios in the range of possible outcome scenarios.

In some embodiments all of these outputs may be presented, or otherwise made available, to the user. In other embodiments, only a subset of these outputs are presented. In still other embodiments, only the final, ordered list of ranked outcome scenarios may be presented. In some cases, such as in the case of the reverse induction combination table 1215, the output may comprise a collection of alphanumeric characters, a data spreadsheet, or an image. In other cases, the output may comprise a graph or plot of the data showing the specific scores and/or positions associated with each outcome scenario for each stakeholder based on the calculations described herein.

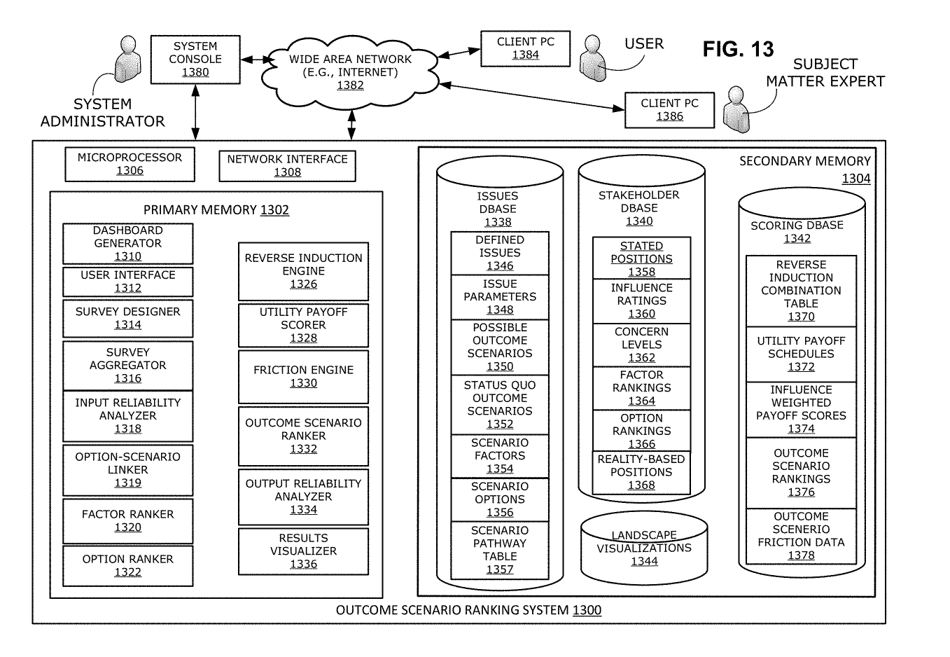

FIG. 13 shows a high-level block diagram illustrating some of the physical and logical components of an exemplary outcome scenario ranking system 1300 configured, according to one embodiment of the present invention, to rank possible outcome scenarios in a range of possible outcome scenarios for a defined issue. The outcome scenario ranking system 1300 carries out the steps described above in reference to FIGS. 1-11 in order to receive, record and process issue and stakeholder input parameters provided by a user, a system operator, a subject matter expert, or all of them. The system 1300 also produces the outputs, such as a rank ordered list of possible outcome scenarios, as described above in reference to FIG. 12. As FIG. 13 shows, the outcome scenario ranking system 1300 comprises a microprocessor 1306, a network interface 1308, a primary memory 1302 and a secondary memory 1304. The primary memory 1302, which typically comprises, for example, the random access memory of a personal computer system, holds a plurality of computer programs containing program instructions that, when executed by the microprocessor 1306, causes the microprocessor to carry out the steps and functions described herein and to record intermediate values and final results in the secondary memory 1304. Although other types of memory storage devices could be used, the secondary memory 1304 typically comprises a high-capacity hard disk drive or solid state drive (SSD) communicatively coupled to the microprocessor 1306 via a system bus (not shown in FIG. 13).

A system console 1380 is connected to the outcome scenario ranking system 1300 to permit access to and control over the system by a system administrator. The network interface 1308 provides a two-way communication channel between the outcome scenario ranking system 1300 and a wide area network 1382 of computers. The connection to the wide area network 1382 permits a user operating a client PC 1384 and a subject matter expert operating another client PC 1386 to access the system, provide data inputs, and review the outputs. The intermediate and final results recorded in the secondary memory 1304 may be transmitted to the user's client PC 1384 and/or the subject matter expert's client PC 1386 over the wide area network 1382.

The plurality of computer programs in the primary memory 1302 includes a dashboard generator 1310, a user interface 1312, a survey designer 1314, a survey aggregator 1316, an input reliability analyzer 1318, an option-scenario linker 1319, a factor ranker 1320, and an option ranker 1322. Taking each of these programs in turn, the dashboard generator 1310 comprises programming instructions that, when executed by the microprocessor, creates displayable dashboard containing a list of predefined issues that the user might wish to analyze. The user interface 1312 comprises program instructions that cause the microprocessor 1306 to display the dashboard created by the dashboard generator 1310 on a display monitor connected to the user's client PC 1384. The client PC 1384 typically comprises a remote terminal connected to the outcome scenario ranking system 1300 via the network interface 1308. The program instructions in the dashboard generator 1310 and user interface 1312 are preferably configured so that the user can select any one of the predefined issues on the dashboard to initiate an analysis on the selected issue. Alternatively, the program instructions in the dashboard generator 1310 and user interface 1312 may be suitably configured to permit the user to create and/or define a new issue (not previously defined) for the outcome scenario ranking system 1300 to analyze. New issues may be created by entering information and data sufficient to adequately describe and/or represent the parameters of the new issue.

Once the user (or system administrator) defines the issue, or selects a predefined issue, the user interface 1312 and dashboard generator 1310 cooperate to permit the user to define (or select) a range of possible outcome scenarios, a set of factors and a range of options associated with the defined issue. In some embodiments, the potential outcome scenarios, factors and options for the particular issue may be selected from a predefined list. In other embodiments, the user may be prompted to enter new information to create new lists of possible outcome scenarios, factors and options, or add additional items to one or more of the predefined lists of possible outcome scenarios, factors and options. The user also identifies which one of the outcome scenarios in the range of possible outcome scenarios is the status quo outcome scenario (i.e., the outcome scenario that is closest to, if not identical to, the present set of circumstances) for the defined issue.

In some cases, the user may not know the range of possible outcomes, the set of factors and the range of options for the set of factors for a particular issue, or otherwise may not be confident that his or her perception and understanding of these parameters is correct or reliable. Therefore, the user may need to survey subject matter experts, researchers, stakeholders and/or others to determine, as accurately as possible, what the necessary inputs should be for the range of possible outcome scenarios, factors and options. For these situations, preferred embodiments of the present invention provide a survey designer 1314, a survey aggregator 1316 and an input reliability analyzer 1318. The survey designer 1314 assists the user in designing and distributing the appropriate surveys for the defined issue. The survey aggregator 1316 receives and combines the survey results (possibly from a large number of survey participants). The input reliability analyzer 1318 is configured to normalize and verify the integrity of the survey results via one or more known reliability testing and error-correcting techniques, such as Monte Carlo testing and/or crowdsourcing. Typically, the survey aggregator 1318 is configured to create the appropriate records and links in the issues database 1338 to reflect the survey results. In some embodiments, the input reliability analyzer 1318 generates descriptive statistics from subject matter expert survey results, and then identifies the average response from a multiplicity of survey responses, the variance between the responses and/or the median response, in order to provide the user with a measure of how reliable the survey results are based on the variety of different subject matter expert survey responses. The reliability-tested and error-corrected survey results for the range of possible outcomes, factors and options may then be displayed to the user by operation of the issues dashboard generator 1310 and the user interface 1312 so that the user can select the items he or she wants to use in the analysis and rankings. The option/scenario linker 1319 links the various options within each factor to a particular outcome scenario to define a pathway to that particular outcome scenario, thereby creating a scenario pathway table 1357 in the secondary memory 1304. Table 5 above shows an example of the data stored in the scenario pathway table 1357.

As the user selects, inputs and/or defines the issue, the range of possible outcome scenarios, the factors and the options, all of the selections and/or definitions are saved in the issues database 1338 in the secondary memory 1304 associated with the outcome scenario ranking system 1300. Thus, as shown in FIG. 13, the issues database 1338 contains records and data structures suitably selected and configured to hold collections of defined issues 1346, issue parameters 1348, possible outcome scenarios 1350, status quo outcome scenarios 1352, scenario factors 1354, scenario options 1356 and a scenario pathway table 1357.

After guiding the user through the selection and/or definitions for the range of possible outcome scenarios, the set of factors and the range of options for the defined issue, the dashboard generator 1310 and user interface 1312 are configured to prompt the user to enter, select or define the stakeholders for the defined issue, the stakeholders' stated positions for the defined issue, the stakeholders' influence ratings for the defined issue, and the stakeholders' levels of concern for the defined issue. Alternatively, the stakeholders, the stated positions, influence ratings and levels of concern may be assigned by a system administrator or a subject matter expert, or otherwise developed by activation and use of the survey designer 1314, the survey aggregator 1316 and input reliability analyzer 1318 programs. In some embodiments, the outcome scenario ranking system 1300 may also be preconfigured to use certain default stakeholders and influence ratings.

As shown in FIG. 13, the primary memory 1302 on the outcome scenario ranking system 1300 also includes a factor ranker 1320, an option ranker 1322, an option/scenario linker 1324, a reverse induction engine 1326, a utility payoff scorer 1328, and a friction calculator 1330. The factor ranker 1320 contains program instructions that generate and display screens that permit the user, a system administrator, a subject matter expert, a stakeholder, or any one of them, to rank the factors for that stakeholder. The factors are ranked from the most important factor for the stakeholder to the least important factor for the stakeholder. Examples of these factor rankings are shown in Tables 8 and 9 (Jane's and Carl's factor rankings) above. The option ranker 1322 contains program instructions that produce and display screens to the user that permit the user, a system administrator, a subject matter expert, a stakeholder, or any one of them, to rank the range of options for each factor. The options are also ranked from the most important option for the stakeholder to the least important option for the stakeholder. Examples of these option rankings are found in Tables 10 and 11 (Jane's and Carl's option rankings) above. Notably, the survey designer 1314 and the survey aggregator 1316 may be activated and used, if desired, to assist the user, system administrator and subject matter expert in ranking the factors and options on behalf of each stakeholder. Secondary memory 1304 contains a stakeholder database 1340 comprising a collection of records suitably arranged and configured to store the stakeholders' stated positions 1358, influence ratings 1360, concern levels 1362, factor rankings 1364, option rankings 1366 and reality-based rankings 1368. All of the stakeholder information provided and/or selected by the user is saved in a stakeholder database 1340 of the secondary memory 1304.

The reverse induction engine 1326 and utility payoff scorer 1328 include instructions that cause the microprocessor 1306 to determine the likely payoffs of the various stakeholders across all of the outcome scenarios. Typically, the reverse induction engine will first generate a reverse induction combination table based on the factor rankings 1364 and option rankings 1366 produced and stored in the stakeholder database 1340 by the factor ranker 1320 and the option ranker 1322, respectively. As previously discussed, the reverse induction combination table includes all of the possible combinations of options in regard to the defined issue. The reverse induction combination tables produced for every stakeholder by the reverse induction engine are stored in the reverse induction combination tables 1370 of the scoring database 1342 in the secondary memory 1304.

The utility payoff scorer 1328 then indexes the option combinations in the reverse induction combination table, beginning with the combination of options corresponding to the status quo outcome scenario. The utility payoff scorer 1328 assigns a utility payoff score of zero to the row in the reverse induction combination table corresponding to the status quo outcome scenario, and then runs a rank-ordered vector in the positive direction from zero and a rank ordered vector in the negative direction from the position zero (i.e. n+1, n−1). The utility payoff scorer 1328 also determines, for every stakeholder, the utility payoff score for every one of the possible outcome scenarios based on the scores assigned by running the rank-ordered vectors. The utility payoff scores produced by the utility payoff scorer 1328 are stored in the utility payoff schedules 1372 section of the scoring database 1342 in the secondary memory.

The outcome scenario ranker 1332 produces a list of possible outcome scenarios, rank ordered from most likely to least likely, by taking the influence of each stakeholder, multiplied by the utility payoff score, divided by the overall influence, which may be referred to as the influence-weighted payoff. The influence weighted payoffs are combined and then rank ordered from highest to lowest, whereby the highest ranked combined influence weighted payoff represents the most likely outcome scenario and the lowest ranked combined influence weighted payoff represents the least likely outcome scenario. The list and the outcome scenario rankings are saved in the outcome scenario rankings 1376 section of the scoring database 1342.

In preferred embodiments, a friction engine 1330 estimates how much relative friction is going to be present on each issue based on the variance, or divergence in utility payoff scores, between the multiple stakeholders. It does this by calculating the difference between the highest influence-weighted payoff score and the lowest influence-weighted payoff score for each outcome scenario.

A results visualizer 1336 generates and saves in the secondary memory landscapes visualizations 1344, comprising graphs and plots configured to illustrate the stated positions, the reality-based positions and the utility payoff scores associated with each one of the possible outcome scenarios. The results visualizer may also be configured to display a rank-ordered list of the possible outcome scenarios, wherein the possible outcome scenarios are ordered from the outcome scenario having the most positive average utility payoff score to the outcome scenario having the least positive utility payoff score. The user interface 1312 is configured to permit the user to transmit the landscape visualizations 1344 to the user's client PC 1384 for to be displayed on a monitor or printed on a printer.

Although the system 1300 has been described herein as having a multiplicity of individual computer programs, each providing programming instructions for performing a different function, it will be understood and appreciated by those skilled in the art, that most or all of the programming instructions may be contained by a single program or may be distributed among several computer systems, modules or subroutines configured to communicate with each other.

### Manual and Semi-Automatic Embodiments of the Invention

In addition to the computer-based outcome scenario ranking system 1300 shown in FIG. 13 and described above, embodiments of the present invention also provide a method for ranking a range of outcome scenarios associated with a defined issue. The method may be practiced manually (i.e., without the aid or use of computer technology), semi-automatically (i.e., with limited aid from and use of computer technology), or automatically (i.e., with extensive aid and use of computer technology). In a manual implementation, certain steps in the method (such as recording factor and option rankings for each stakeholder, generating the reverse induction combination tables for each stakeholder, assigning a utility payoff score of “0” to the combination of options in the reverse induction combination tables corresponding to the status quo, running the ordinal arrays up and down the reverse induction combination tables to generate the utility payoff schedules for each stakeholder, and recording the utility payoff scores and reality-based positions of each stakeholder), may be carried out by organizing, tracking and processing lists of scenarios, factors and options, as well as intermediate and final rankings and scores, using non-electronic and non-computerized recording devices, such as pencil and paper.

In semi-automated implementations, personal computer systems may be used, along with commercially-available spreadsheet and word processing programs, such as Microsoft Excel® and Microsoft Word®, to record, track, manipulate and process data representing sets and ranges of possible outcome scenarios, factors, options, influence ratings, levels of concern, utility payoff scores and rankings, as described above and illustrated in FIGS. 1 through 10B, to produce the desired results. All such manual and semi-automated implementations comprising carrying out the steps as described above are intended to fall within the scope of the present invention. However, because the data that must to be collected and recorded, and then tracked and manipulated to carry out the steps of the invention can, and does, tend to grow exponentially as the number of stakeholders, factors and options increases, using manual and semi-automatic devices to carry out the steps of the claimed method can quickly become too cumbersome, if not impossible, for most people. Therefore, it is anticipated that the most common manner of practicing the claimed method will involve utilizing computer technology, as described herein below, to receive, record, organize, track, process and present the large sets of scoring and ranking data used to achieve the final results.

While carrying out these functions, embodiments of the present invention may also be configured to generate visualizations (i.e., graphs and plots) illustrating, for each step in the process, certain values, such as payoffs, which helps users and/or subject matter experts and/or operators visualize the negotiation landscapes associated with the issues and disputes to be negotiated. These visualizations may be transmitted to the users and/or subject matter experts via the wide area network.

Although the exemplary embodiments, uses and advantages of the invention have been disclosed above with a certain degree of particularity, it will be apparent to those skilled in the art upon consideration of this specification and practice of the invention as disclosed herein that alterations and modifications can be made without departing from the spirit or the scope of the invention, which are intended to be limited only by the following claims and equivalents thereof.

1. A method for determining a likely outcome scenario for a defined issue involving two or more stakeholders, the method comprising the steps of:
a) defining a range of possible outcome scenarios for the defined issue, including a status quo outcome scenario;
b) defining a set of factors for the defined issue;
c) defining a range of options for each factor in the set of factors;
d) establishing a pathway to each one of the possible outcome scenarios in the range of possible outcome scenarios by linking one of the options for each factor in the set of factors to said each one of the possible outcome scenarios;
e) for each stakeholder, ranking the factors in the set of factors by order of importance to the stakeholder, thereby producing a set of factor rankings for said each stakeholder;
f) for each stakeholder and each factor, ranking the options in the range of options for said each factor by order of importance to the stakeholder, thereby producing a set of option rankings for each stakeholder;
g) using reverse induction to generate a utility payoff schedule for each stakeholder based on the factor rankings and the option rankings for said each stakeholder, the utility payoff schedule comprising a utility payoff score for said each stakeholder for each one of the possible outcome scenarios in the range of possible outcome scenarios; and
h) determining the likely outcome scenario in the range of possible outcome scenarios based on said utility payoff score for said each stakeholder in the utility payoff schedule.

2. The method of claim 1, further comprising the steps of:
a) generating a rank-ordered list comprising all of the possible outcome scenarios in the range of possible outcome scenarios, wherein the possible outcome scenarios in the rank-ordered list are sequenced according to relative values of the utility payoff scores in the utility payoff schedule for each one of said possible outcome scenarios; and
b) transmitting the rank-ordered list to a display device.

3. The method of claim 1, further comprising the steps of:
a) calculating an average utility payoff score for each one of the possible outcome scenarios in the range of possible outcome scenarios by summing together the utility payoff scores in said utility payoff schedule for said each possible outcome scenario across all of said two or more stakeholders and dividing the sum by the number of stakeholders; and
b) determining the likely outcome scenario in the range of possible outcome scenarios by comparing the average utility payoff scores for all of the possible outcome scenarios for all of the stakeholders and selecting the possible outcome scenario with the most positive average utility payoff score.

4. The method of claim 3, further comprising the steps of:
a) receiving an influence rating for each stakeholder; and
b) calculating an influence-weighted utility payoff score for each stakeholder for each possible outcome scenario by multiplying the utility payoff score for said each possible outcome scenario for said each stakeholder by the influence rating for said each stakeholder.

5. The method of claim 4, further comprising the steps of:
a) calculating an average influence-weighted utility payoff score for each one of the possible outcome scenarios in the range of possible outcome scenarios by summing together the influence-weighted utility payoff scores for said each possible outcome scenario across all of said two or more stakeholders, and dividing the sum by the number of stakeholders; and
b) determining the likely outcome scenario in the range of possible outcome scenarios by comparing the average influence-weighted utility payoff scores for all of the possible outcome scenarios for all of the stakeholders and selecting the possible outcome scenario with the most positive average influence-weighted utility payoff score.

6. The method of claim 1, further comprising the steps of:
a) calculating an average influence-weighted payoff score for each one of the possible outcome scenarios in the range of possible outcome scenarios according to the formula
$$AIWP = {\sum }_{1}^{n} ( \frac{( {PAYOFF}_{n} \times {INFLUENCE}_{n} )}{{\sum }_{1}^{n} ( {INFLUENCE}_{n} )} )$$
where n=the number of stakeholders; and
b) determining the likely outcome scenario in the range of possible outcome scenarios by comparing the average influence-weighted payoff scores for all of the possible outcome scenarios for all of the stakeholders and selecting the possible outcome scenario with the most positive average influence-weighted payoff score.

7. The method of claim 6, further comprising the steps of:
a) receiving, for each stakeholder, the level of concern the stakeholder has for the definedissue; and
b) weighting the average influence-weighted payoff scores by the level of concern for said each stakeholder.

8. The method of claim 4, further comprising the step of determining an amount of friction associated with realizing each one of the possible outcome scenarios by calculating the variance in the influence-weighted utility payoff scores across all of the stakeholders.

9. A computer system for ranking outcome scenarios for a defined issue involving two or more stakeholders, the computer system comprising:
a) a memory;
b) a microprocessor;
c) a user interface in the memory having programming instructions that, when executed by the microprocessor, will cause the microprocessor to assist a user in defining (ii) a range of possible outcome scenarios for the defined issue, including a status quo outcome scenario, (ii) a set of factors for the defined issue, and (iii) a range of options for each factor in the set of factors;
d) an option-scenario linker in the memory having programming instructions that, when executed by the microprocessor, will cause the microprocessor to establish a pathway to each one of the possible outcome scenarios in the range of possible outcome scenarios by linking one of the options for each factor in the set of factors to one of the possible outcome scenarios;
e) a factor ranker in the memory having programming instructions that, when executed by the microprocessor, will cause the microprocessor to produce a set of factor rankings for each stakeholder by ranking the factors in the set of factors in order of importance to the stakeholder;
f) an option ranker in the memory having programming instructions that, when executed by the microprocessor, will cause the microprocessor to produce a set of option rankings for each stakeholder and each factor by ranking the options in the range of options for said each factor in order of importance to the stakeholder;
g) a reverse induction engine in the memory having programming instructions that, when executed by the microprocessor, will cause the microprocessor to generate a utility payoff schedule for each stakeholder based on the factor rankings and the option rankings for said each stakeholder, the utility payoff schedule comprising a utility payoff score for said each stakeholder for each one of the possible outcome scenarios in the range of possible outcome scenarios; and
h) a utility payoff scorer in the memory having programming instructions that, when executed by the microprocessor, will cause the microprocessor to determine a utility payoff score for each one of the possible outcome scenarios in the range of possible outcome scenarios; and
i) an outcome scenario ranker in the memory having programming instructions that, when executed by the microprocessor, will cause the microprocessor to determine a likely outcome scenario in the range of possible outcome scenarios based on said utility payoff score for said each one of the possible outcome scenarios.

10. The computer system of claim 9, wherein:
a) the utility payoff scorer further comprises programming instructions that, when executed by the microprocessor, will cause the microprocessor to calculate an average utility payoff score for each one of the possible outcome scenarios in the range of possible outcome scenarios by summing together the utility payoff scores for said each possible outcome scenario across all of the stakeholders and dividing the sum by the number of stakeholders; and
b) the outcome scenario ranker further comprises programming instructions that, when executed by the microprocessor, will cause the microprocessor to determine the likely outcome scenario in the range of possible outcome scenarios by comparing the average utility payoff scores for all of the possible outcome scenarios for all of the stakeholders and selecting the possible outcome scenario with the most positive average utility payoff score.

11. The computer system of claim 9, wherein:
a) the user interface further comprises programming instructions that, when executed by the microprocessor, will cause the microprocessor to receive an influence rating for each stakeholder in said two or more stakeholders; and
b) the utility payoff scorer further comprises programming instructions that, when executed by the microprocessor, will cause the microprocessor to determine the likely outcome scenario in the range of possible outcome scenarios based on said utility payoff score for said each one of the possible outcome scenarios and said influence rating for said each stakeholder.

12. The computer system of claim 10, wherein:
a) the utility payoff scorer further comprises programming instructions that, when executed by the microprocessor, will cause the microprocessor to calculate an average influence-weighted utility payoff score for each one of the possible outcome scenarios in the range of possible outcome scenarios according to the formula
$$AIWP = {\sum }_{1}^{n} ( \frac{( {PAYOFF}_{n} \times {INFLUENCE}_{n} )}{{\sum }_{1}^{n} ( {INFLUENCE}_{n} )} )$$
where n=the number of stakeholders; and
b) the outcome scenario ranker further comprises programming instructions that, when executed by the microprocessor, will cause the microprocessor to determine the likely outcome scenario in the range of possible outcome scenarios by comparing the average influence-weighted utility payoff scores for all of the possible outcome scenarios for all of the stakeholders and selecting the possible outcome scenario with the most positive average influence-weighted utility payoff score.

13. The computer system of claim 12, wherein:
a) the user interface further comprises program instructions that cause the microprocessor to receive, for each stakeholder, a level of concern for the defined issue; and
b) the utility payoff scorer further comprises programming instructions that cause the microprocessor to calculate the average influence-weighted payoff scores based on the influence ratings and the level of levels of concern.

14. The computer system of claim 12, further comprising a friction engine in the memory, the friction engine having programming instructions that, when executed by the microprocessor, will cause the microprocessor to determine an amount of friction associated with realizing each one of the possible outcome scenarios by calculating the variance in the influence-weighted utility payoff scores across all of the stakeholders.

15. On a computer system comprising a microprocessor, a network interface, a user interface and a database, a computer-implemented method for determining a likely outcome scenario for a defined issue involving two or more stakeholders, the method comprising the steps of:
a) storing in the database a range of possible outcome scenarios for the defined issue, the range including a status quo outcome scenario;
b) storing in the database a set of factors for the defined issue;
c) storing in the database a range of options for each factor in the set of factors;
d) with the user interface, permitting a user operating a remote terminal to establish a pathway to each one of the possible outcome scenarios in the range of possible outcome scenarios by linking one of the options for each factor in the set of factors to said each one of the possible outcome scenarios;
e) with the user interface, for each stakeholder, permitting the user operating the remote terminal to rank the factors in the set of factors by order of importance to the stakeholder, thereby producing a set of factor rankings for said each stakeholder;
f) with the user interface, for each stakeholder and each factor, permitting the user to rank the options in the range of options for said each factor by order of importance to the stakeholder, thereby producing a set of option rankings for each stakeholder;
g) with the microprocessor, storing the pathways, the factor rankings and the option rankings in the database;
h) with the microprocessor, generating and storing in the database a utility payoff schedule for each stakeholder on the factor rankings and the option rankings for said each stakeholder, the utility payoff schedule comprising a utility payoff score for said each stakeholder for each one of the possible outcome scenarios in the range of possible outcome scenarios;
i) with the microprocessor, determining and storing in the database the likely outcome scenario in the range of possible outcome scenarios based on said utility payoff score for said each stakeholder in the utility payoff schedule; and
j) transmitting the likely outcome scenario to the remote terminal via the network interface.

16. The computer-implemented method of claim 15, further comprising the steps of:
a) with the microprocessor, generating and storing in the database a rank-ordered list comprising all of the possible outcome scenarios in the range of possible outcome scenarios, wherein the possible outcome scenarios in the rank-ordered list are sequenced according to relative values of the utility payoff scores in the utility payoff schedule for each one of said possible outcome scenarios; and
b) transmitting the rank-ordered list to the remote terminal via the network interface.

17. (canceled)

18. The computer-implemented method of claim 15, further comprising the step of executing a reverse induction program on the microprocessor, the program having program instructions that, when executed by the microprocessor, will cause the microprocessor to use reverse induction to generate and store in the database a reverse induction combination table based on the pathways, the factor rankings and the option rankings in the database.

19. The computer-implemented method of claim 15, further comprising:
a) receiving via the user interface an influence rating for each stakeholder; and
b) with the microprocessor, calculating an influence-weighted utility payoff score for each stakeholder for each possible outcome scenario by multiplying the utility payoff score for said each possible outcome scenario for said each stakeholder by the influence rating for said each stakeholder.

20. The computer-implemented method of claim 16, further comprising the steps of:
a) with the microprocessor, calculating an average influence-weighted payoff score for each one of the possible outcome scenarios in the range of possible outcome scenarios according to the formula
$$AIWP = {\sum }_{1}^{n} ( \frac{( {PAYOFF}_{n} \times {INFLUENCE}_{n} )}{{\sum }_{1}^{n} ( {INFLUENCE}_{n} )} )$$
where n=the number of stakeholders;
b) with the microprocessor, determining the likely outcome scenario in the range of possible outcome scenarios by comparing the average influence-weighted payoff scores for all of the possible outcome scenarios for all of the stakeholders and selecting the possible outcome scenario with the most positive average influence-weighted payoff score; and
c) transmitting the likely outcome scenario to the remote terminal via the network interface.
